(19) United States
(12) Patent Application Publication
(10) Pub. No.: US 2025/0354062 A1
(43) Pub. Date: Nov. 20, 2025

(54) LIQUID CRYSTAL DIMMING DEVICE

(71) Applicant: Jiangsu Hecheng Display Technology Co., Ltd., Nanjing (CN)

(72) Inventors: Jiajia DING, Nanjing (CN); Zhenting ZHOU, Nanjing (CN); Panpan WANG, Nanjing (CN); Wenquan DING, Nanjing (CN)

(73) Assignee: Jiangsu Hecheng Display Technology Co., Ltd., Nanjing (CN)

(21) Appl. No.: 18/866,606

(22) PCT Filed: Apr. 18, 2023
(86) PCT No.: PCT/CN2023/088918

§ 371 Date: Nov. 18, 2024

(30) Foreign Application Priority Data
May 20, 2022 (CN) 202210553338.4

(51) Int. Cl. C09K 19/30; C09K 19/60; G02F 1/1337; G02F 1/137

(52) U.S. Cl. CPC C09K 19/3001; C09K 19/601; C09K 19/603; G02F 1/133738; G02F 1/13712; G02F 1/13725

(57) ABSTRACT

The present invention provides a liquid crystal dimming device. The liquid crystal dimming device of the present application sequentially comprises, from bottom to top, a lower substrate, a lower conductive layer, a lower alignment layer, a guest-host liquid crystal composition layer, an upper alignment layer, an upper conductive layer, and an upper substrate; alignment directions of the upper alignment layer and the lower alignment layer are parallel alignment; the guest-host liquid crystal composition layer comprises at least one dichroic dye, at least one chiral agent and at least one liquid crystal composition; wherein, the liquid crystal composition comprises at least one compound of general formula N. The liquid crystal dimming device of the present invention has an appropriate transmittance (Tᵣ₀, Tᵣ₂₅₅), an appropriate contrast rate, a higher VHR (initial), a higher VHR (Ra) and a wider operation temperature range. The dimming device of the present invention has a better display effect at the moment of power-off after applying power on it for 2 h, and can effectively avoid the problems of display mura and image sticking.

### TECHNICAL FIELD

The present invention belongs to the technical field of dimming device and relates to a liquid crystal dimming device.

### BACKGROUND ARTS

At present, liquid crystal dimming devices is more and more widely used in the construction and transportation fields, which requires a wider operation temperature range of liquid crystal dimming devices, especially at high temperatures, it can be used normally. In the existing intelligent dimming panel market, there are products like polymer dispersed liquid crystal (PDLC) intelligent dimming devices, electrochromic intelligent dimming devices, etc. PDLC intelligent dimming devices can only realize the switch between transparency and haziness without shading or insulation; and problems like a complex film layer process, a long response time (8˜20 s) and a blue tint in the dark state exist in electrochromic intelligent dimming devices. Using the selective absorption of light by dichroic dye molecules in liquid crystals, guest-host type liquid crystal dimming devices realize the switch between the bright state and the dark state, which, comparing with the existing PDLC and electrochromic smart dimming devices, substantially improve the optical properties like the purity of the black state, the response time, etc.

The guest-host type liquid crystal dimming device circumvents the shortcomings of traditional modulation devices, ensures the optical display effect and improves the service life while realizing high brightness display. However, there are still many technical problems to be solved for the optical modulation devices prepared by liquid crystal compositions doped with dichroic dyes. Typically, in order to increase the dark state transmittance of the guest-host type liquid crystal dimming device and improve the contrast rate, the concentration of the dye molecules in the dye-liquid crystal mixture can be increased, or the cell gap can be increased. However, when the concentration of dichroic dye molecules gets greater, the dichroic dye molecules precipitate from the liquid crystals and affect the performance of the liquid crystal, therefore, the concentration of dye liquid crystals in the dye liquid crystal molecule is general limited. On the other hand, the contrast rate is improved via improving the manufacturing process and increasing the thickness of liquid crystal cell. However, the retardation (Δn×d) is typically fixed, then the liquid crystal display device with a greater cell gap tends to cause a smaller optical anisotropy of the liquid crystal composition, and the smaller optical anisotropy often tends to lead to the decrease of the contrast rate as well.

On the other hand, in order to improve the contrast rate of single cell dye liquid crystals, chiral agents are introduced into the dye liquid crystals to increase the twist of the liquid crystal molecules within the liquid crystal cell and reduce the P (steepness factor) value. The super-twisted negative liquid crystals are aligned perpendicular to the substrate in the initial state, and when applying power to drive, the negative liquid crystal molecules fall down and are twisted with the action of the chiral agents. The dye molecules are twisted with the twist of the liquid crystal molecules and absorb the light in multiple polarization directions, which exhibits a dark state with a much lower transmittance and the contrast rate is increased. However, with the existing device structure, the problems of poor display, uneven alignment, display mura and image sticking still occur.

Image sticking is caused by the liquid crystal being polarized by a long-time drive and deflected without being controlled by the signal voltage, resulting in the same image being displayed on the screen for a period of time. This phenomenon is weakened over time and finally disappears. Image sticking can be divided into line sticking and surface sticking, wherein the line sticking has a great relationship with the reliability of the liquid crystal material itself. The performance parameter commonly used to characterize the reliability of the liquid crystal material is the voltage holding rate (VHR), the higher the VHR, the lower the possibility of the liquid crystal material impacted by the disturbing factors (such as impurities in liquid crystals, high or low temperature, UV radiation and so on).

How to solve the above problems is an urgent problem to be solved for the skills in the art.

### SUMMARY OF THE INVENTION

Regarding the disadvantages in the prior art, it is an object of the present invention to provide a liquid crystal dimming device, which has a higher transmittance, a better contrast rate and a higher stability (VHR (initial), VHR (Ra)), can solve the problems of display mura and the image sticking of the dimming device, and meets the requirements on the operation temperature range in the construction and transportation fields.

To realize the above invention object, the present invention adopts the following technical solutions:

For one thing, the present invention provides a liquid crystal dimming device, sequentially comprising, from bottom to top, a lower substrate, a lower conductive layer, a lower alignment layer, a guest-host liquid crystal composition layer, an upper alignment layer, an upper conductive layer, and an upper substrate;
alignment directions of the upper alignment layer and the lower alignment layer are parallel alignment;
the guest-host liquid crystal composition layer comprises at least one dichroic dye, at least one chiral agent and at least one liquid crystal composition;
wherein, the liquid crystal composition comprises at least one compound of general formula N:

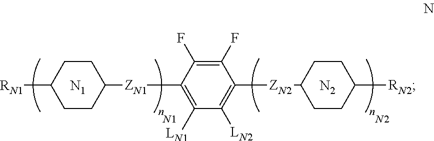

wherein,
R_{N1} and R_{N2} each independently represents C₁₋₁₂ (for example, C₁, C₂, C₃, C₄, C₅, C₆, C₇, C₈, C₉, C₁₀, C₁₁, or C₁₂) linear or branched alkyl,

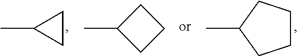

one or more than two nonadjacent —CH₂— in the C₁₋₁₂ linear or branched alkyl can each be independently replaced by —CH═CH—, —C≡C—, —O—, —CO—, —CO—O— or —O—CO—;
ring

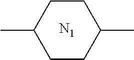

and ring

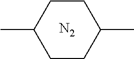

each independently represents

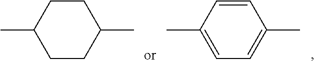

wherein one or more —CH₂— in

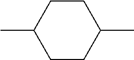

can be replaced by —O—, one or more single bond in the rings can be replaced by double bond, wherein one or more —H on

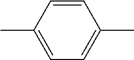

can each be independently substituted by —F, —Cl or —CN, and one or more —CH═ in the rings can be replaced by —N═;
Z_{N1} and Z_{N2} each independently represents single bond, —CO—O—, —O—CO—, —CH₂O—, —OCH₂—, —CH═CH—, —C≡C—, —CH₂CH₂—, —CF₂CF₂—, —(CH₂)₄—, —CF₂O— or —OCF₂—;
L_{N1} and L_{N2} each independently represents —H, halogen, C₁₋₃ (for example, C₁, C₂, or C₃) alkyl, or C₁₋₃ (for example, C₁, C₂, or C₃) alkoxy; and
n_{N1} represents 0, 1, 2 or 3, n_{N2} represents 0 or 1, and 0≤n_{N1}+n_{N2}≤3, when n_{N1}=2 or 3, ring

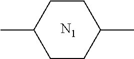

can be the same or different, and Z_{N1} can be the same or different.

In some embodiments of the present invention, the compound of general formula N is selected from a group consisting of the following compounds:

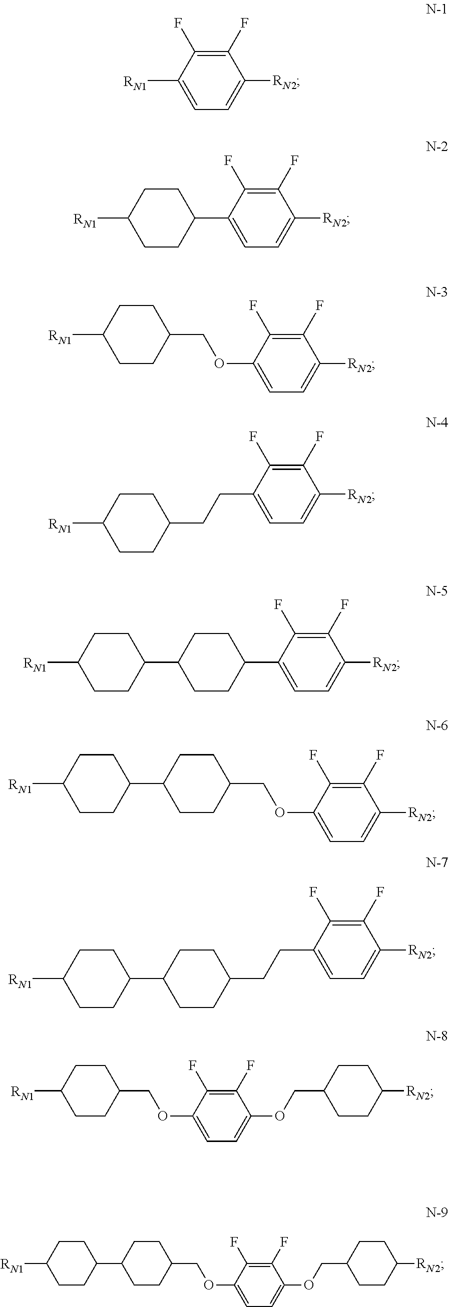

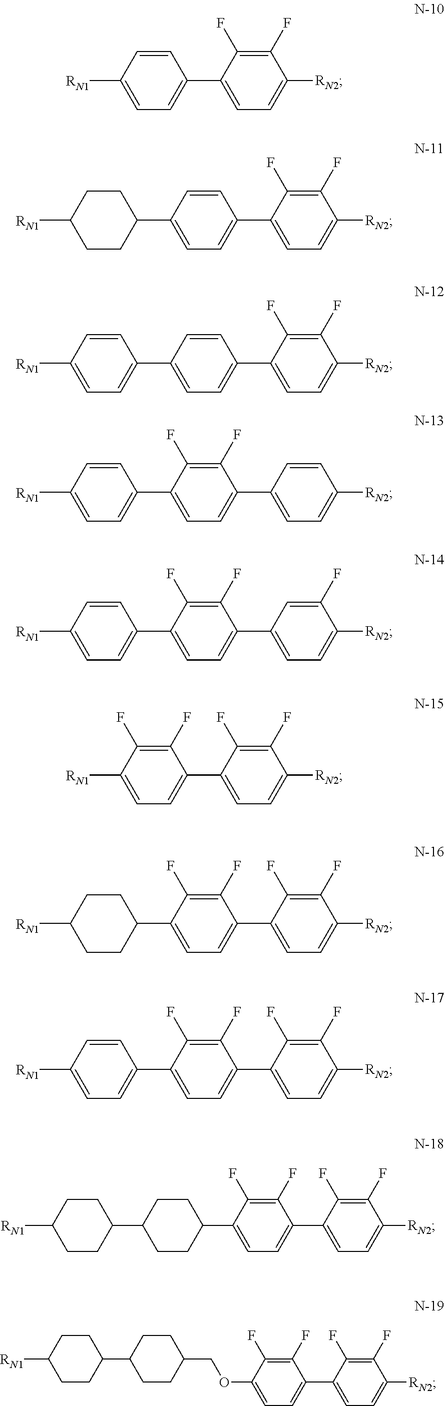

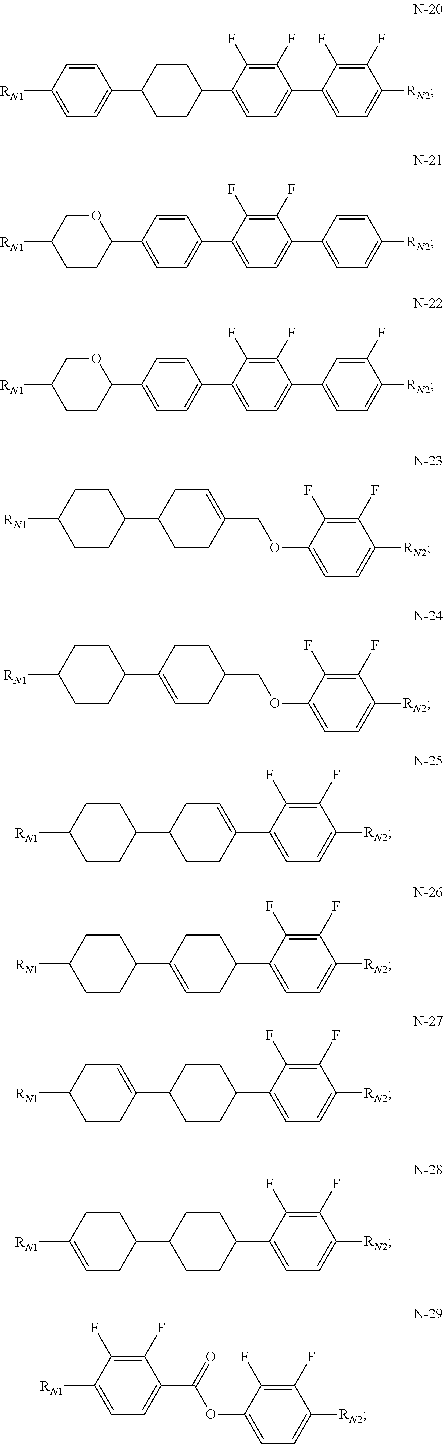

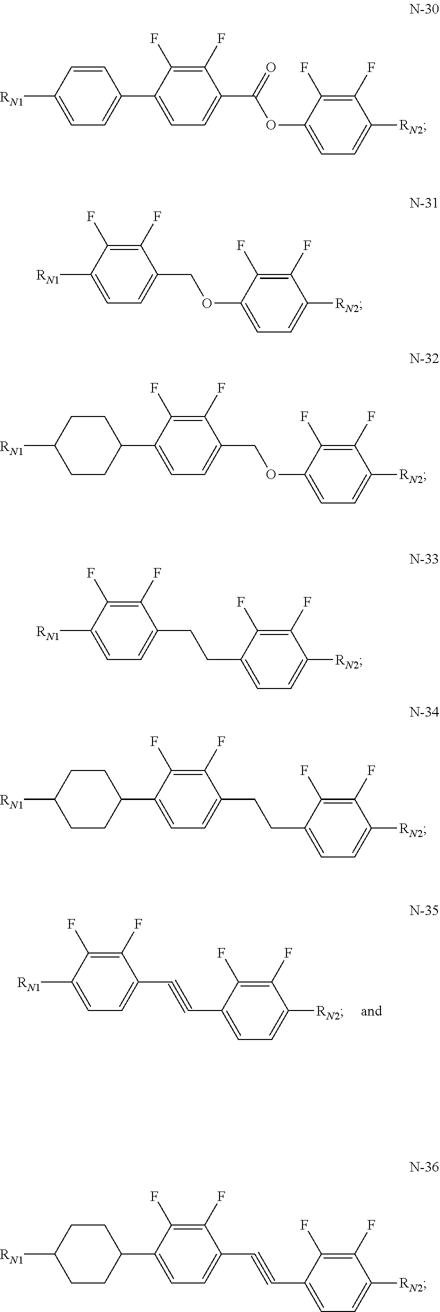

wherein R_{N1} and R_{N2} are defined the same as those in the general formula N.

In some embodiments of the present invention, the compound of general formula N provides 0.1-98 wt. % (including any of the numerical values or sub-ranges therebetween) of the liquid crystal composition, for example, 0.1 wt. %, 1 wt. %, 2 wt. %, 4 wt. %, 6 wt. %, 8 wt. %, 10 wt. %, 11 wt. %, 12 wt. %, 13 wt. %, 14 wt. %, 15 wt. %, 16 wt. %, 17 wt. %, 18 wt. %, 20 wt. %, 22 wt. %, 24 wt. %, 25 wt. %, 26 wt. %, 28 wt. %, 30 wt. %, 32 wt. %, 34 wt. %, 35 wt. %, 36 wt. %, 38 wt. %, 40 wt. %, 42 wt. %, 44 wt. %, 46 wt. %, 48 wt. %, 50 wt. %, 52 wt. %, 54 wt. %, 56 wt. %, 58 wt. %, 60 wt. %, 62 wt. %, 64 wt. %, 66 wt. %, 68 wt. %, 70 wt. %, 72 wt. %, 74 wt. %, 76 wt. %, 78 wt. %, 80 wt. %, 82 wt. %, 84 wt. %, 86 wt. %, 88 wt. %, 90 wt. %, 92 wt. %, 94 wt. %, 96 wt. %, 98 wt. % or a range between any two numerical values of these.

In order to achieve a better display effect and effectively avoid the problems of display mura and the image sticking, the compound of general formula N is selected from compounds of a group consisting of the compound of general formula N-2, the compound of general formula N-5, the compound of general formula N-11.

In some embodiments of the present invention, preferably, R_{N1} and R_{N2} each independently represents C₁₋₁₀ linear or branched alkyl, C₁₋₉ linear or branched alkoxy, or C₂₋₁₀ linear or branched alkenyl; further preferably, R_{N1} and R_{N2} each independently represents C₁₋₈ linear or branched alkyl, C₁₋₇ linear or branched alkoxy, or C₂₋₈ linear or branched alkenyl; still further preferably, R_{N1} and R_{N2} each independently represents C₁₋₅ linear or branched alkyl, C₁₋₄ linear or branched alkoxy, or C₂₋₅ linear or branched alkenyl.

In the present invention, the range of numerical values involved in limiting the number of carbon atoms of a group means that the number of carbon atoms may be all optional integers within the limited range, for example, C₁₋₁₀ means that the number of carbon atoms may be 1, 2, 3, 4, 5, 6, 7, 8, 9, or 10, and so forth.

In some embodiments of the present invention, the dielectric anisotropy of the liquid crystal component <0 (for example, <−1, <−2, <−2, <−3, <−4, <−5, <−6).

In the present invention, the twisting of the liquid crystal molecules can be suppressed when alignment directions of the upper alignment layer and the lower alignment layer are parallel alignment, and the anti-twisting does not tend to occur under the power-applied state of the dimming device, causing a better twisting state of the super-twisted negative liquid crystal and a more uniform display of the liquid crystal dimming device of the present invention, which effectively improves the problem of image sticking.

In some embodiments of the present invention, the dichroic dye molecule is one or more dyes selected from the group consisting of dyes of azo type, anthraquinone type, phthalocyanine, cyanine type, indigoid, arylmethane, nitro and nitroso.

In some embodiments of the present invention, the dichroic dye molecule is selected from the group consisting of dyes of azo type and anthraquinone type.

In the present invention, the dichroic dyes show different absorption properties for the visible spectrum according to the difference on the structure, a single dichroic dye mainly absorbs light of a specific wavelength and the color displayed is the complementary color of the all lights that pass through, and it is difficult to achieve black color with one single dye, therefore, it is needed to mix a variety of dyes to absorb lights of a plurality of wavelengths, and then achieve an even absorption of the visible light band according to the degree of sensitivity of the human eye to light, which is called black. As to the liquid crystal dimming device containing dichroic dyes, in the visible light band, the more uniform the absorption of light of different wavelengths by the liquid crystal composition, the more uniform the distribution of the transmittance curve, the better the display effect of the display device. Therefore, in the coordination of a variety of dichroic dyes, a suitable proportion and better chromaticity reproduction thereof shall be selected; in addition, the better the mutual solubility of the liquid crystal composition and the dye, the higher the content of the dichroic dye to be added, and the higher the contrast rate thereof.

In some embodiments of the present invention, the dichroic dye molecule is selected from the group consisting of the following compounds:

| Dye | | λmax | |
|---|---|---|---|
| No. | Molecular Structure | (nm) | Color |
| 1 | 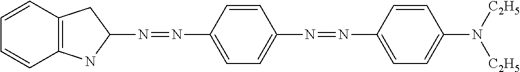 [SMILES: CCN(CC)c1ccc(N=Nc2ccc(N=NC3Cc4ccccc4N3)cc2)cc1] | 574 | Violet |
| 2 | 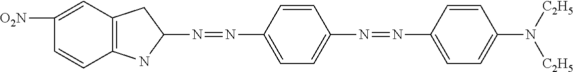 [SMILES: CCN(CC)c1ccc(N=Nc2ccc(N=NC3Cc4cc([N+](=O)[O-])ccc4N3)cc2)cc1] | 610 | Blue- green |
| 3 | 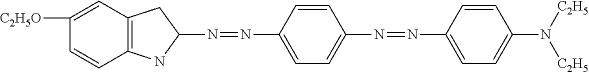 | 570 | Violet |
| 4 | 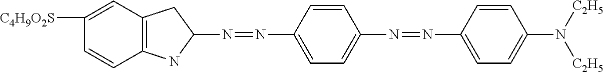 | 595 | Blue- green |
| 5 | 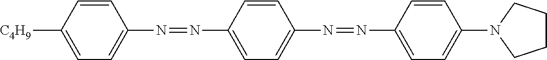 | 507 | Purple |
| 6 | 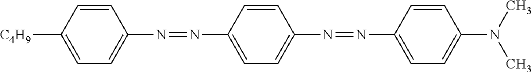 | 526-533 | Purple |
| 7 | 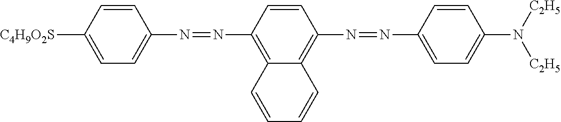 | 573 | Violet |
| 8 | 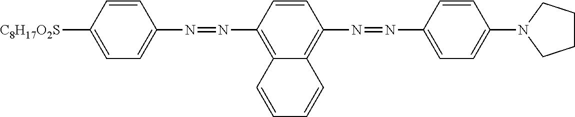 | 574 | Violet |
| 9 | 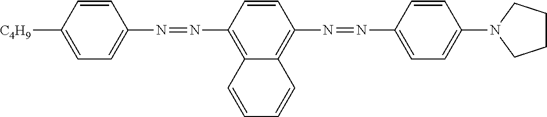 | 533-542 | Purple |
| 10 | 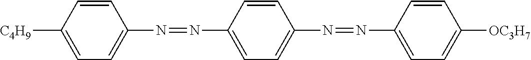 | 390-398 | Yellow |
| 11 | 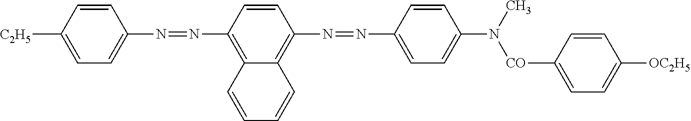 [SMILES: CCOc1ccc(C(=O)N(C)c2ccc(N=Nc3ccc(N=Nc4ccc(CC)cc4)c4ccccc34)cc2)cc1] | 402 | Yellow |
| 12 | 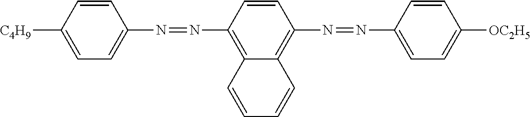 | 439-446 | Orange- yellow |
| 13 | 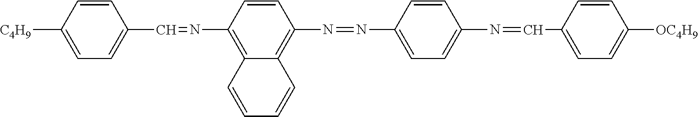 | 443-450 | Orange- yellow |
| 14 | 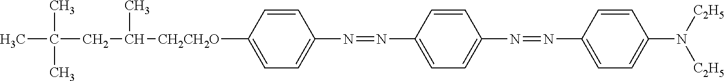 | 511 | Red |
| 15 | 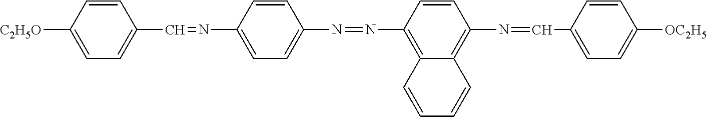 | 447 | Orange- yellow |
| 16 | 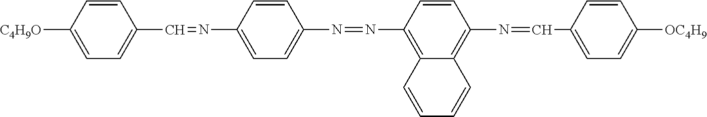 | 450 | Orange- yellow |
| 17 | 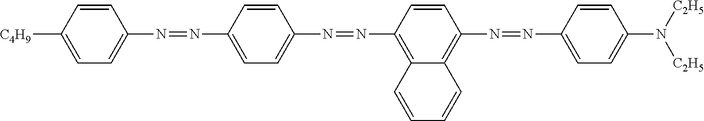 | 563-573 | Blue- violet |
| 18 | 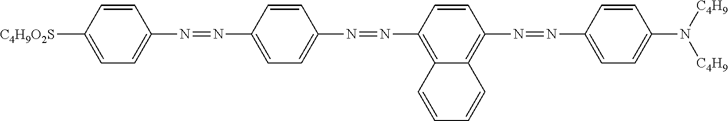 | 580-589 | Blue- green |
| 19 | 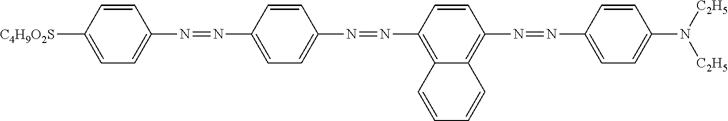 | 591-599 | Blue- green |
| 20 | 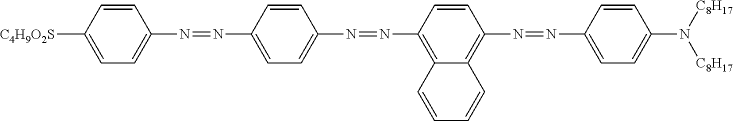 | 592-600 | Blue- green |
| 21 | 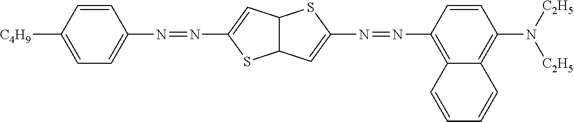 | 621-660 | Blue |
| 22 | 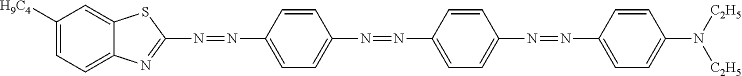 | 591-606 | Blue- green |
| 23 | 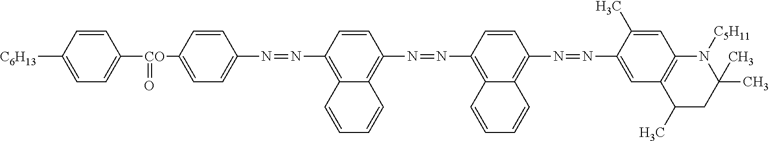 | 634-643 | Blue |
| 24 | 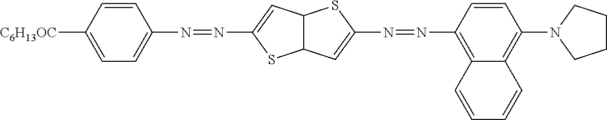 | 674 | Blue |
| 25 | 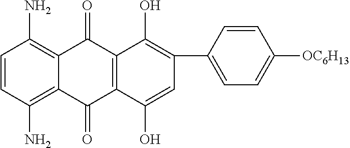 | 640 | Blue |
| 26 | 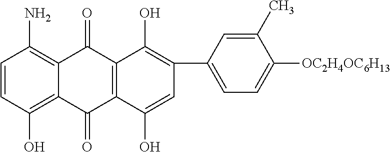 | 645 | Blue |
| 27 | 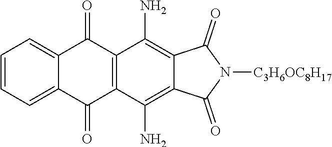 | 680 | Blue |
| 28 | 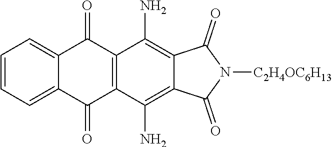 | 760 | Blue |
| 29 | 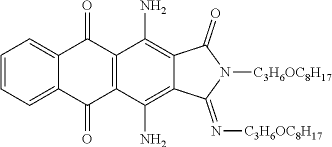 | 670 | Blue |
| 30 | 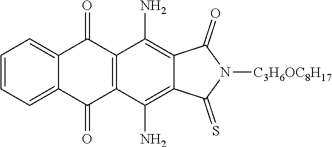 | 760 | Blue |
| 31 | 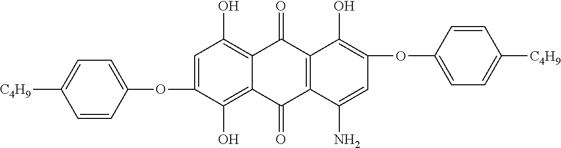 | 595 | Blue- green |
| 32 | 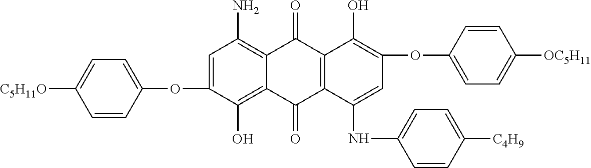 | 630 | Blue |
| 33 | 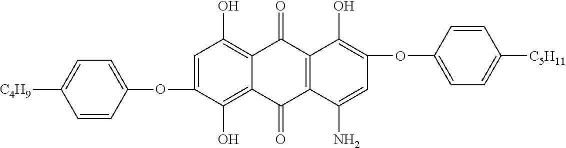 | 595 | Blue- green |
| 34 | 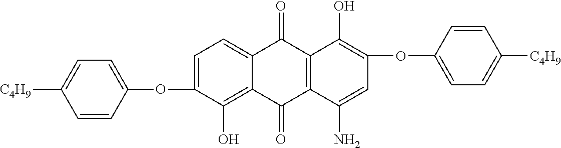 | 535 | Purple |
| 35 | 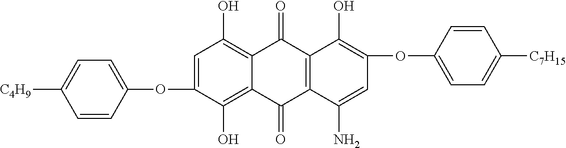 | 595 | Blue- green |

In some embodiments of the present invention, the dichroic dye provides 0.01-10 wt. % of the total weight of the liquid crystal composition (including any of the numerical values or sub-ranges therebetween), for example, 0.1 wt. %, 0.5 wt. %, 1 wt. %, 1.2 wt. %, 1.5 wt. %, 1.8 wt. %, 2 wt. %, 2.2 wt. %, 2.5 wt. %, 2.8 wt. %, 3 wt. %, 3.2 wt. %, 3.5 wt. %, 3.8 wt. %, 4 wt. %, 4.2 wt. %, 4.5 wt. %, 4.8 wt. %, 5 wt. %, 5.2 wt. %, 5.5 wt. %, 5.8 wt. %, 6 wt. %, 6.2 wt. %, 6.5 wt. %, 6.8 wt. %, 7 wt. %, 7.2 wt. %, 7.5 wt. %, 7.8 wt. %, 8 wt. %, 8.2 wt. %, 8.5 wt. %, 8.8 wt. %, 9 wt. %, 9.2 wt. %, 9.5 wt. %, 9.8 wt. %, 10 wt. %, or a range between any two numerical values of these; preferably, 1-6 wt. %.

In some embodiments of the present invention, the dichroic dye molecule is selected from a combination of one or at least two of the dye of the dye number of 5 to the dye of the dye number of 35; preferably, a combination of one or at least two of the dye of the dye number of 5 to the dye of the dye number of 22.

In some embodiments of the present invention, the violet dye is selected from a combination of one or at least two of the dye of the dye number of 5 to the dye of the dye number of 9.

In some embodiments of the present invention, the orange dye is selected from a combination of one or at least two of the dye of the dye number of 10 to the dye of the dye number of 16.

In some embodiments of the present invention, the blue dye is selected from a combination of one or at least two of the dye of the dye number of 17 to the dye of the dye number of 35; preferably, a combination of one or at least two of the dye of the dye number of 17 to the dye of the dye number of 22.

In some embodiments of the present invention, the liquid crystal composition further comprises at least one compound of general formula M:

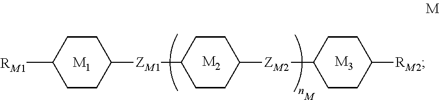

wherein,
R_{M1} and R_{M2} each independently represents C₁₋₁₂ linear or branched alkyl,

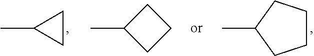

one or more than two nonadjacent —CH₂— in the C₁₋₁₂ linear or branched alkyl can each be independently replaced by —CH═CH—, —C≡C—, —O—, —CO—, —CO—O— or —O—CO—;
ring

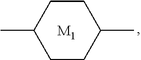

ring

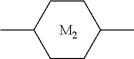

and ring

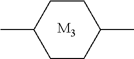

each independently represents

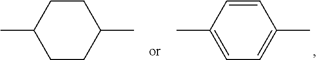

wherein one or more —CH₂— in

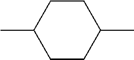

can be replaced by —O—, and one or more single bond in the rings can be replaced by double bond, at most one —H on

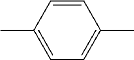

can be substituted by halogen;
Z_{M1} and Z_{M2} each independently represents single bond, —CO—O—, —O—CO—, —CH₂O—, —OCH₂—, —C≡C—, —CH═CH—, —CH₂CH₂— or —(CH₂)₄—; and
n_{M} represents 0, 1 or 2, wherein when n_{M}=2, ring

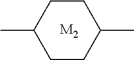

can be same or different, Z_{M2} can be the same or different.

The alkenyl group in the present invention is preferably selected from the groups represented by any one of formula (V1) to formula (V9), particularly preferably, formula (V1), formula (V2), formula (V8) or formula (V9). The groups represented by formula (V1) to formula (V9) are shown as follows:

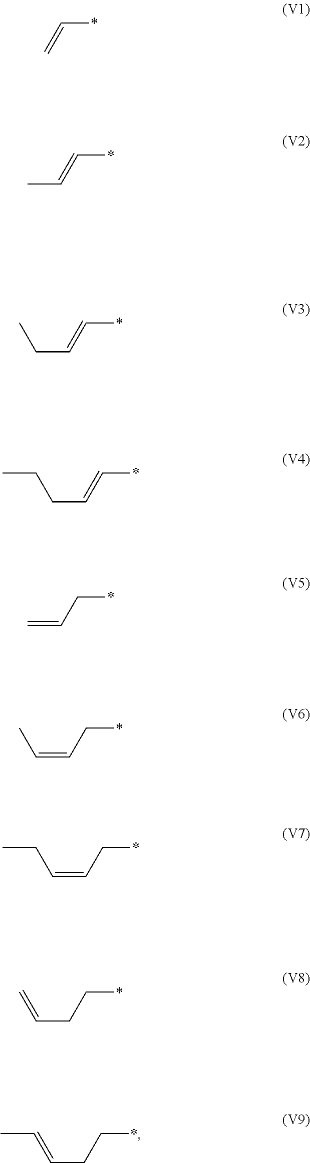

in which, * represents carbon atom bound in the ring structure.

The alkenoxy group in the present invention is preferably selected from the groups represented by any one of formula (OV1) to formula (OV9), particularly preferably, formula (OV1), formula (OV2), formula (OV8) or formula (OV9). The groups represented by formula (OV1) to formula (OV9) are shown as follows:

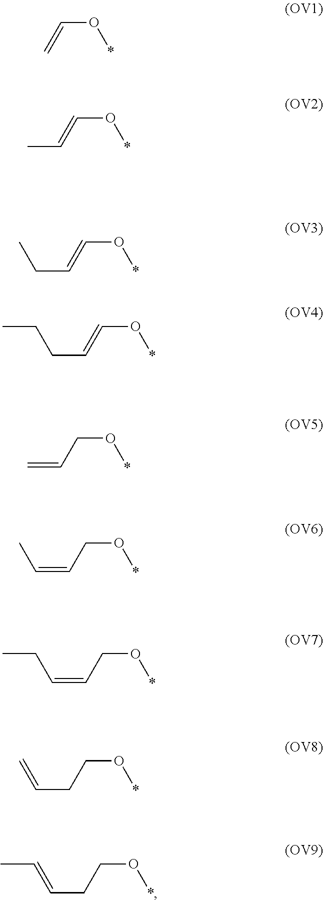

in which, * represents carbon atom bound in the ring structure.

In some embodiments of the present invention, the compound of general formula M is selected from a group consisting of the following compounds:

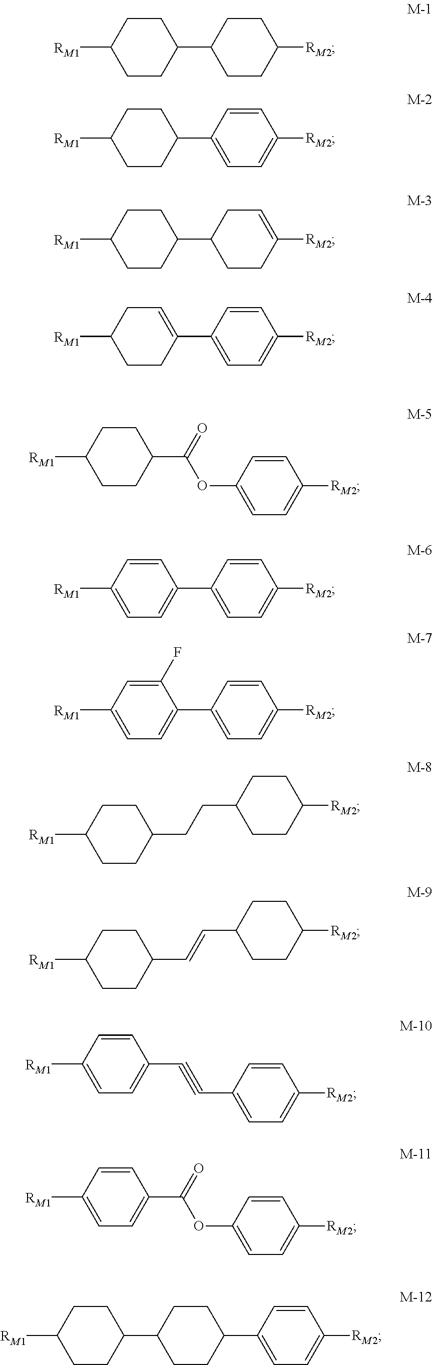

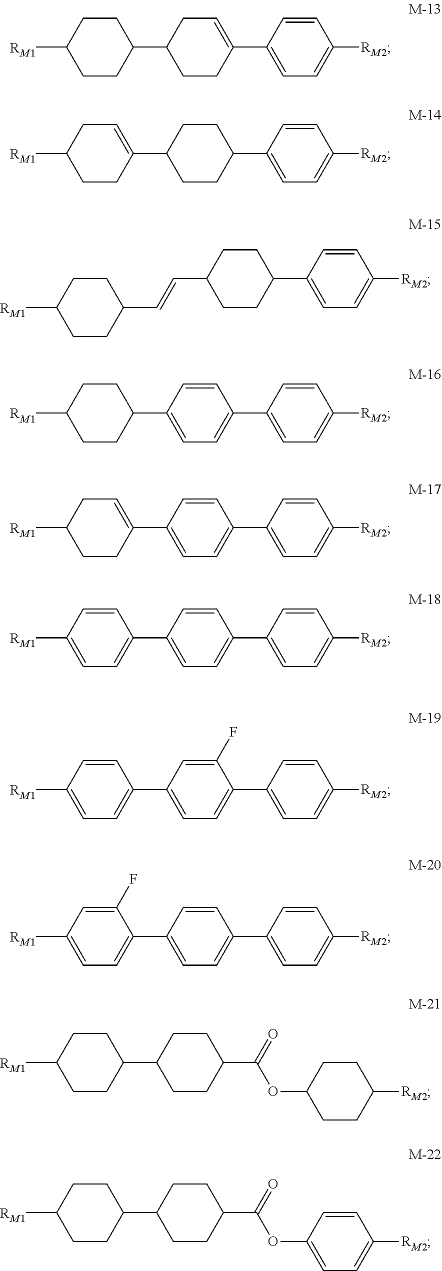

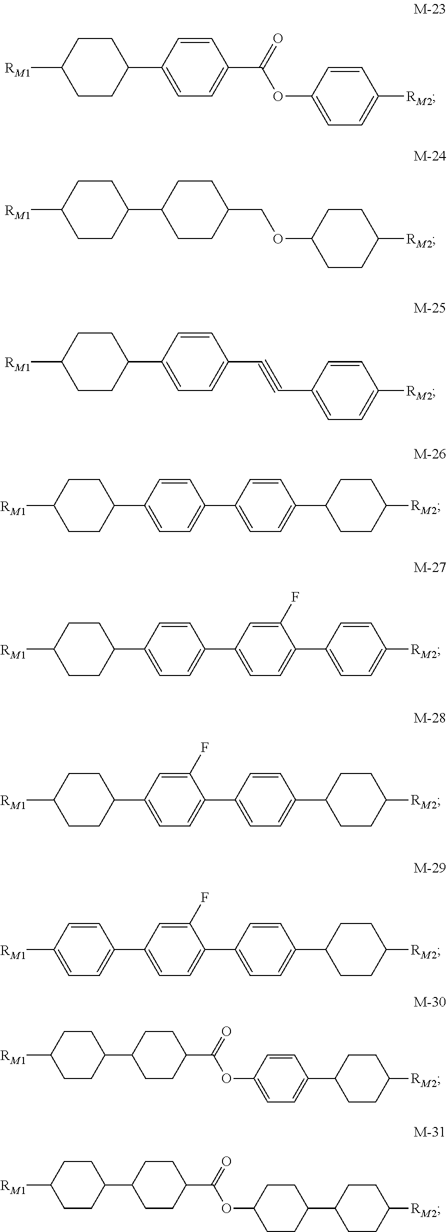

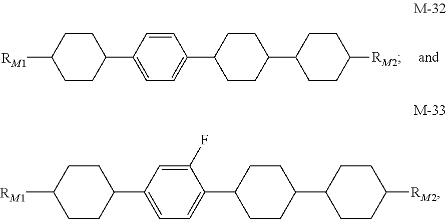

wherein R_{M1} and R_{M2} are defined the same as those in the general formula M.

In some embodiments of the present invention, the compound of general formula M provides 0.1-60 wt. % of the total weight of the liquid crystal composition (including any of the numerical values or sub-ranges therebetween), for example, 0.1 wt. %, 1 wt. %, 2 wt. %, 4 wt. %, 6 wt. %, 8 wt. %, 10 wt. %, 11 wt. %, 12 wt. %, 13 wt. %, 14 wt. %, 15 wt. %, 16 wt. %, 17 wt. %, 18 wt. %, 20 wt. %, 22 wt. %, 24 wt. %, 25 wt. %, 26 wt. %, 28 wt. %, 30 wt. %, 32 wt. %, 34 wt. %, 35 wt. %, 36 wt. %, 38 wt. %, 40 wt. %, 42 wt. %, 44 wt. %, 46 wt. %, 48 wt. %, 50 wt. %, 52 wt. %, 54 wt. %, 56 wt. %, 58 wt. %, 60 wt. %, or a range between any two numerical values of these; preferably, the compound of general formula M provides 1-50 wt. % of the total weight of the liquid crystal composition.

In some embodiments of the present invention, in order to achieve a better display effect and effectively avoid the problems of display mura and the image sticking, the compound of general formula M is selected from compounds of a group consisting of the compound of general formula M-1, the compound of general formula M-2, the compound of general formula M-12, the compound of general formula M-16, the compound of general formula M-26, the compound of general formula M-27, the compound of general formula M-28, the compound of general formula M-29, the compound of general formula M-30, the compound of general formula M-31, the compound of general formula M-32, the compound of general formula M-33.

In some embodiments of the present invention, in order to achieve a better display effect (a higher VHR (initial), a higher VHR (Ra) and a wider operation temperature range) and effectively avoid the problems of display mura and the image sticking, the compound of general formula M comprises at least one compound selected from a group consisting of the compound of general formula M-26, the compound of general formula M-27, the compound of general formula M-28, the compound of general formula M-29, the compound of general formula M-30, the compound of general formula M-31, the compound of general formula M-32, the compound of general formula M-33.

In some embodiments of the present invention, preferably, R_{M1} and R_{M2} each independently is C₁₋₁₀ linear or branched alkyl, C₁₋₉ linear or branched alkoxy, or C₂₋₁₀ linear or branched alkenyl; further preferably, R_{M1} and R_{M2} each independently is C₁₋₈ linear or branched alkyl, C₁₋₇ linear or branched alkoxy, or C₂₋₈ linear or branched alkenyl; still further preferably, R_{M1} and R_{M2} each independently is C₁₋₅ linear or branched alkyl, C₁₋₄ linear or branched alkoxy, or C₂₋₅ linear or branched alkenyl.

In some embodiments of the present invention, preferably, R_{M1} and R_{M2} each independently is C₂₋₈ linear alkenyl; further preferably, each independently is C₂₋₅ linear alkenyl.

In some embodiments of the present invention, preferably, one of R_{M1} and R_{M2} is C₂₋₅ linear alkenyl and the other is C₁₋₅ linear alkyl.

In some embodiments of the present invention, preferably, R_{M1} and R_{M2} each independently is C₁₋₈ linear alkyl, or C₁₋₇ linear alkoxy; further preferably, each independently is C₁₋₅ linear alkyl, or C₁₋₄ linear alkoxy.

In some embodiments of the present invention, preferably, one of R_{M1} and R_{M2} is C₁₋₅ linear alkyl, and the other is C₁₋₅ linear alkyl, or C₁₋₄ linear alkoxy; further preferably, R_{M1} and R_{M2} each independently is C₁₋₅ linear alkyl.

In some embodiments of the present invention, it is preferred that both R_{M1} and R_{M2} are alkyl when reliability is valued; it is preferred that both R_{M1} and R_{M2} are alkoxy when reducing volatility of the compound is valued, and it is preferred that at least one of R_{M1} and R_{M2} is alkenyl when reducing viscosity is valued.

In some embodiments of the present invention, the liquid crystal composition further comprises at least one compound of general formula A-1 and/or general formula A-2:

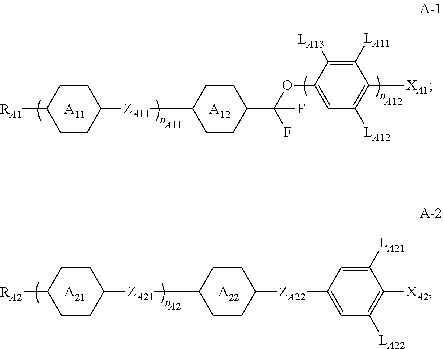

wherein,
R_{A1} and R_{A2} each independently represents C₁₋₁₂ linear or branched alkyl,

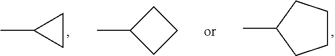

one or more than two nonadjacent —CH₂— in the C₁₋₁₂ linear or branched alkyl can each be independently replaced by —CH═CH—, —C≡C—, —O—, —CO—, —CO—O— or —O—CO—, and one or more —H in the C₁₋₁₂ linear or branched alkyl,

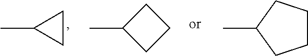

can each be independently substituted by —F or —Cl;
ring

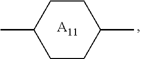

ring

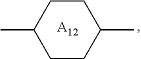

ring

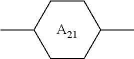

and ring

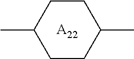

each independently represents

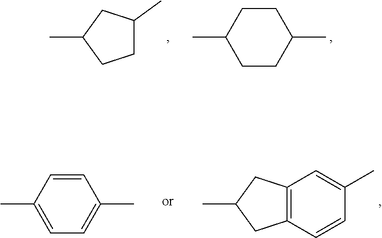

wherein one or more —CH₂— in

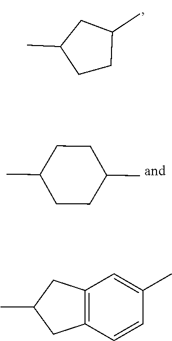

can be replaced by —O—, one or more single bond in the rings can be replaced by double bond, wherein one or more —H on

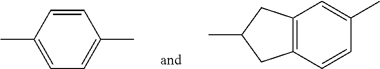

can each be independently substituted by —F, —Cl or —CN, one or more —CH═ in the rings can be replaced by —N═;
Z_{A11}, Z_{A21} and Z_{A22} each independently represents single bond, —CH₂CH₂—, —CF₂CF₂—, —CO—O—, —O—CO—, —O—CO—O—, —CH═CH—, —CF═CF—, —CH₂O— or —OCH₂—;
L_{A11}, L_{A12}, L_{A13}, L_{A21} and L_{A22} each independently represents —H, C₁₋₃ alkyl, or halogen;
X_{A1} and X_{A2} each independently represents halogen, C₁₋₅ halogenated alkyl or halogenated alkoxy, C₂₋₅ halogenated alkenyl or halogenated alkenoxy;
n_{A11} represents 0, 1, 2 or 3, when n_{A11}=2 or 3, ring

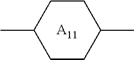

can be same or different, and Z_{A11} can be same or different;
n_{A12} represents 1 or 2, wherein when n_{A12}=2, ring

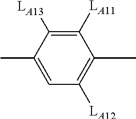

can be same or different; and
n_{A2} represents 0, 1, 2 or 3, wherein when n_{A2}=2 or 3, ring

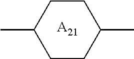

can be same or different, and Z_{A21} can be the same or different.

In some embodiments of the present invention, at least one compound of general formula A-1 and/or general formula A-2 provides 0.1-60 wt. % of the total weight of the liquid crystal composition (including any of the numerical values or sub-ranges therebetween), for example, 0.1 wt. %, 1 wt. %, 2 wt. %, 4 wt. %, 6 wt. %, 8 wt. %, 10 wt. %, 11 wt. %, 12 wt. %, 13 wt. %, 14 wt. %, 15 wt. %, 16 wt. %, 17 wt. %, 18 wt. %, 20 wt. %, 22 wt. %, 24 wt. %, 25 wt. %, 26 wt. %, 28 wt. %, 30 wt. %, 32 wt. %, 34 wt. %, 35 wt. %, 36 wt. %, 38 wt. %, 40 wt. %, 42 wt. %, 44 wt. %, 46 wt. %, 48 wt. %, 50 wt. %, 52 wt. %, 54 wt. %, 56 wt. %, 58 wt. %, 60 wt. %, or a range between any two numerical values of these.

In some embodiments of the present invention, the compound of general formula A-1 is selected from a group consisting of the following compounds:

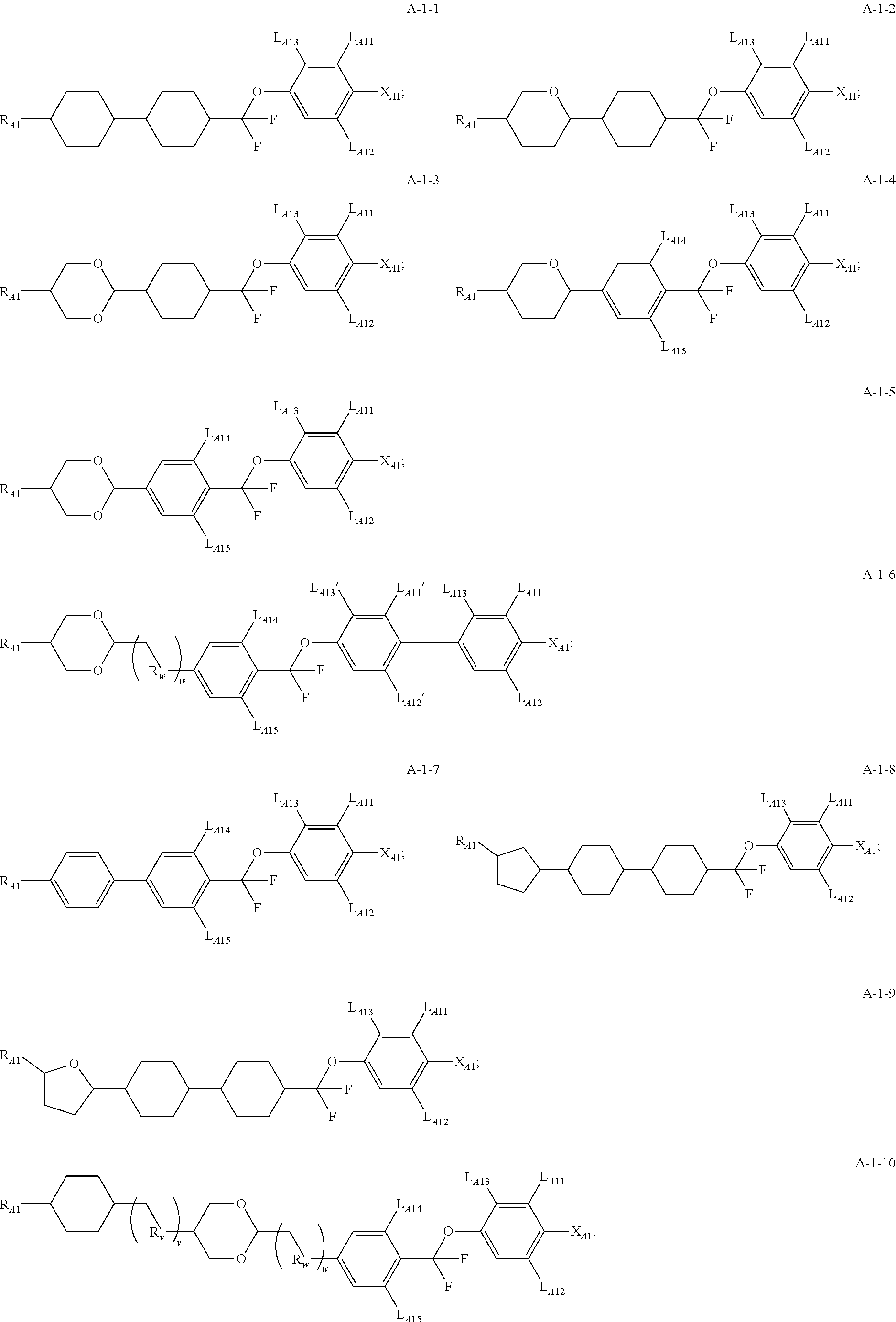

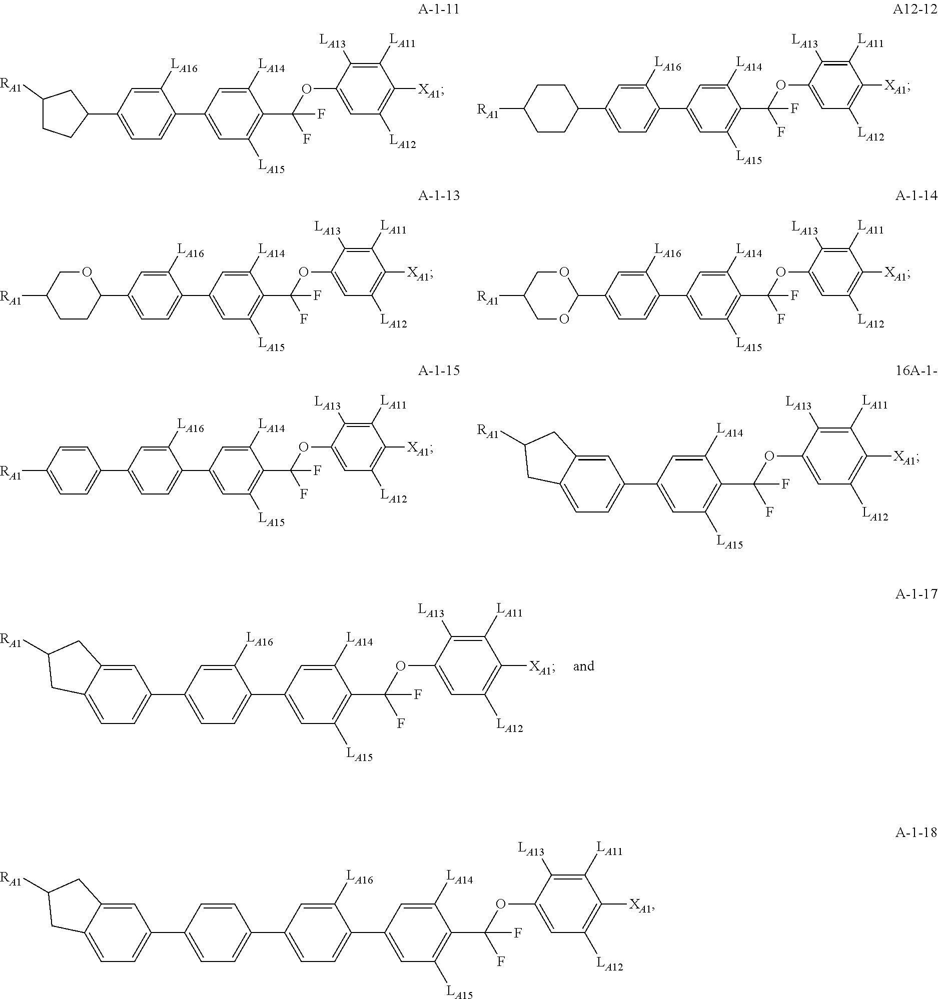

wherein
R_{A1} represents C₁₋₈ linear or branched alkyl, one or more than two nonadjacent —CH₂— in the C₁₋₈ linear or branched alkyl can each be independently replaced by —CH═CH—, —C≡C—, —O—, —CO—, —CO—O— or —O—CO—, and one or more —H in C₁₋₈ linear or branched alkyl can each be independently substituted by —F or —Cl;
Rᵥ and R_{w} each independently represents —CH₂— or —O—;
L_{A11}, L_{A12}, L_{A11}′, L_{A12}′, L_{A14}, L_{A15} and L_{A16} each independently represents —H or —F;
L_{A13} and L_{A13}′ each independently represents —H or —CH₃;
X_{A1} represents —F, —CF₃ or —OCF₃; and
v and w each independently represents 0 or 1.

In some embodiments of the present invention, the compound of general formula A-1 provides 0.1-50 wt. % (including any of the numerical values or sub-ranges therebetween) of the total weight of the liquid crystal composition, for example, 0.1 wt. %, 1 wt. %, 2 wt. %, 4 wt. %, 6 wt. %, 8 wt. %, 10 wt. %, 11 wt. %, 12 wt. %, 13 wt. %, 14 wt. %, 15 wt. %, 16 wt. %, 17 wt. %, 18 wt. %, 20 wt. %, 22 wt. %, 24 wt. %, 25 wt. %, 26 wt. %, 28 wt. %, 30 wt. %, 32 wt. %, 34 wt. %, 35 wt. %, 36 wt. %, 38 wt. %, 40 wt. %, 42 wt. %, 44 wt. %, 46 wt. %, 48 wt. %, 50 wt. %, or a range between any two numerical values of these.

In some embodiments of the present invention, the compound of general formula A-2 is selected from a group consisting of the following compounds:

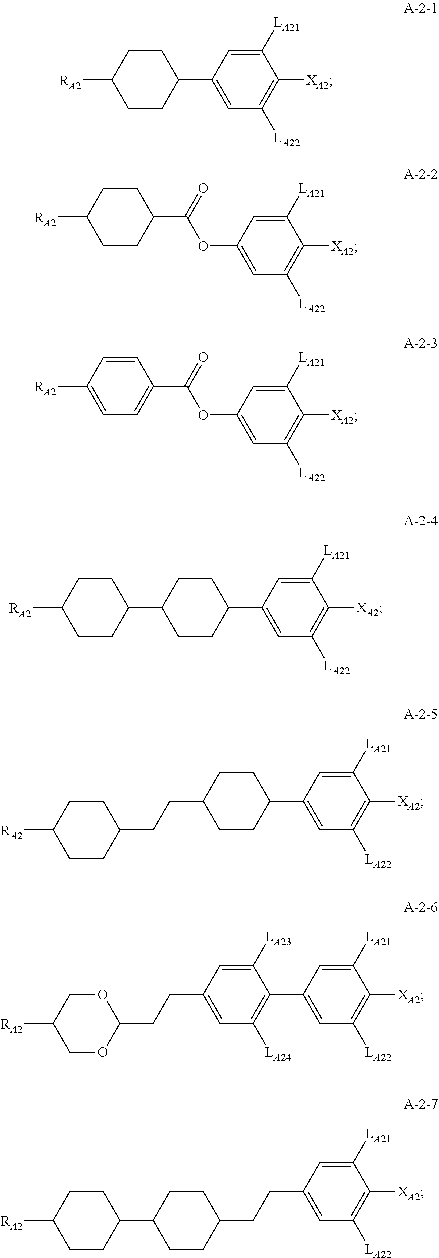

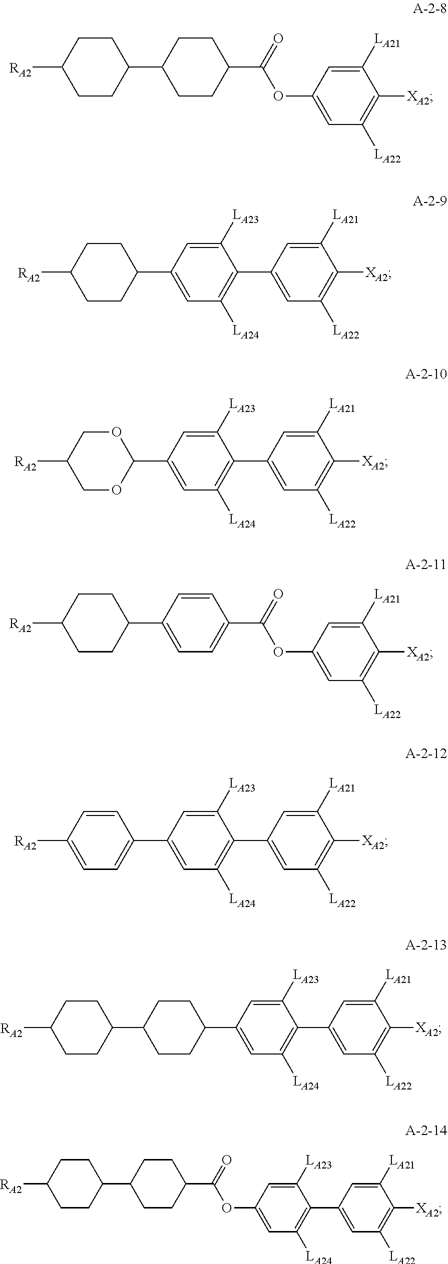

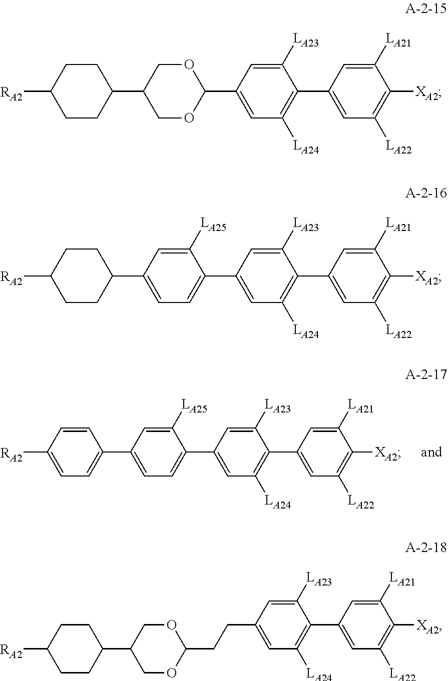

wherein
R_{A2} represents C₁₋₈ linear or branched alkyl, one or more than two nonadjacent —CH₂— in the C₁₋₈ linear or branched alkyl can each be independently replaced by —CH═CH—, —C≡C—, —O—, —CO—, —CO—O— or —O—CO—, and one or more —H in the C₁₋₈ linear or branched alkyl can each be independently substituted by —F or —Cl;
L_{A21}, L_{A22}, L_{A23}, L_{A24} and L_{A25} each independently represents —H or —F; and
X_{A2} represents —F, —CF₃, —OCF₃ or —CH₂CH₂CH═CF₂.

In some embodiments of the present invention, the compound of general formula A-2 provides 0.1-50 wt. % (including any of the numerical values or sub-ranges therebetween) of the total weight of the liquid crystal composition, for example, 0.1 wt. %, 1 wt. %, 2 wt. %, 4 wt. %, 6 wt. %, 8 wt. %, 10 wt. %, 11 wt. %, 12 wt. %, 13 wt. %, 14 wt. %, 15 wt. %, 16 wt. %, 17 wt. %, 18 wt. %, 20 wt. %, 22 wt. %, 24 wt. %, 25 wt. %, 26 wt. %, 28 wt. %, 30 wt. %, 32 wt. %, 34 wt. %, 35 wt. %, 36 wt. %, 38 wt. %, 40 wt. %, 42 wt. %, 44 wt. %, 46 wt. %, 48 wt. %, 50 wt. %, or a range between any two numerical values of these.

In some embodiments of the present invention, the liquid crystal composition further comprises at least one compound of general formula F:

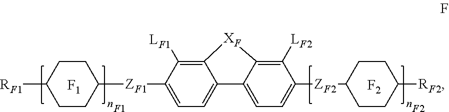

wherein
R_{F1} and R_{F2} each independently represents —H, halogen, C₁₋₁₂ linear or branched alkyl,

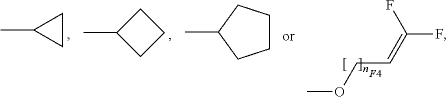

one or more than two nonadjacent —CH₂— in the C₁₋₁₂ linear or branched alkyl,

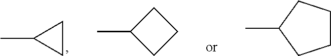

can each be independently replaced by —C≡C—, —O—, —S—, —CO—, —CO—O— or —O—CO—, and one or more —H in the C₁₋₁₂ linear or branched alkyl can each be independently substituted by —F or —Cl;
ring

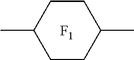

and ring

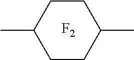

each independently represents

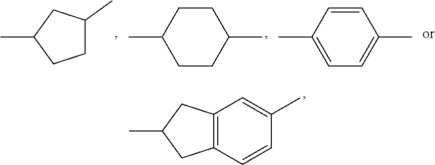

wherein one or more —CH₂— in

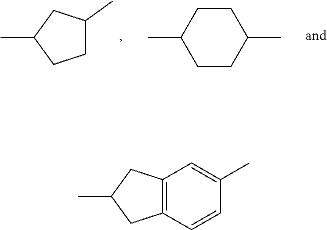

can be replaced by —O—, and one or more single bond in the rings can be replaced by double bond, wherein one or more —H on

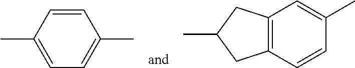

can each be independently substituted by —CN, —F or —Cl, and one or more —CH═ in the rings can be replaced by —N═;
X_{F} represents —O—, —S— or —CO—; L_{F1} and L_{F2} each independently represents —H, —F, —Cl, —CF₃ or —OCF₃;
Z_{F1} and Z_{F2} each independently represents single bond, —O—, —CO—O—, —O—CO—, —CH₂O—, —OCH₂—, —CH═CH—, —C≡C—, —CH₂CH₂—, —CF₂CF₂—, —(CH₂)₄—, —CF₂O— or —OCF₂—;
n_{F1} and n_{F2} each independently represents 0, 1 or 2, wherein when n_{F1} represents 2, ring

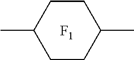

can be same or different, wherein when n_{F2} represents 2, ring

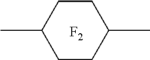

can be same or different, and Z_{F2} can be same or different; and
n_{F4} represents an integer of 0-4.

In some embodiments of the present invention, the compound of general formula F is selected from a group consisting of the following compounds:

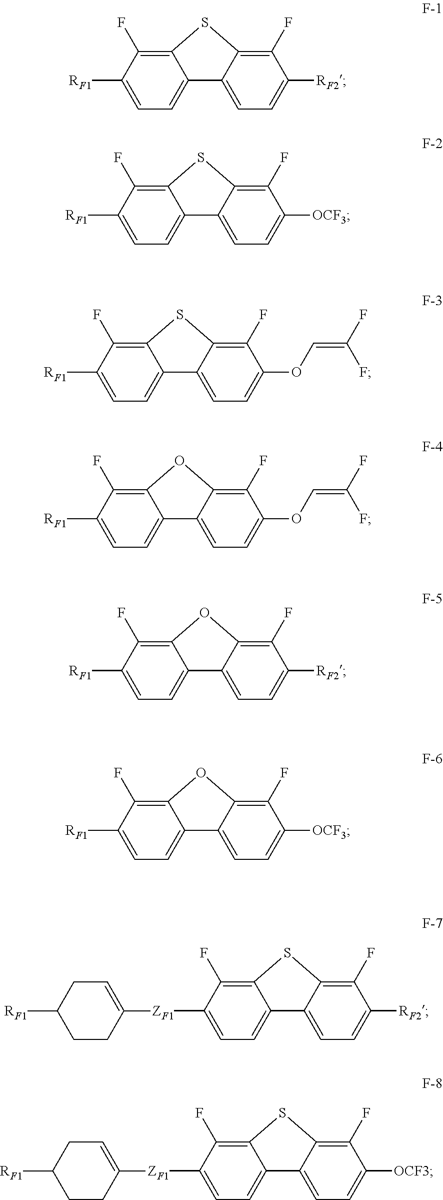

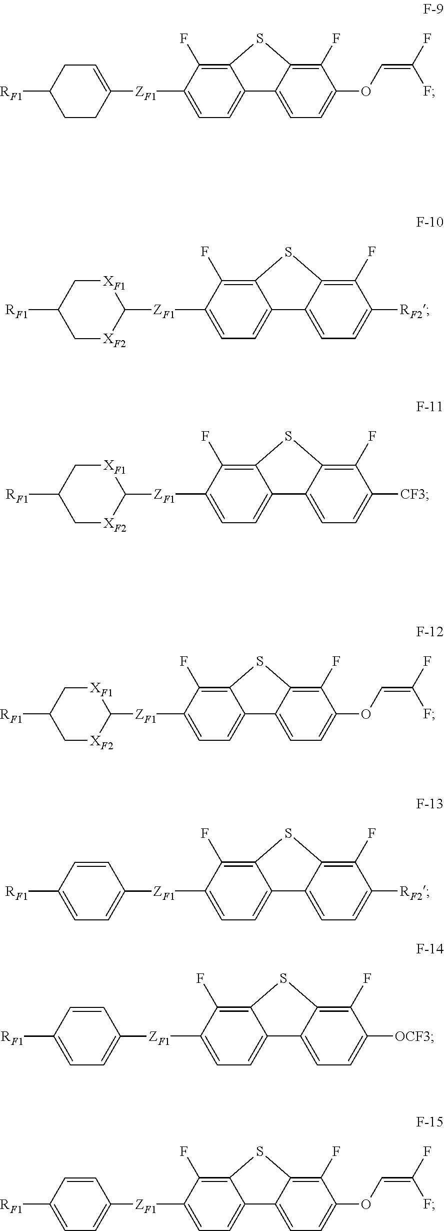

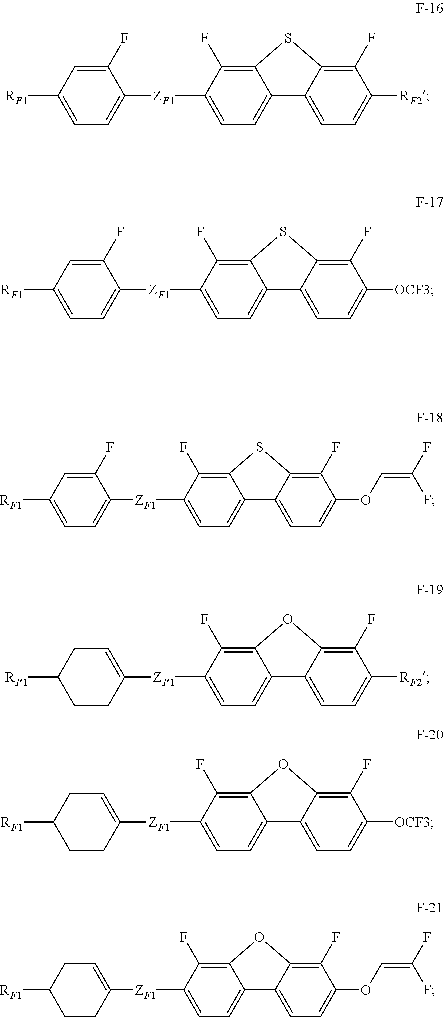

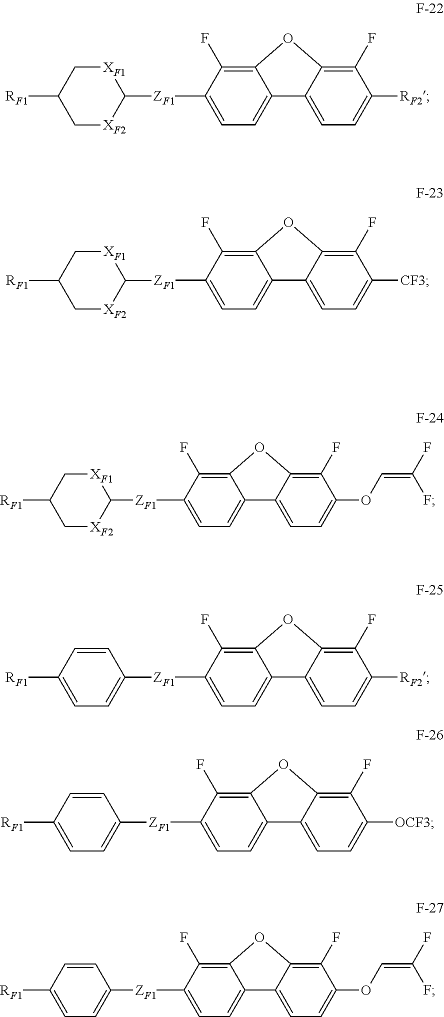

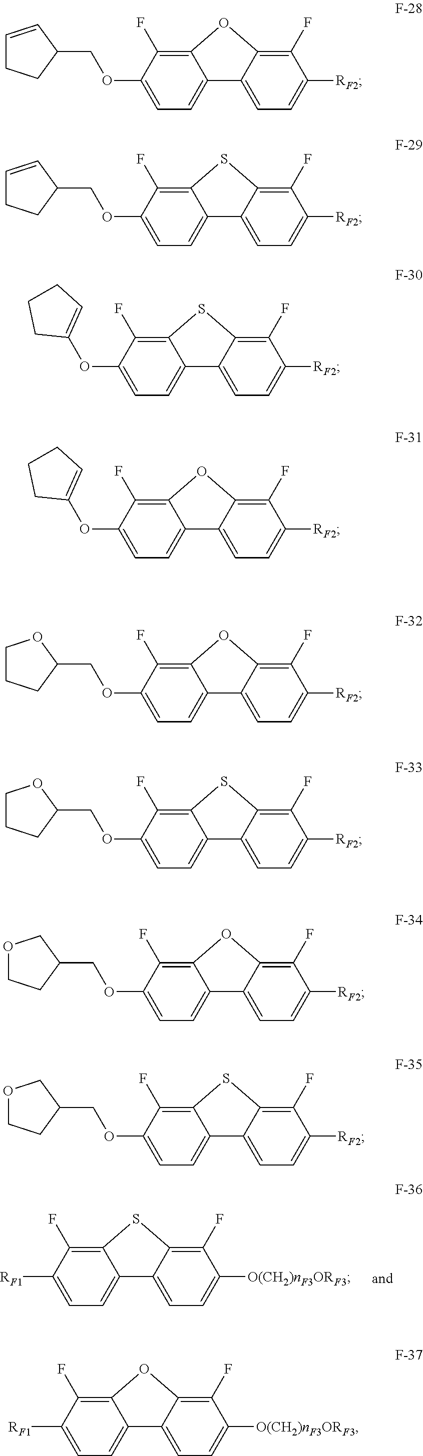

wherein
R_{F2}′ represents C₁₋₁₁ linear or branched alkoxy;
X_{F1} and X_{F2} each independently represents —CH₂— or —O—;
n_{F3} represents an integer of 1-5 (for example, 1, 2, 3, 4 or 5); and
R_{F3} represents C₁₋₅ linear or branched alkyl, or C₁₋₄ linear or branched alkoxy or C₂₋₅ linear or branched alkenyl.

In some embodiments of the present invention, the compound of general formula F provides 0.1-30 wt. % (including any of the numerical values or sub-ranges therebetween) of the total weight of the liquid crystal composition, for example, 0.1 wt. %, 0.5 wt. %, 1 wt. %, 2 wt. %, 4 wt. %, 6 wt. %, 8 wt. %, 10 wt. %, 11 wt. %, 12 wt. %, 13 wt. %, 14 wt. %, 15 wt. %, 16 wt. %, 17 wt. %, 18 wt. %, 20 wt. %, 22 wt. %, 24 wt. %, 25 wt. %, 26 wt. %, 28 wt. %, 30 wt. % or a range between any two numerical values of these.

In some embodiments of the present invention, the liquid crystal composition further comprises at least one polymerizable compound of general formula RM:

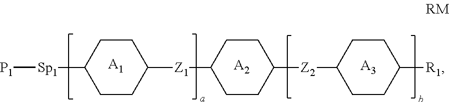

wherein,
ring

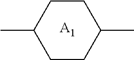

and ring

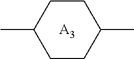

each independently represents

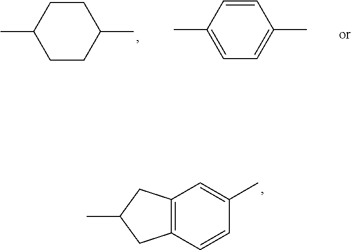

wherein one or more —CH₂— in

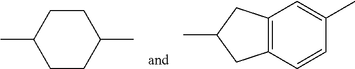

can be replaced by —O—, and one or more single bond in the rings can be replaced by double bond, wherein one or more —H on

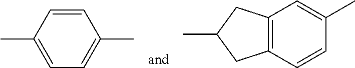

can each be independently substituted by —F, —Cl, —CN, —Sp₃-P₃, C₁₋₁₂ halogenated or unhalogenated linear alkyl, C₁₋₁₁ halogenated or unhalogenated linear alkoxy,

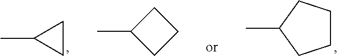

and one or more —CH═ in the rings can be replaced by —N═;
ring

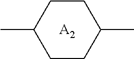

represents

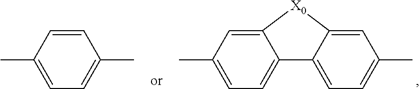

wherein one or more —H on

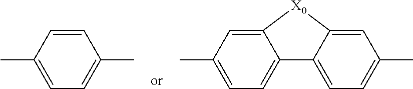

can each be independently substituted by —F, —Cl, —CN, —Sp₃-P₃, C₁₋₁₂ halogenated or unhalogenated linear alkyl, C₁₋₁₁ halogenated or unhalogenated linear alkoxy,

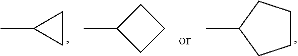

and one or more —CH═ in the rings can be replaced by —N═;
R₁ represents —H, halogen, —CN, —Sp₂-P₂, C₁₋₁₂ (for example, it can be C₁, C₂, C₃, C₄, C₅, C₆, C₇, C₈, C₉, C₁₀, C₁₁, or C₁₂) linear or branched alkyl,

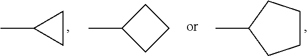

wherein one or more than two nonadjacent —CH₂— in the C₁₋₁₂ linear or branched alkyl,

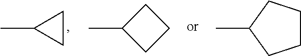

can each be independently replaced by —CH═CH—, —C≡C—, —O—, —CO—, —CO—O— or —O—CO—, and one or more —H can each be independently substituted by —F or —Cl;
P₁, P₂ and P₃ each independently represents a polymerizable group;
Sp₁, Sp₂ and Sp₃ each independently represents a spacer group or single bond;
X₀ represents —O—, —S— or —CO—;
Z₁ and Z₂ each independently represents —O—, —S—, —CO—, —CO—O—, —O—CO—, —O—CO—O—, —CH₂O—, —OCH₂—, —CH₂S—, —SCH₂—, —CF₂O—, —OCF₂—, —CF₂S—, —SCF₂—, —(CH₂)_{d}—, —CF₂CH₂—, —CH₂CF₂—, —(CF₂)_{d}—, —CH═CH—, —CF═CF—, —CH═CF—, —CF═CH—, —C≡C—, —CH═CH—CO—O—, —O—CO—CH═CH—, —CH₂CH₂—CO—O—, —O—CO—CH₂CH₂—, —CHR¹—, —CR¹R²— or single bond, wherein R¹ and R² each independently represents C₁₋₁₂ linear or branched alkyl, and d represents an integer of 1-4; and
a represents 0, 1 or 2, b represents 0 or 1, wherein when a represents 2, ring

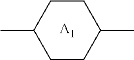

can be same or different, and Z₁ can be the same or different.

In some embodiments of the present invention, the polymerizable compound of general formula RM is selected from a group consisting of the following compounds:

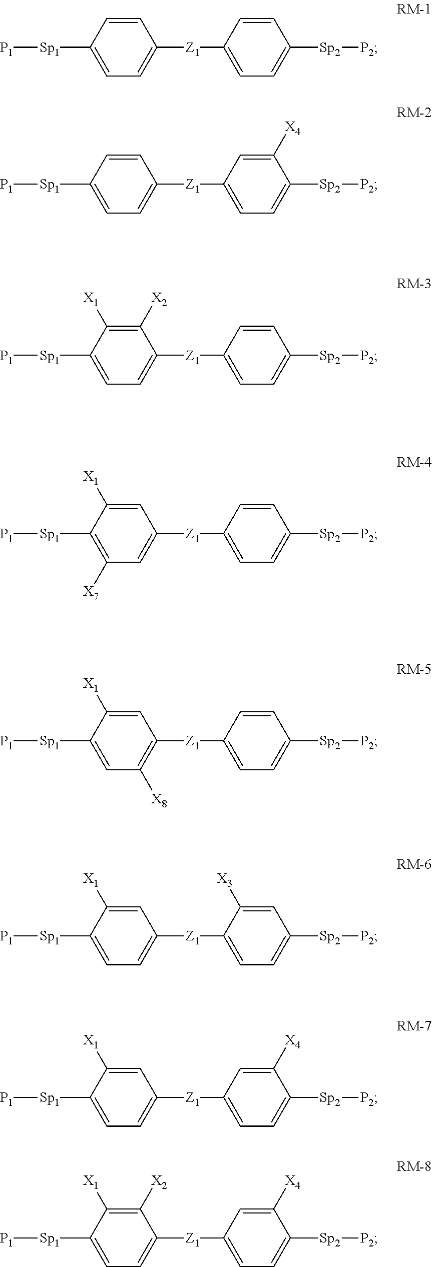

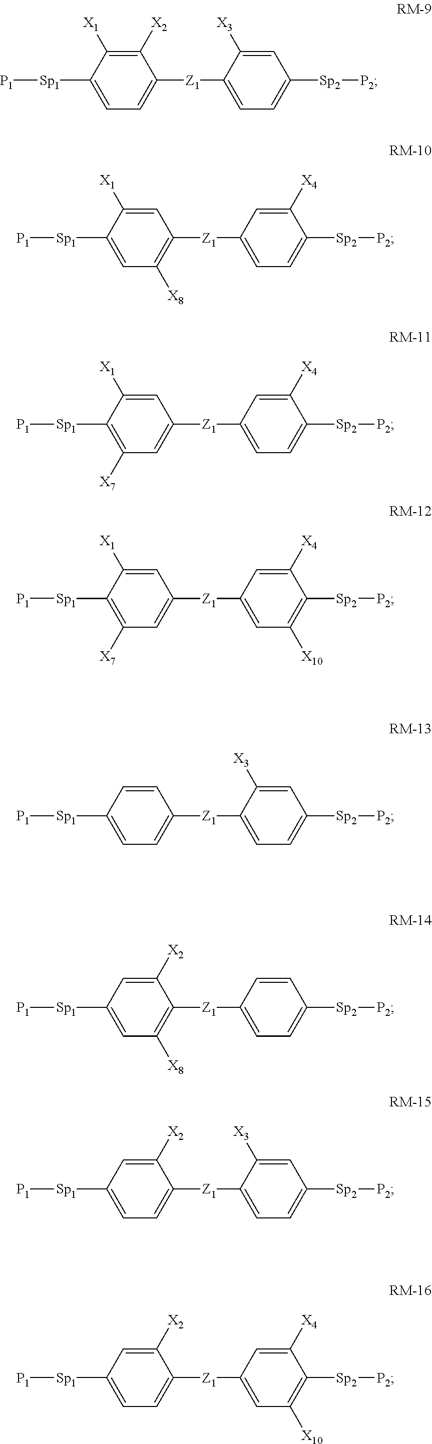

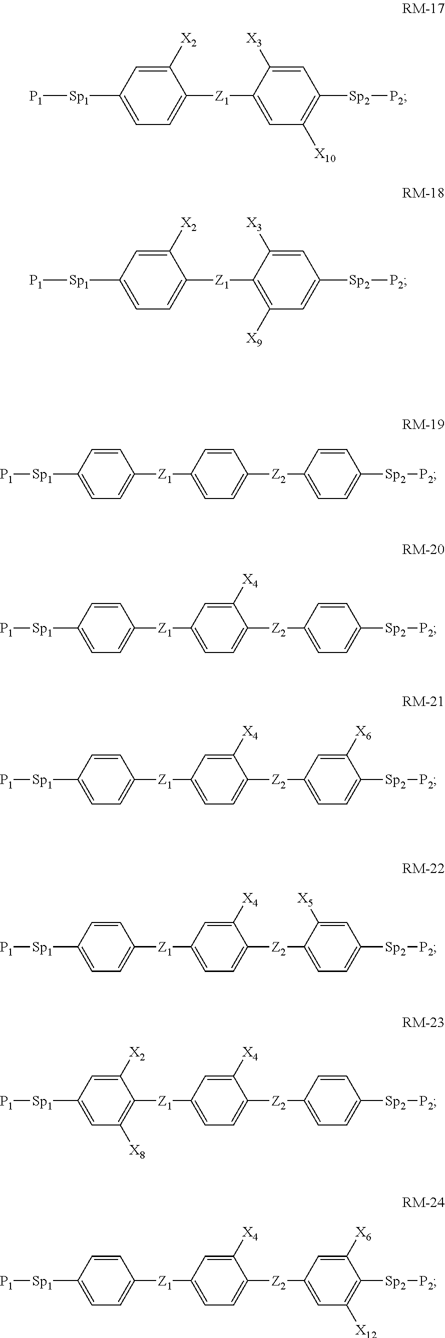

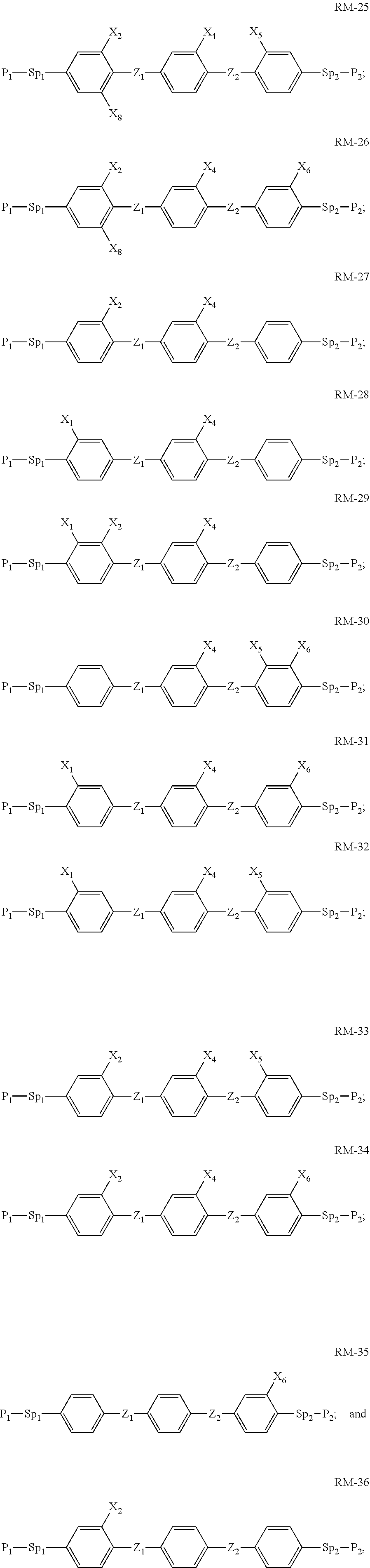

wherein
X₁-X₁₀ and X₁₂ each independently represents —F, —Cl, —Sp₃-P₃, C₁₋₅ linear alkyl or alkoxy,

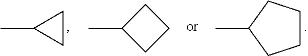

In some embodiments of the present invention, X₁-X₁₀ and X₁₂ each independently represents —F, —Cl, —Sp₃-P₃, —CH₃, or —OCH₃.

In some embodiments of the present invention, both of Sp₁ and Sp₂ represent a single bond.

The polymerizable groups involved in the present invention are groups suitable for polymerization reactions (for example, free radical or ionic bond polymerization, addition polymerization or condensation polymerization), or groups suitable for addition or condensation on the polymer backbone. For the chain polymerization, a polymerizable group containing —CH═CH— or —C≡C— is particularly preferred, and for the ring-opening polymerization, for example, an oxetanyl or epoxy group is particularly preferred.

In some embodiments of the present invention, the polymerizable groups P₁, P₂, P₃ each independently represents

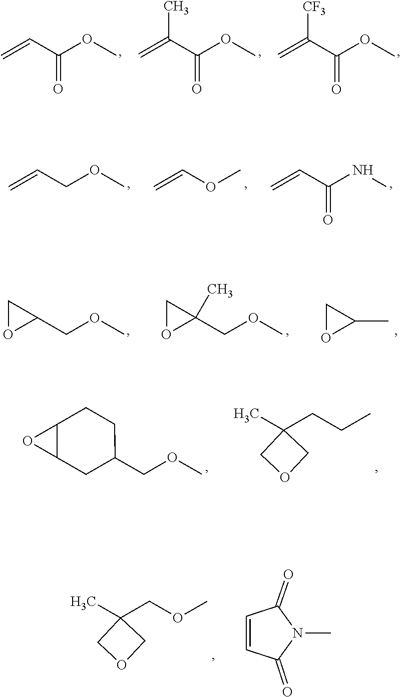

or —SH; preferably, the polymerizable groups P₁, P₂, P₃ each independently represents

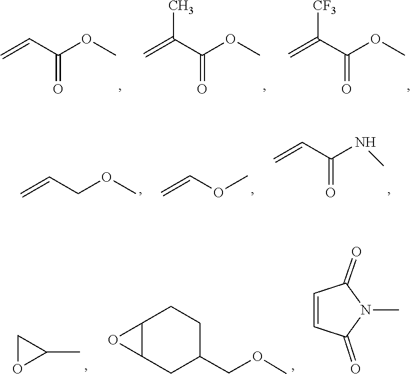

or —SH; further preferably, the polymerizable groups P₁, P₂, P₃ each independently represents

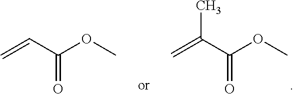

The term “spacer group” as used herein, is known to the person skilled in the art and is described in the references (for example, Pure Appl. Chem. 2001, 73(5), 888 and C. Tschierske, G. Pelzl, S. Diele, Angew. Chem. 2004, 116, 6340-6368). As used herein, the term “spacer group” represents a flexible group which connects the mesogenic group and the polymerizable group in a polymerizable compound. For example, —(CH₂)p₁-, —(CH₂CH₂O)q₁-CH₂CH₂—, —(CH₂CH₂S)q₁-CH₂CH₂—, —(CH₂CH₂NH)q₁-CH₂CH₂—, —CR⁰R⁰⁰—(CH₂)p₁- or —(SiR⁰R⁰⁰—O)p₁- are representative spacer groups, wherein p₁ represents an integer of 1-12 (for example, 1, 2, 3, 4, 5, 6, 7, 8, 9, 10, 11, or 12), q₁ represents an integer of 1-3 (for example, 1, 2, or 3), R⁰ and R⁰⁰ each independently represents —H, C₁₋₁₂ (for example, C₁, C₂, C₃, C₄, C₅, C₆, C₇, C₈, C₉, C₁₀, C₁₁, or C₁₂) linear or branched alkyl, or C₃₋₁₂ (for example, C₃, C₄, C₅, C₆, C₇, C₈, C₉, C₁₀, C₁₁, or C₁₂) cyclic alkyl. The particularly preferred spacer group is —(CH₂)p₁-, —(CH₂)p₁-O—, —(CH₂)p₁-O—CO—, —(CH₂)p₁-CO—O—, —(CH₂)p₁-O—CO—O— or —CR⁰R⁰⁰—(CH₂)ₚ₁—.

In some embodiments of the present invention, the polymerizable compound of general formula RM provides 0.001-5 wt. % (including any of the numerical values or sub-ranges therebetween) of the total weight of the liquid crystal composition, for example, 0.001 wt. %, 0.002 wt. %, 0.004 wt. %, 0.005 wt. %, 0.006 wt. %, 0.008 wt. %, 0.01 wt. %, 0.02 wt. %, 0.04 wt. %, 0.06 wt. %, 0.08 wt. %, 0.1 wt. %, 0.2 wt. %, 0.25 wt. %, 0.26 wt. %, 0.27 wt. %, 0.28 wt. %, 0.29 wt. %, 0.3 wt. %, 0.32 wt. %, 0.33 wt. %, 0.34 wt. %, 0.35 wt. %, 0.4 wt. %, 0.5 wt. %, 0.6 wt. %, 0.8 wt. %, 1 wt. %, 1.2 wt. %, 1.6 wt. %, 1.8 wt. %, 2 wt. %, 2.5 wt. %, 3 wt. %, 3.5 wt. %, 4 wt. %, 4.5 wt. %, 5 wt. %, or a range between any two numerical values of these.

In some embodiments of the present invention, the liquid crystal composition further comprises at least one self-aligning agent of general formula SA:

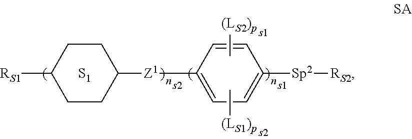

wherein
R_{S1} represents —Sp¹-P¹, C₁₋₁₂ (for example, it can be C₁, C₂, C₃, C₄, C₅, C₆, C₇, C₈, C₉, C₁₀, C₁₁, or C₁₂) linear or branched alkyl,

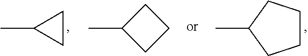

wherein one or more than two nonadjacent —CH₂— in the C₁₋₁₂ linear or branched alkyl can each be independently replaced by —CH═CH—, —C≡C—, —O—, —CO—, —CO—O— or —O—CO—, and one or more —H in the C₁₋₁₂ linear or branched alkyl,

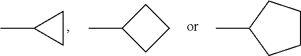

can each be independently substituted by —F or —Cl;
ring

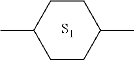

represents

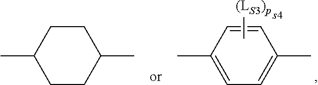

wherein one or more —CH₂— in

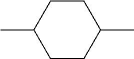

can be replaced by —O—, and one or more single bond in the rings can be replaced by double bond;
Ls₁ and Ls₃ each independently represents —F, —Cl, —CN, —NO₂, —NCO, —NCS, —OCN, —SCN, —C(O)N(R^{S0})₂, —C(O)R^{S0}, C₁₋₁₂ (for example, it can be C₁, C₂, C₃, C₄, C₅, C₆, C₇, C₈, C₉, C₁₀, C₁₁, or C₁₂) linear or branched alkyl,

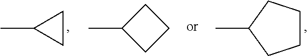

wherein one or more than two nonadjacent —CH₂— in the C₁₋₁₂ linear or branched alkyl can each be independently replaced by —CH═CH—, —C≡C—, —O—, —CO—, —CO—O— or —O—CO—, and one or more —H in the C₁₋₁₂ linear or branched alkyl,

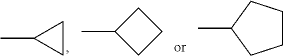

can each be independently substituted by —F, wherein R^{S0} represents C₁₋₁₂ (for example, C₁, C₂, C₃, C₄, C₅, C₆, C₇, C₈, C₉, C₁₀, C₁₁, or C₁₂) linear or branched alkyl;
L_{S2} represents -Sp₃-P₂ or

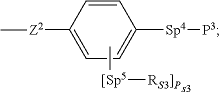

R_{S2} and R_{S3} each independently represents anchoring group, the anchoring group is

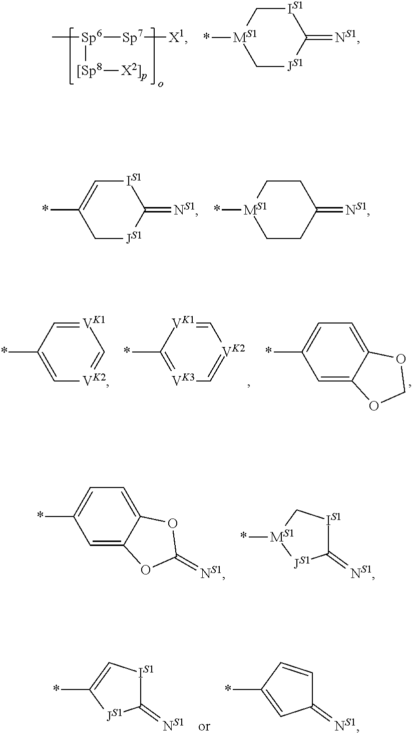

in which, * represents the binding site in the bound structure;
p represents 1 or 2, wherein when p represents 2, —Sp⁸-X² can be the same or different;
represents 0 or 1;
M^{S1} represents

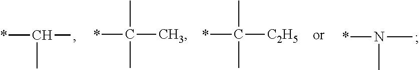

I^{S1} and J^{S1} each independently represents —CH₂—, —O— and —S—;
N^{S1} represents ═O or ═S;
V^{K1}, V^{K2} and V^{K3} each independently represents —CH═ or —N═;
X¹ and X² each independently represents —H, —OH, —SH, —NH₂, —NHR¹¹, —N(R¹¹)₂, —NHC(O)R¹¹, —OR¹¹, —C(O)OH, —CHO, or C₁₋₁₂ (for example, C₁, C₂, C₃, C₄, C₅, C₆, C₇, C₈, C₉, C₁₀, C₁₁, or C₁₂) halogenated or unhalogenated linear or branched alkyl, wherein at least one of X¹ and X² is selected from the group consisting of —OH, —SH, —NH₂, —NHR¹¹, —C(O)OH and —CHO, wherein R¹¹ represents C₁₋₁₂ (for example, C₁, C₂, C₃, C₄, C₅, C₆, C₇, C₈, C₉, C₁₀, C₁₁, or C₁₂) linear or branched alkyl;
P¹, P² and P³ each independently represents polymerizable group;
Sp¹, Sp², Sp³, Sp⁴, Sp⁵, Sp⁷ and Sp⁸ each independently represents spacer group or single bond;
Sp⁶ each independently represents

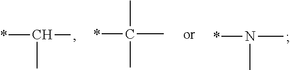

Z¹ and Z² each independently represents —O—, —S—, —CO—, —CO—O—, —O—CO—, —O—CO—O—, —CH₂O—, —OCH₂—, —CH₂S—, —SCH₂—, —CF₂O—, —OCF₂—, —CF₂S—, —SCF₂—, —(CH₂)_{d}—, —CF₂CH₂—, —CH₂CF₂—, —(CF₂)_{d}—, —CH═CH—, —CF═CF—, —CH═CF—, —CF═CH—, —C≡C—, —CH═CH—CO—O—, —O—CO—CH═CH—, —CH₂CH₂—CO—O—, —O—CO—CH₂CH₂—, —CHR¹—, —CR¹R²— or single bond, wherein R¹ and R² each independently represents C₁₋₁₂ linear or branched alkyl, and d represents an integer of 1-4;
nₛ₁ represents 1, 2 or 3, nₛ₂ represents 1, 2, 3 or 4, and nₛ₁+nₛ₂≥3, wherein when nₛ₁ represents 2 or 3,

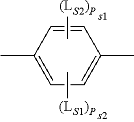

can be same or different, wherein when nₛ₂ represents 2, 3 or 4,

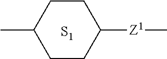

can be same or different; and
pₛ₁, pₛ₂, pₛ₃ and pₛ₄ each independently represents 0, 1 or 2, wherein when pₛ₁ represents 2, Ls₂ can be same or different, wherein when pₛ₂ represents 2, Ls₁ can be same or different; wherein when pₛ₃ represents 2, —Sp⁵-R_{S3} can be same or different; wherein when pₛ₄ represents 2, Ls₃ can be the same or different.

In some embodiments of the present invention, Ls₂ represents —Sp³-P²,

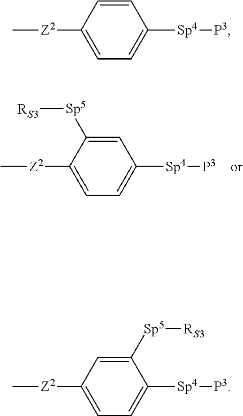

In some embodiments of the present invention, Sp³, Sp⁴ and Sp⁵ each independently represents —(CH₂)p₁-, —(CH₂)p₁-O—, —(CH₂)p₁-O—CO—, —(CH₂)p₁-CO—O—, —(CH₂)p₁-O—CO—O— or —CR⁰R⁰⁰—(CH₂)ₚ₁—, wherein p₁ represents an integer of 1-12 (for example, 1, 2, 3, 4, 5, 6, 7, 8, 9, 10, 11, or 12), R⁰ and R⁰⁰ each independently represents —H or C₁₋₁₂ (for example, C₁, C₂, C₃, C₄, C₅, C₆, C₇, C₈, C₉, C₁₀, C₁₁, or C₁₂) linear or branched alkyl, or C₃₋₁₂ (for example, C₃, C₄, C₅, C₆, C₇, C₈, C₉, C₁₀, C₁₁, or C₁₂) cyclic alkyl; preferably, Sp³, Sp⁴ and Sp⁵ each independently represents —(CH₂)p₁- or —(CH₂)p₁-O—.

In some embodiments of the present invention, the self-aligning agent of general formula SA is selected from a group consisting of the following compounds:

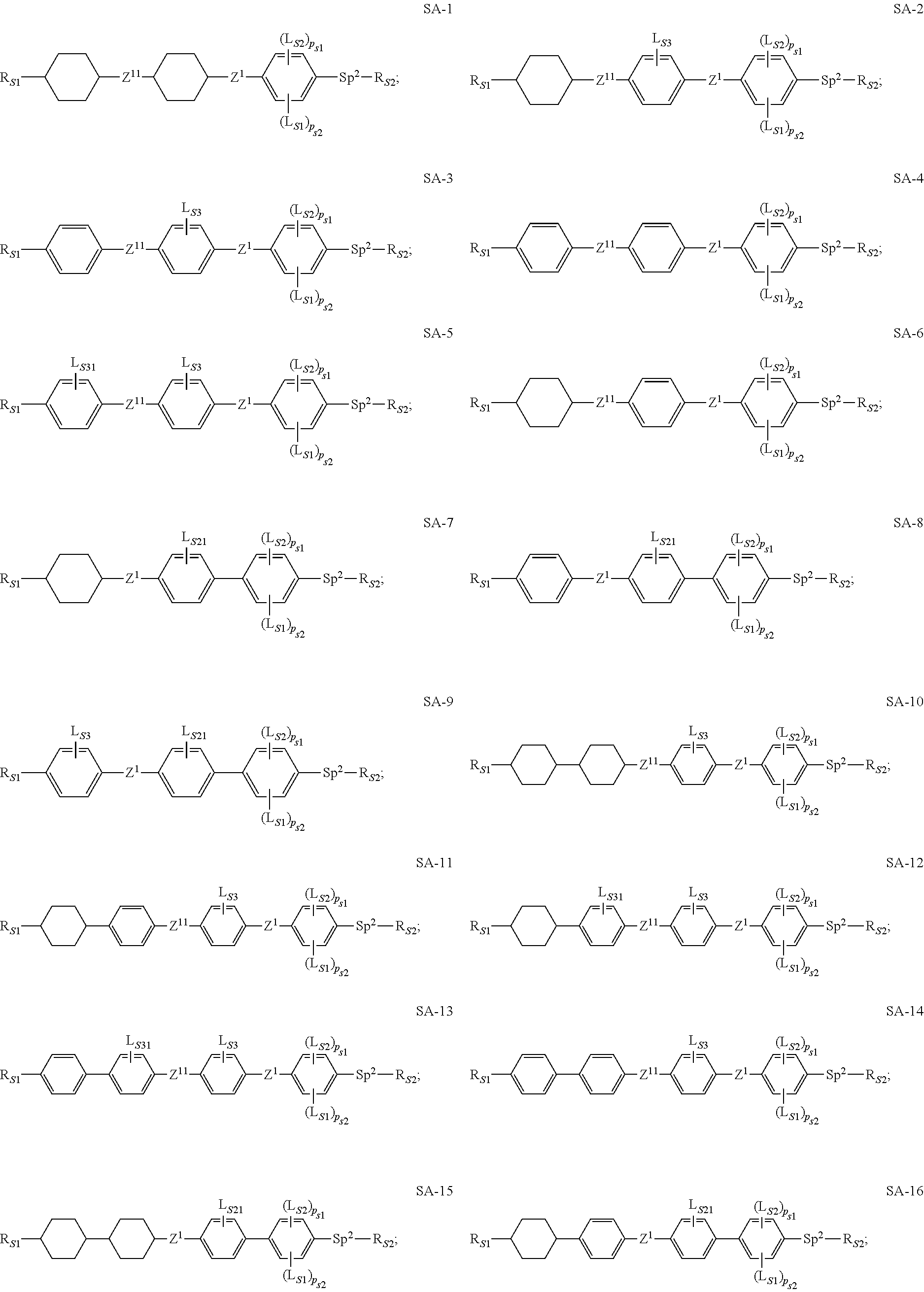

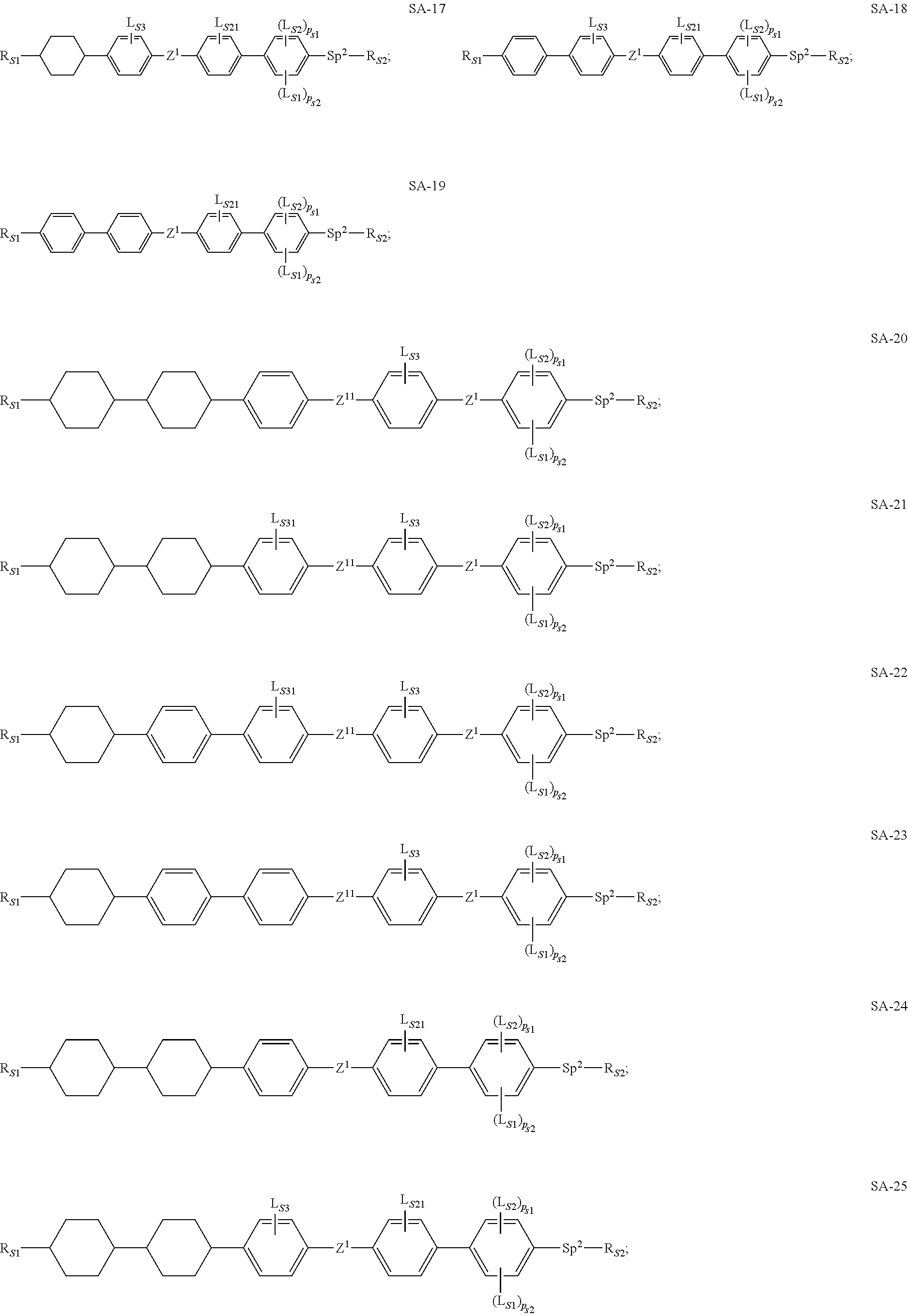

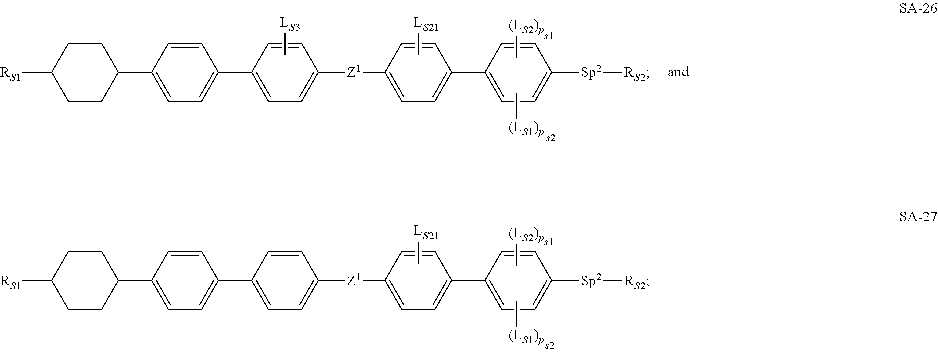

wherein
Ls₃₁ represents —F, —Cl, —CN, —NO₂, —NCO, —NCS, —OCN, —SCN, —C(O)N(R^{S0})₂, —C(O)R^{S0}, C₁₋₁₂ (for example, it can be C₁, C₂, C₃, C₄, C₅, C₆, C₇, C₈, C₉, C₁₀, C₁₁, or C₁₂) linear or branched alkyl,

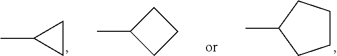

wherein one or more than two nonadjacent —CH₂— in the C₁₋₁₂ linear or branched alkyl can each be independently replaced by —CH═CH—, —C≡C—, —O—, —CO—, —CO—O— or —O—CO—, and one or more —H in the C₁₋₁₂ linear or branched alkyl,

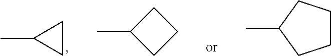

can each be independently substituted by —F, wherein RSO represents C₁₋₁₂ (for example, C₁, C₂, C₃, C₄, C₅, C₆, C₇, C₈, C₉, C₁₀, C₁₁, or C₁₂) linear or branched alkyl;
Ls₂₁ represents -Sp³-P² or

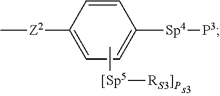

and
Z¹¹ represents —O—, —S—, —CO—, —CO—O—, —O—CO—, —O—CO—O—, —CH₂O—, —OCH₂—, —CH₂S—, —SCH₂—, —CF₂O—, —OCF₂—, —CF₂S—, —SCF₂—, —(CH₂)_{d}—, —CF₂CH₂—, —CH₂CF₂—, —(CF₂)_{d}—, —CH═CH—, —CF═CF—, —CH═CF—, —CF═CH—, —C≡C—, —CH═CH—CO—O—, —O—CO—CH═CH—, —CH₂CH₂—CO—O—, —O—CO—CH₂CH₂—, —CHR¹—, —CR¹R²— or single bond, wherein R¹ and R² each independently represents C₁₋₁₂ linear or branched alkyl, and d represents an integer of 1-4.

In some embodiments of the present invention, preferably, Ls₁, Ls₃ and Ls₃₁ each independently represents —F, —Cl, —CN, —NO₂, —NCO, —NCS, —OCN, —SCN, —C(O)N(R^{S0})₂, —C(O)R^{S0}, C₁₋₁₀ linear or branched alkyl, C₁₋₉ linear or branched alkoxy, or C₂₋₁₀ linear or branched alkenyl; further preferably, Ls₁, Ls₃ and Ls₃₁ each independently represents —F, —Cl, C₁₋₈ linear or branched alkyl, C₁₋₇ linear or branched alkoxy, or C₂₋₈ linear or branched alkenyl.

In some embodiments of the present invention, preferably, R_{S1} represents -Sp¹-P¹, C₁₋₁₀ linear or branched alkyl, C₁₋₉ linear or branched alkoxy, or C₂₋₁₀ linear or branched alkenyl; further preferably, R_{S1} represents C₁₋₈ linear or branched alkyl, C₁₋₇ linear or branched alkoxy, or C₂₋₈ linear or branched alkenyl.

In some embodiments of the present invention, R_{S2} and R_{S3} each independently represents —OH, —SH, —NH₂, —NHR¹¹, —N(R¹¹)₂, —NHC(O)R¹¹, —OR¹¹, —C(O)OH,

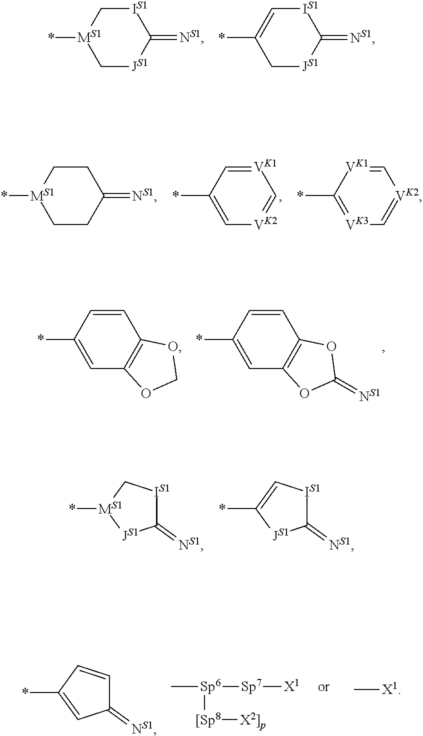

In some embodiments of the present invention, R_{S2} and R_{S3} each independently is selected from the group consisting of the following groups:

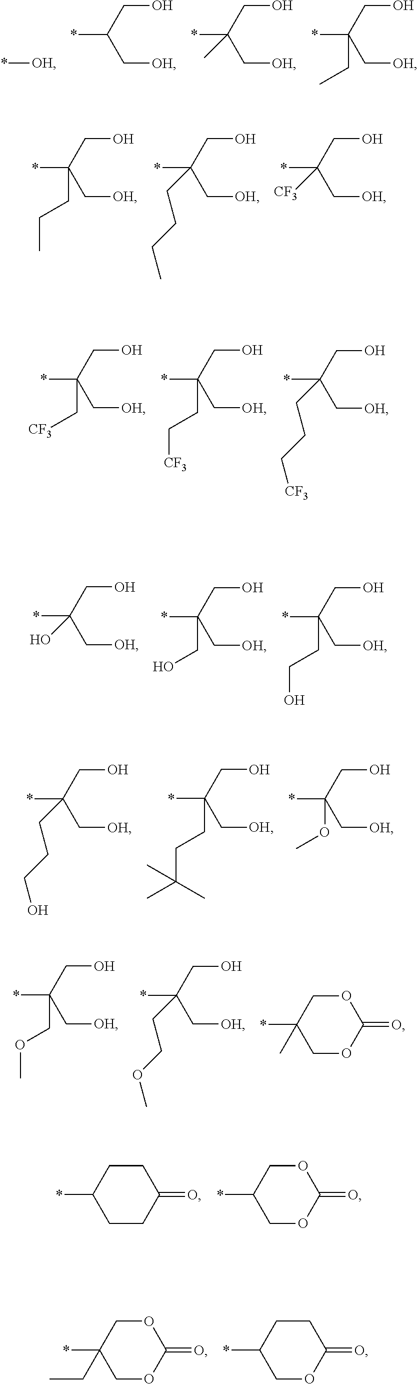

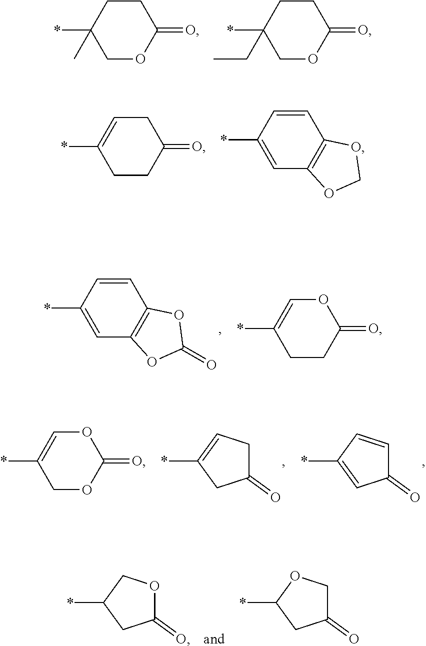

wherein
* represents the binding site in the bound structure.

In some embodiments of the present invention, R_{S2} and R_{S3} each independently is selected from the group consisting of the following groups:

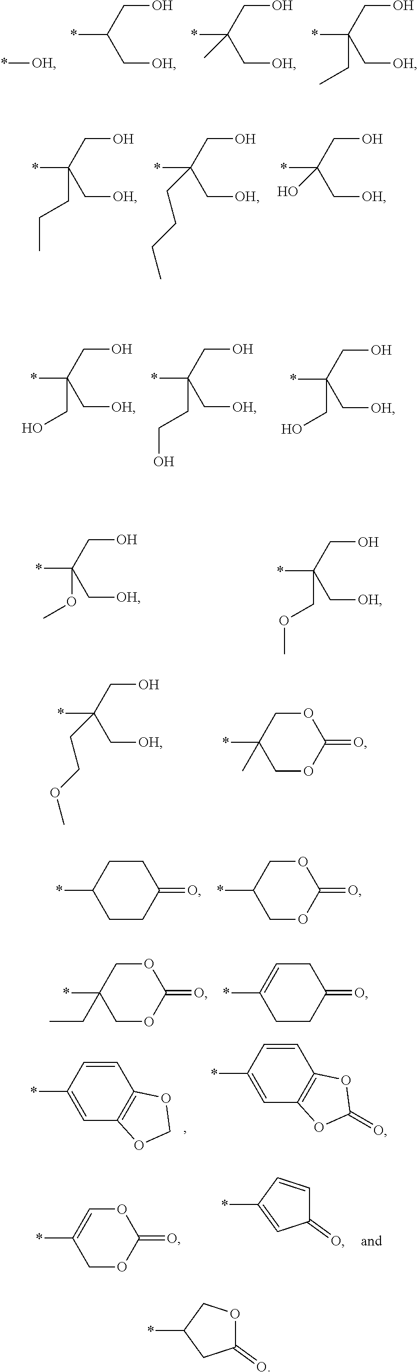

Further, R_{S2} and R_{S3} each independently is preferred to be:

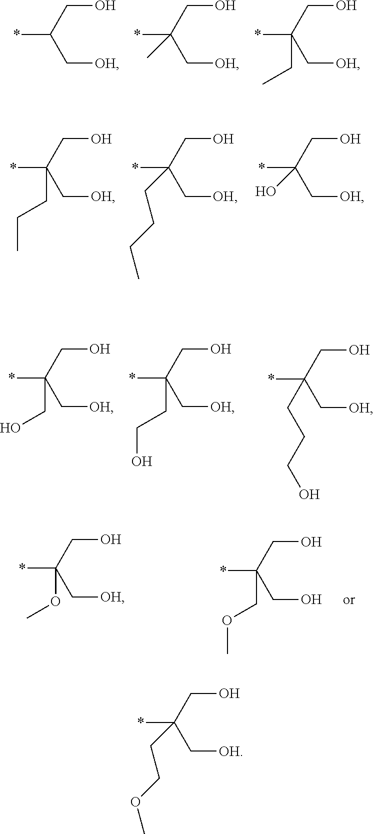

In some embodiments of the present invention, pₛ₁ represents 1 or 2.

In some embodiments of the present invention, the self-aligning agent of general formula SA provides 0.001-5 wt. % (including any of the numerical values or sub-ranges therebetween) of the total weight of the liquid crystal composition, for example, 0.001 wt. %, 0.005 wt. %, 0.05 wt. %, 0.1 wt. %, 0.2 wt. %, 0.25 wt. %, 0.3 wt. %, 0.35 wt. %, 0.4 wt. %, 0.45 wt. %, 0.5 wt. %, 0.55 wt. %, 0.6 wt. %, 0.65 wt. %, 0.7 wt. %, 0.75 wt. %, 0.8 wt. %, 0.85 wt. %, 0.9 wt. %, 0.95 wt. %, 1.0 wt. %, 2 wt. %, 3 wt. %, 4 wt. %, 5 wt. %, or a range between any two numerical values of these; preferably, the self-aligning agent of general formula SA provides 0.1-2 wt. % of the total weight of the liquid crystal composition.

In the present invention, when the self-aligning agent of general formula SA is added to the liquid crystal composition, it enables the liquid crystal composition of the present invention to orient the liquid crystal molecules without disposing a PI-aligning layer.

In some embodiments of the present invention, the chiral agent provides 0.01-10 wt. % (including any of the numerical values or sub-ranges therebetween) of the total weight of the liquid crystal composition, for example, 0.01 wt. %, 0.1 wt. %, 0.2 wt. %, 0.4 wt. %, 0.5 wt. %, 0.6 wt. %, 0.66 wt. %, 0.7 wt. %, 0.72 wt. %, 0.1 wt. %, 1 wt. %, 1.1 wt. %, 1.14 wt. %, 1.2 wt. %, 1.25 wt. %, 1.3 wt. %, 1.36 wt. %, 1.5 wt. %, 1.8 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, 7 wt. %, 7.5 wt. %, 8 wt. %, 8.2 wt. %, 8.5 wt. %, 9 wt. %, 9.5 wt. %, 10 wt. %, or a range between any two numerical values of these; preferably, 0.1 wt. %-3 wt. %.

In some embodiments of the present invention, the chiral agent is an S-type chiral compound or an R-type chiral compound.

In some embodiments of the present invention, the S-type chiral compound is selected from a group consisting of the chiral agents of S1011, S2011, S5011, S811, S6N, and the R-type chiral agent is selected from a group consisting of the chiral agent among R1011, R2011, R5011, R811, R6N.

In some embodiments of the present invention, the chiral agent is selected from a group consisting of S1011, S2011, S811.

In some embodiments of the present invention, the HTP value of the chiral agent is ≥5 (for example, ≥6, ≥7, ≥7, ≥8, ≥9, ≥10, ≥11).

In addition to the above compounds, the liquid crystal composition of the present invention may also contain common nematic liquid crystal, smectic liquid crystal, cholesteric liquid crystal, antioxidant, ultraviolet absorber, infrared absorber, photoinitiator, polymerizable monomer or light stabilizer and so on.

In some embodiments of the present invention, the liquid crystal composition further comprises dopants selected from a group consisting of the following compounds:

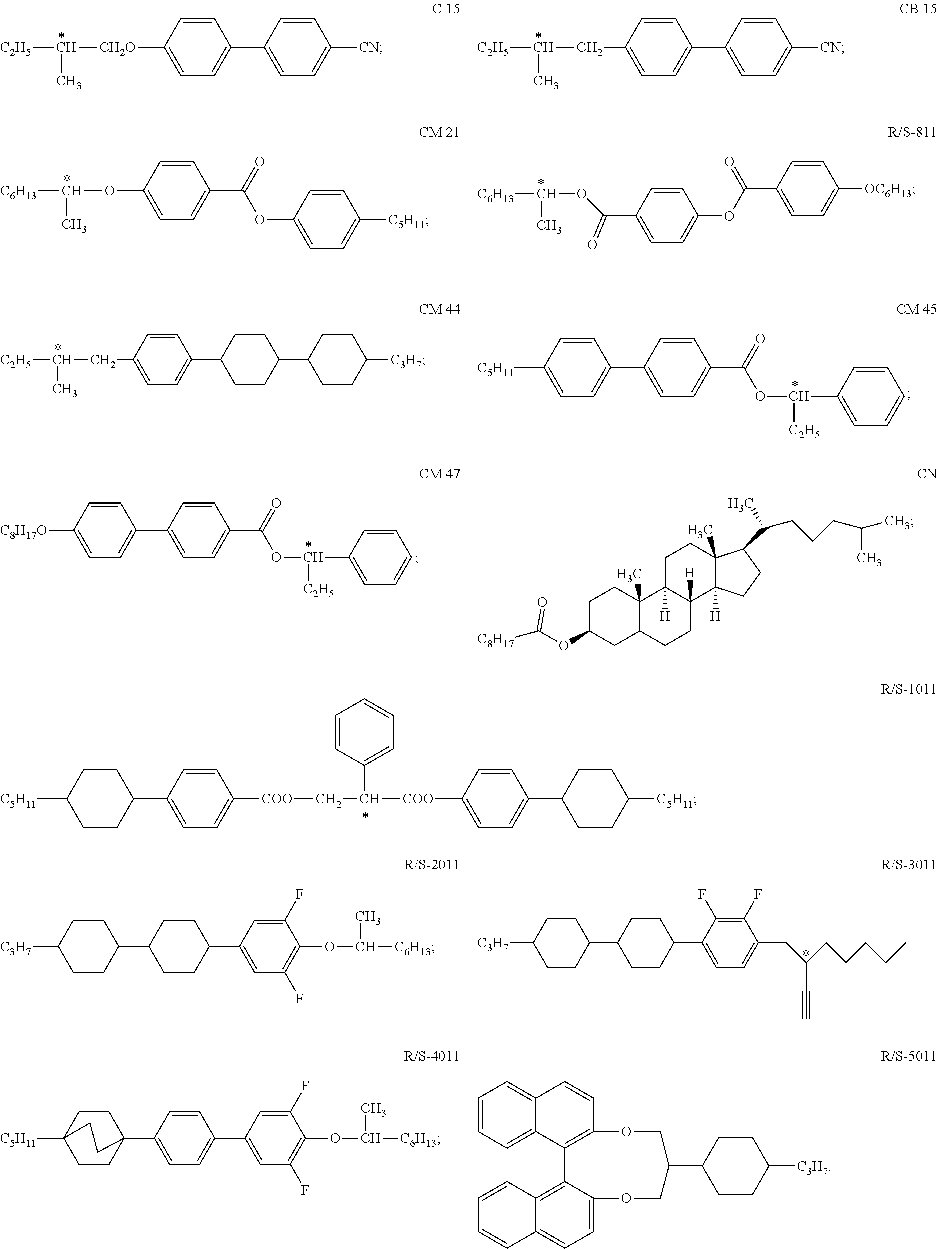

In some embodiments of the present invention, the dopant provides 0-5 wt. % of the total weight of the liquid crystal composition, for example, 0.3 wt. %, 0.5 wt. %, 1 wt. %, 2 wt. %, 3 wt. %, 4 wt. % or 5 wt. %; preferably, the dopant provides 0.01-1 wt. % of the total weight of the liquid crystal composition.

Further, additives (such as antioxidant, light stabilizer, and the like) used in the liquid crystal composition of the present invention are preferably to be the following substances:

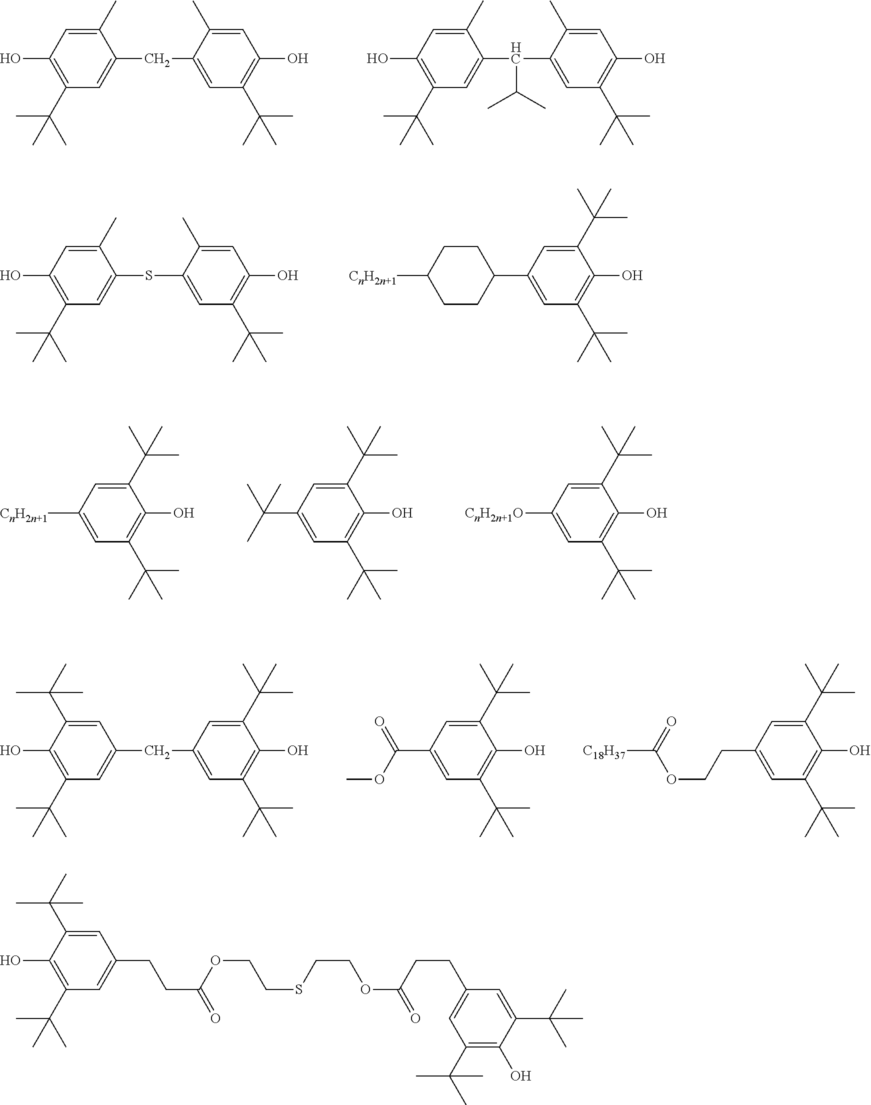

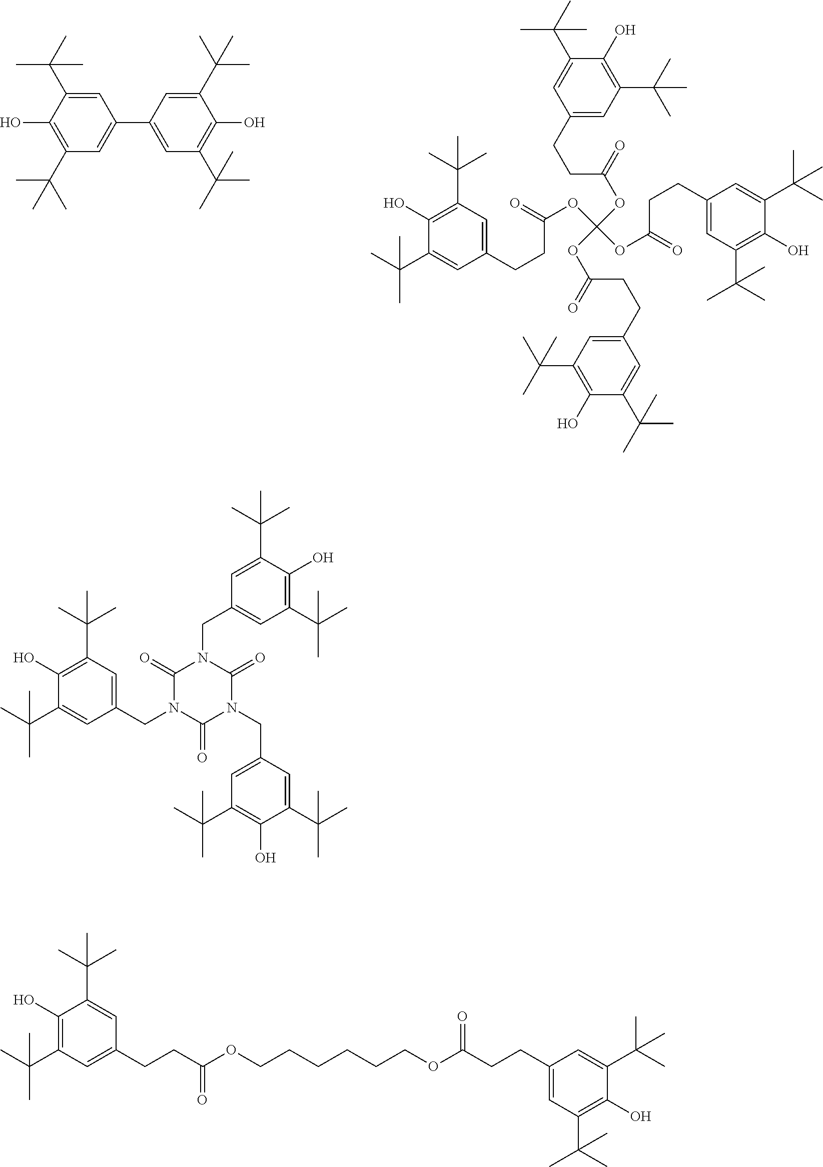

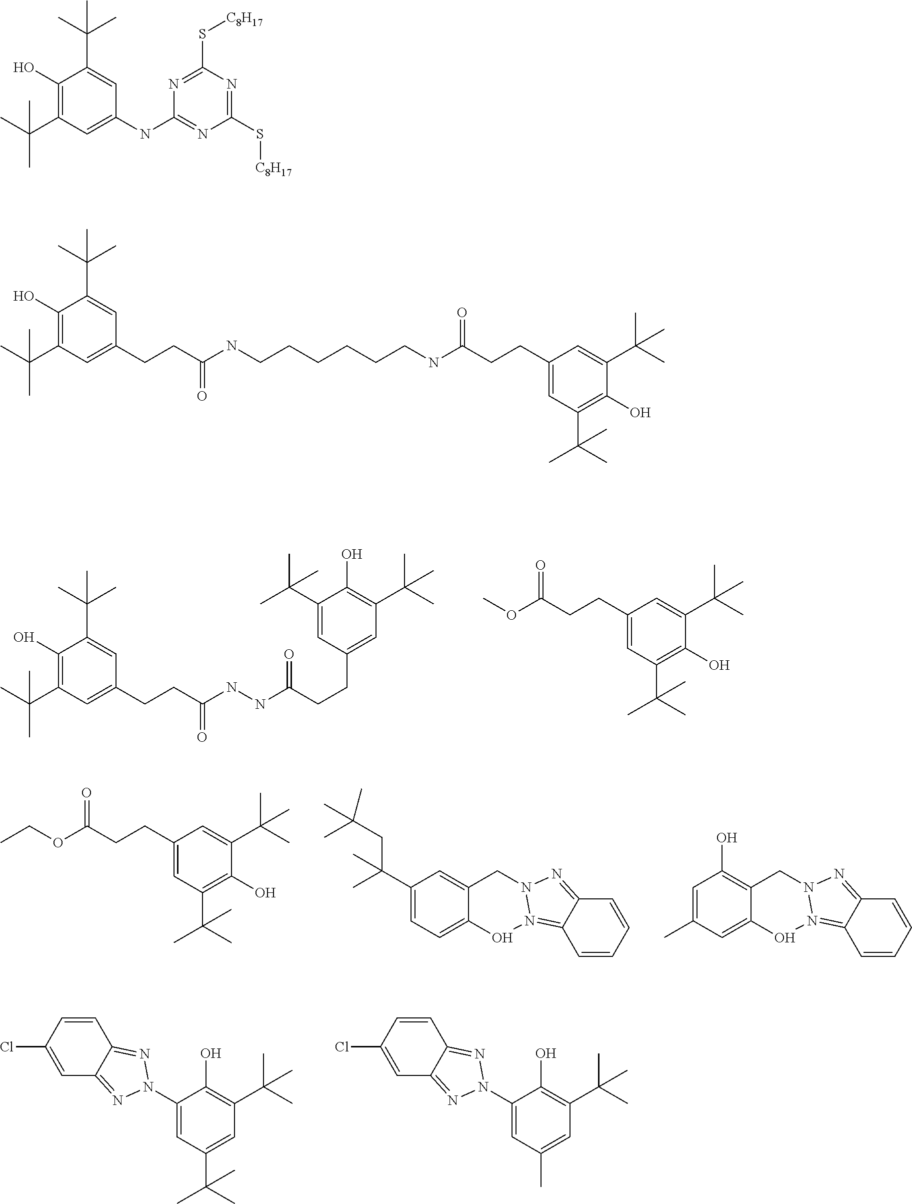

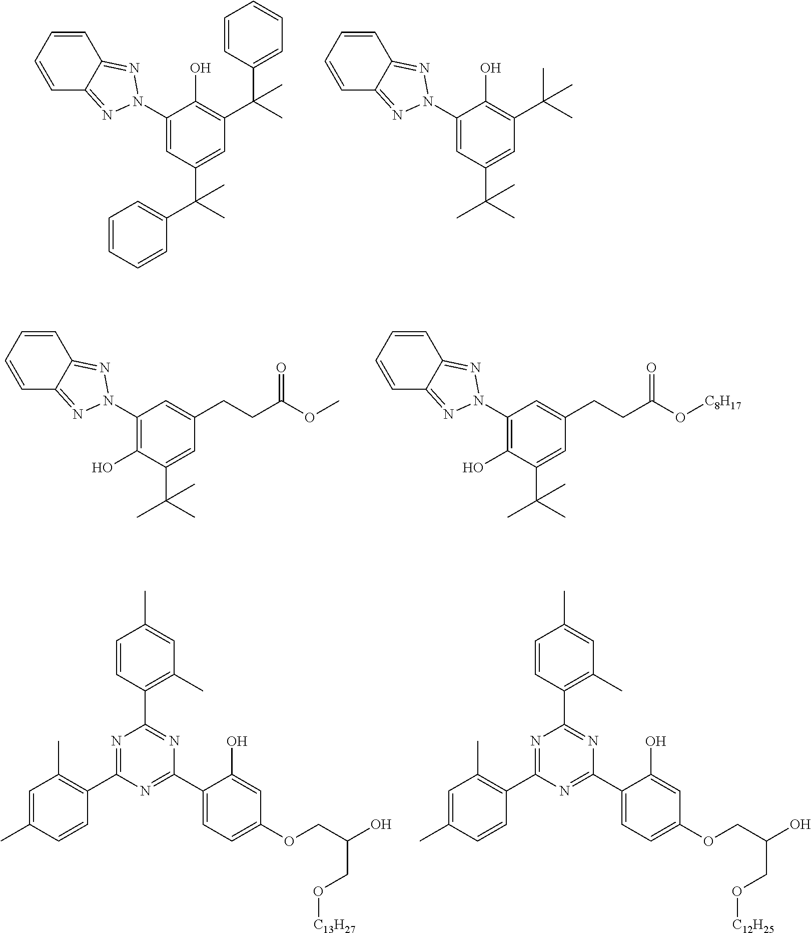

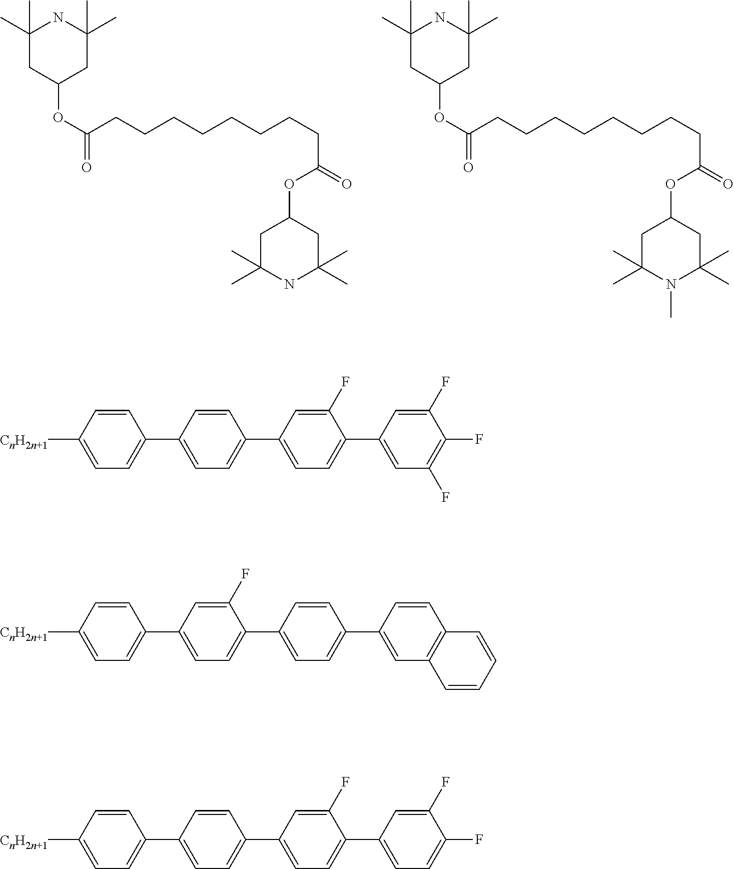

wherein, n represents a positive integer of 1-12.

Preferably, the antioxidant is selected from the light stabilizers as shown below:

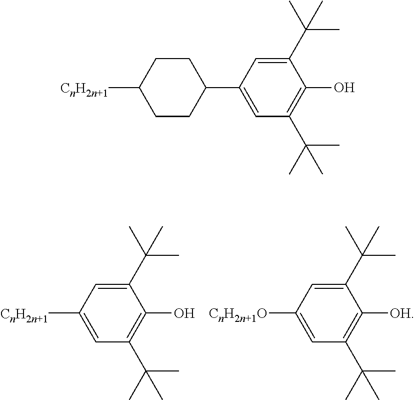

In some embodiments of the present invention, the additives provide 0-5% by weight of the total weight of the liquid crystal composition, for example, 0.3 wt. %, 0.5 wt. %, 1 wt. %, 2 wt. %, 3 wt. %, 4 wt. % or 5 wt. %; preferably, the additives provide 0.01-1% by weight of the total weight of the liquid crystal composition, for example, 0.01 wt. %, 0.05 wt. %, 0.08 wt. %, 0.1 wt. %, 0.5 wt. %, 0.8 wt. % or 1 wt. %.

In some embodiments of the present invention, the liquid crystal composition of the present invention further comprises the photoinitiator as shown below:

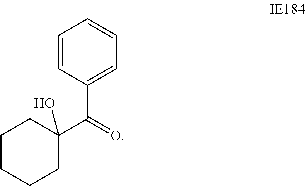 [SMILES: O=C(c1ccccc1)C1(O)CCCCC1]

The liquid crystal dimming device as described in the present invention can be used in the construction and transportation fields.

Compared with the prior art, the present invention has the following beneficial effects:
the liquid crystal dimming device of the present invention has an appropriate transmittance (Tᵣ₀, Tᵣ₂₅₅), an appropriate contrast rate, a higher VHR (initial), a higher VHR (Ra) and a wider operation temperature range. The dimming device of the present invention has a better display effect at the moment of power-off after applying power on it for 2 h, and can effectively avoid the problems of display mura and image sticking.

### DESCRIPTION OF DRAWINGS

FIG. 1 is the photograph of the surface of the liquid crystal dimming device in Example 1 at the moment of power-off after applying power on it for 2 h;

FIG. 2 is the photograph of the surface of the liquid crystal dimming device in Comparative Example 1 at the moment of power-off after applying power on it for 2 h;

FIG. 3 is the photograph of the surface of the liquid crystal dimming device in Example 2 at the moment of power-off after applying power on it for 2 h;

FIG. 4 is the photograph of the surface of the liquid crystal dimming device in Comparative Example 2 at the moment of power-off after applying power on it for 2 h;

FIG. 5 is the photograph of the surface of the liquid crystal dimming device in Example 3 at the moment of power-off after applying power on it for 2 h;

FIG. 6 is the photograph of the surface of the liquid crystal dimming device in Comparative Example 3 at the moment of power-off after applying power on it for 2 h;

FIG. 7 is the photograph of the surface of the liquid crystal dimming device in Example 4 at the moment of power-off after applying power on it for 2 h;

FIG. 8 is the photograph of the surface of the liquid crystal dimming device in Comparative Example 4 at the moment of power-off after applying power on it for 2 h;

FIG. 9 is the photograph of the surface of the liquid crystal dimming device in Example 5 at the moment of power-off after applying power on it for 2 h;

FIG. 10 is the photograph of the surface of the liquid crystal dimming device in Comparative Example 5 at the moment of power-off after applying power on it for 2 h;

FIG. 11 is the photograph of the surface of the liquid crystal dimming device in Example 6 at the moment of power-off after applying power on it for 2 h;

FIG. 12 is the photograph of the surface of the liquid crystal dimming device in Comparative Example 6 at the moment of power-off after applying power on it for 2 h;

FIG. 13 is the photograph of the surface of the liquid crystal dimming device in Example 7 at the moment of power-off after applying power on it for 2 h;

FIG. 14 is the photograph of the surface of the liquid crystal dimming device in Comparative Example 7 at the moment of power-off after applying power on it for 2 h.

### DETAILED EMBODIMENTS

The technical solution of the present invention will be further illustrated by the detailed embodiments below. It should be clear for the person skilled in the art that, the Examples are only used to help to understand the present invention, and shall not be seen as specific limitations on the present invention.

The present invention will be illustrated by combining the detailed embodiments below. It should be noted that, the following Examples are instances of the present invention, which are only used to illustrate the present invention, not to limit it. Other combinations and various modifications within the conception of the present invention are possible without departing from the subject matter and scope of the present invention.

For the convenience of the expression, the group structures of the compounds in the following Examples are represented by the codes listed in Table 1:

TABLE 1
Codes of the group structures of the compounds

| Unit structure of group | Code | Name of group |
|---|---|---|
| 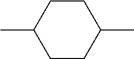 | C | 1,4-cyclohexylidene |
| 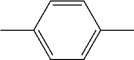 | P | 1,4-phenylene |
| 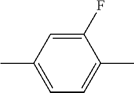 | G | 2-fluoro-1,4-phenylene |
| 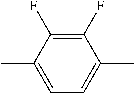 | W | 2,3-difluoro- 1,4-phenylene |
| —COO— | E | ester bridge group |
| —F | F | fluorine substituent |
| —O— | O | oxygen bridge group |
| —CH═CH— or —CH═CH₂ | V | ethenylene or ethenyl |
| —CH₂O— | 1O | methyleneoxy |
| —CₙH₂ₙ₊₁ or —CₙH₂ₙ— | n (n | alkyl or alkylene |
| | represents | |
| | a positive | |
| | integer of | |
| | 1-12) | |

Take the compound with following structural formula as an example:

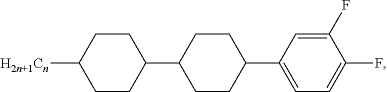

represented by the codes listed in Table 1, this structural formula can be expressed as nCCGF, in which n in the code represents the number of the carbon atoms of the alkyl on the left, for example, n is “3”, meaning that the alkyl is —C₃H₇; C in the code represents 1,4-cyclohexylidene, G represents 2-fluoro-1,4-phenylene, and F represents fluorine.

The abbreviated codes of the test items in the following Examples are as follows:
Cp clearing point (nematic-isotropy phases transition temperature, ° C.)
Δn optical anisotropy (589 nm, 25° C.)
Δε dielectric anisotropy (1 KHz, 25° C.)
T_{c} phase transformation point in low temperature storage (i.e., the lower limit temperature of the nematic phase, ° C.)
VHR (initial) initial voltage holding ratio (%)
VHR (Ra) voltage holding ratio after maintained at a high temperature of 85° C. for 500 h (%)
t_{-30° C.} low-temperature storage time (h, −30° C.)
Tᵣ₀ transmittance in an off-status (25° C., %)
Tᵣ₂₅₅ transmittance in an on-status (25° C., %)
CR contrast rate (25° C.)
wherein,
Cp: tested by melting point apparatus.
Δn: Δn=nₑ−n₀, tested using an Abbe Refractometer under a sodium lamp (589 nm) light source at 25° C.
Δε: Δε=ε_{|}−ε_{⊥}, in which, ε_{|} is the dielectric constant parallel to the molecular axis, ε_{⊥} is the dielectric constant perpendicular to the molecular axis, test conditions: 25° C., 1 KHz, VA-type test cell with a cell gap of 6 μm.
T_{c}: placing the nematic phase liquid crystal materials in glass bottles and stored in refrigerators at temperatures of 0° C., −10° C., −20° C., −30° C., and −40° C., respectively, and then the low temperature at 10 days is observed, for example, if the sample is in the nematic phase at −20° C. and becomes crystalline or near-crystalline at −30° C., then the T_{c} is <−20° C.
VHR (initial, 25° C.): initial voltage holding ratio, tested using a TOY06254 liquid crystal physical property evaluation system; the test temperature is 25° C., the test voltage is 5 V, and the test frequency is 6 Hz.
VHR (initial, 60° C.): initial voltage holding ratio, tested using a TOY06254 liquid crystal physical property evaluation system; the test temperature is 60° C., the test voltage is 5 V, and the test frequency is 6 Hz.
VHR (Ra, 25° C.): tested using a TOY06254 liquid crystal physical property evaluation system; the liquid crystal is tested after maintaining at a high temperature of 85° C. for 500 h; the test temperature is 25° C., the test voltage is 5 V, and the test frequency is 6 Hz.
VHR (Ra, 60° C.): tested using a TOY06254 liquid crystal physical property evaluation system; the liquid crystal is tested after maintaining at a high temperature of 85° C. for 500 h; the test temperature is 60° C., the test voltage is 5 V, and the test frequency is 6 Hz.
t_{-30° C.}: placing the nematic phase liquid crystal medium in glass bottles and stored at −30° C., the time recorded when precipitation of crystals was observed.
CR: testing the transmittance (i.e., Tᵣ₂₅₅ and Tᵣ₀) of the liquid crystal cell using a DMS 505 tester at 255 gray-scale voltage and 0 gray-scale voltage respectively, and obtained from Tᵣ₂₅₅/Tᵣ₀.

The components used in the following Examples can either be synthesized by methods known in the art or be obtained commercially. The synthetic techniques are conventional, and each of the obtained liquid crystal compounds is tested to meet the standards of electronic compound.

The liquid crystal compositions are prepared in accordance with the ratios of each of the liquid crystal compounds specified in the following Examples. The preparation of the liquid crystal compositions is carried out according to the conventional methods in the art, such as mixed and prepared according to the ratios via means of heating, ultrasonic processing, suspending and so forth.

### Example 1

The present Example provides a liquid crystal dimming device, sequentially comprising, from bottom to top, a lower substrate, a lower conductive layer, a lower alignment layer, a guest-host liquid crystal composition layer, an upper alignment layer, an upper conductive layer, and an upper substrate; wherein alignment directions of the upper alignment layer and the lower alignment layer are parallel alignment.

The liquid crystal composition 1 is prepared according to each compound and weight percentage listed in Table 2, the dye providing 3.8 wt. % of the liquid crystal composition is added in the liquid crystal composition 1, the chiral agent S811 providing 1.14 wt. % of the liquid crystal composition is added in the liquid crystal composition 1, the performance test of the liquid crystal dimming device is carried out by filling the same into the guest-host liquid crystal composition layer of the present Example and the test results thereof are shown in Table 3.

TABLE 2
Formulation of liquid crystal composition

| | | | |
|---|---|---|---|
| Code of | Weight | Code of | Performance |
| component | percent | structure | Parameters |

| | | | | |
|---|---|---|---|---|
| 3CWO2 | 15 | N-2 | Cp | 111 |
| 5CWO2 | 10 | N-2 | Δn | 0.106 |
| 3CWO4 | 15 | N-2 | Δε | −6.6 |
| 2CPWO2 | 4 | N-11 | T_{c} | −30 |
| 3CPWO3 | 4 | N-11 | t_{-30° C.} | ≥7 |
| 3CPWO4 | 4 | N-11 | | |
| 3CCWO2 | 10 | N-5 | | |
| 3CCWO3 | 10 | N-5 | | |
| 4CCWO3 | 9 | N-5 | | |
| 5CCWO2 | 9 | N-5 | | |
| 3CCEPC2 | 5 | M-30 | | |
| 3CCEPC5 | 5 | M-30 | | |
| Total | 100 | | | |

TABLE 3
Test results for the performance parameters

| | |
|---|---|
| Tᵣ₀ | 12.6 |
| Tᵣ₂₅₅ | 57.2 |
| CR | 4.5 |
| VHR (initial, 25° C.) | 90.6 |
| VHR (initial, 60° C.) | 69.73 |
| VHR (Ra, 25° C.) | 73.75 |
| VHR (Ra, 60° C.) | 34.48 |

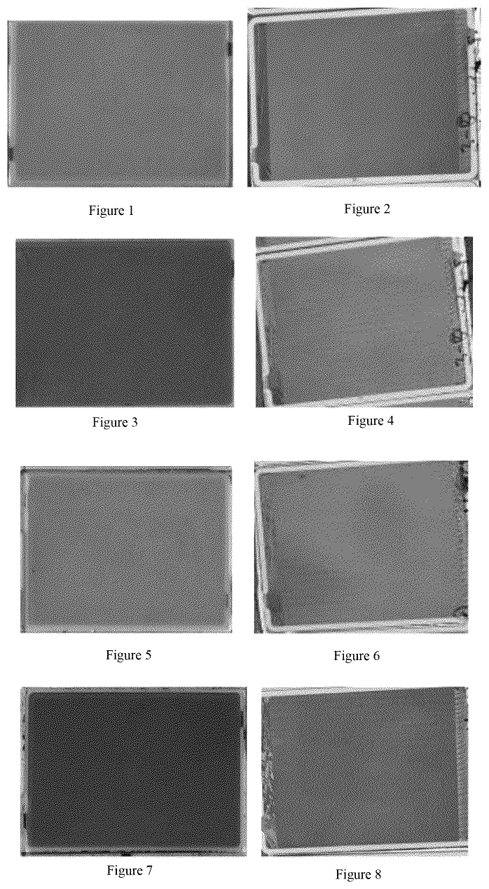

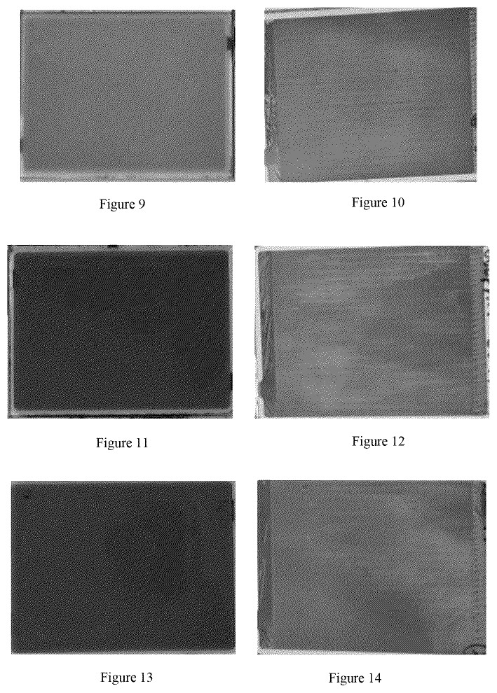

Applying power on the liquid crystal dimming device in Example 1 for 2 h, the surface of the device at the moment of power-off is as shown in FIG. 1.

### Comparative Example 1

The difference between the present Comparative Example 1 and Example 1 merely lies in that the alignment directions of the upper alignment layer and the lower alignment layer are anti-parallel alignment. The performance test thereof is carried out and the results are shown in Table 4.

TABLE 4
Test results for the performance parameters

| | |
|---|---|
| Tᵣ₀ | 12.4 |
| Tᵣ₂₅₅ | 57.5 |
| CR | 4.6 |
| VHR (initial, 25° C.) | 89.68 |
| VHR (initial, 60° C.) | 68.45 |
| VHR (Ra, 25° C.) | 51.53 |
| VHR (Ra, 60° C.) | 32.57 |

Applying power on the liquid crystal dimming device in Comparative Example 1 for 2 h, the surface of the device at the moment of power-off is as shown in FIG. 2.

It can be seen from the comparison between Comparative Example 1 and Example 1 that filling the liquid crystal composition with a higher clearing point, an appropriate optical anisotropy, an appropriate absolute value of dielectric anisotropy and a better low temperature storage stability, as well as the chiral agent and the dye into the liquid crystal dimming device of the present invention makes the liquid crystal dimming device of the present invention have an appropriate transmittance (Tᵣ₀, Tᵣ₂₅₅), an appropriate contrast rate, a higher VHR (initial), a higher VHR (Ra) and a wider operation temperature range. It can be seen from the comparison between FIG. 2 and FIG. 1 that the dimming device of the present invention has a better display effect at the moment of power-off after applying power on it for 2 h, and can effectively avoid the problems of display mura and image sticking.

### Example 2

The present Example provides a liquid crystal dimming device, sequentially comprising, from bottom to top, a lower substrate, a lower conductive layer, a lower alignment layer, a guest-host liquid crystal composition layer, an upper alignment layer, an upper conductive layer, and an upper substrate; wherein alignment directions of the upper alignment layer and the lower alignment layer are parallel alignment.

The liquid crystal composition 1 is prepared according to each compound and weight percentage listed in Table 2, the dye providing 3 wt. % of the liquid crystal composition is added in the liquid crystal composition 1, the chiral agent S811 providing 1.36 wt. % of the liquid crystal composition is added in the liquid crystal composition 1, the performance test of the liquid crystal dimming device is carried out by filling the same into the guest-host liquid crystal composition layer of the present Example and the test results thereof are shown in Table 5.

TABLE 5
Test results for the performance parameters

| | |
|---|---|
| Tᵣ₀ | 16.8 |
| Tᵣ₂₅₅ | 58 |
| CR | 3.5 |
| VHR (initial, 25° C.) | 89.67 |
| VHR (initial, 60° C.) | 68.64 |
| VHR (Ra, 25° C.) | 70.54 |
| VHR (Ra, 60° C.) | 31.48 |

Applying power on the liquid crystal dimming device in Example 2 for 2 h, the surface of the device at the moment of power-off is as shown in FIG. 3.

### Comparative Example 2

The difference between the present Comparative Example 2 and Example 2 merely lies in that the alignment directions of the upper alignment layer and the lower alignment layer are anti-parallel alignment.

The performance test thereof is carried out and the results are shown in Table 6.

TABLE 6
Test results for the performance parameters

| | |
|---|---|
| Tᵣ₀ | 16.4 |
| Tᵣ₂₅₅ | 58.2 |
| CR | 3.5 |
| VHR (initial, 25° C.) | 88.33 |
| VHR (initial, 60° C.) | 66.21 |
| VHR (Ra, 25° C.) | 48.58 |
| VHR (Ra, 60° C.) | 28.94 |

Applying power on the liquid crystal dimming device in Comparative Example 2 for 2 h, the surface of the device at the moment of power-off is as shown in FIG. 4.

It can be seen from the comparison between Comparative Example 2 and Example 2 that filling the liquid crystal composition with a higher clearing point, an appropriate optical anisotropy, an appropriate absolute value of dielectric anisotropy and a better low temperature storage stability, as well as the chiral agent and the dye into the liquid crystal dimming device of the present invention makes the liquid crystal dimming device of the present invention have an appropriate transmittance (Tᵣ₀, Tᵣ₂₅₅), an appropriate contrast rate, a higher VHR (initial), a higher VHR (Ra) and a wider operation temperature range. It can be seen from the comparison between the FIG. 4 and FIG. 3 that the dimming device of the present invention has a better display effect at the moment of power-off after applying power on it for 2 h, and can effectively avoid the problems of display mura and image sticking.

### Example 3

The present Example provides a liquid crystal dimming device, sequentially comprising, from bottom to top, a lower substrate, a lower conductive layer, a lower alignment layer, a guest-host liquid crystal composition layer, an upper alignment layer, an upper conductive layer, and an upper substrate; wherein alignment directions of the upper alignment layer and the lower alignment layer are parallel alignment.

The liquid crystal composition 2 is prepared according to each compound and weight percentage listed in Table 7, the dye providing 4 wt. % of the liquid crystal composition is added in the liquid crystal composition 2, the chiral agent S811 providing 1.1 wt. % of the liquid crystal composition is added in the liquid crystal composition 2, the performance test of the liquid crystal dimming device is carried out by filling the same into the guest-host liquid crystal composition layer of the present Example and the test results thereof are shown in Table 8.

TABLE 7
Formulation of liquid crystal composition

| | | | |
|---|---|---|---|
| Code of | Weight | Code of | Performance |
| component | percent | structure | Parameters |

| | | | | |
|---|---|---|---|---|
| 3CWO2 | 16.5 | N-2 | Cp | 126 |
| 3CWO4 | 15 | N-2 | Δn | 0.102 |
| 5CWO2 | 7 | N-2 | Δε | −5.8 |
| 3CCWO2 | 10 | N-5 | T_{c} | −30 |
| 3CCWO3 | 10 | N-5 | t_{-30° C.} | ≥7 |
| 4CCWO2 | 9 | N-5 | | |
| 5CCWO2 | 9 | N-5 | | |
| 2CPWO2 | 5.5 | N-11 | | |
| 3CCEPC3 | 5 | M-30 | | |
| 3CCEPC4 | 5 | M-30 | | |
| 3CCEPC5 | 5 | M-30 | | |
| 3CCEPC2 | 3 | M-30 | | |
| Total | 100 | | | |

TABLE 8
Test results for the performance parameters

| | |
|---|---|
| Tᵣ₀ | 13.5 |
| Tᵣ₂₅₅ | 57 |
| CR | 4.2 |
| VHR (initial, 25° C.) | 90.75 |
| VHR (initial, 60° C.) | 68.76 |
| VHR (Ra, 25° C.) | 73.61 |
| VHR (Ra, 60° C.) | 33.4 |

Applying power on the liquid crystal dimming device in Example 3 for 2 h, the surface of the device at the moment of power-off is as shown in FIG. 5.

### Comparative Example 3

The difference between the present Comparative Example 3 and Example 3 merely lies in that the alignment directions of the upper alignment layer and the lower alignment layer are anti-parallel alignment.

The performance test thereof is carried out and the results are shown in Table 9.

TABLE 9
Test results for the performance parameters

| | |
|---|---|
| Tᵣ₀ | 13.6 |
| Tᵣ₂₅₅ | 57 |
| CR | 4.2 |
| VHR (initial, 25° C.) | 89.41 |
| VHR (initial, 60° C.) | 66.67 |
| VHR (Ra, 25° C.) | 51.22 |
| VHR (Ra, 60° C.) | 29.51 |

Applying power on the liquid crystal dimming device in Comparative Example 3 for 2 h, the surface of the device at the moment of power-off is as shown in FIG. 6.

It can be seen from the comparison between Comparative Example 3 and Example 3 that filling the liquid crystal composition with a higher clearing point, an appropriate optical anisotropy, an appropriate absolute value of dielectric anisotropy and a better low temperature storage stability, as well as the chiral agent and the dye into the liquid crystal dimming device of the present invention makes the liquid crystal dimming device of the present invention have an appropriate transmittance (Tᵣ₀, Tᵣ₂₅₅), an appropriate contrast rate, a higher VHR (initial), a higher VHR (Ra) and a wider operation temperature range. It can be seen from the comparison between the FIG. 6 and FIG. 5 that the dimming device of the present invention has a better display effect at the moment of power-off after applying power on it for 2 h, and can effectively avoid the problems of display mura and image sticking.

### Example 4

The present Example provides a liquid crystal dimming device, sequentially comprising, from bottom to top, a lower substrate, a lower conductive layer, a lower alignment layer, a guest-host liquid crystal composition layer, an upper alignment layer, an upper conductive layer, and an upper substrate; wherein alignment directions of the upper alignment layer and the lower alignment layer are parallel alignment.

The liquid crystal composition 2 is prepared according to each compound and weight percentage listed in Table 7, the dye providing 3.6 wt. % of the liquid crystal composition is added in the liquid crystal composition 2, the chiral agent S1011 providing 0.72 wt. % of the liquid crystal composition is added in the liquid crystal composition 2, the performance test of the liquid crystal dimming device is carried out by filling the same into the guest-host liquid crystal composition layer of the present Example and the test results thereof are shown in Table 10.

TABLE 10
Test results for the performance parameters

| | |
|---|---|
| Tᵣ₀ | 13.2 |
| Tᵣ₂₅₅ | 53.4 |
| CR | 4 |
| VHR (initial, 25° C.) | 84.85 |
| VHR (initial, 60° C.) | 58.08 |
| VHR (Ra, 25° C.) | 62.88 |
| VHR (Ra, 60° C.) | 23.07 |

Applying power on the liquid crystal dimming device in Example 4 for 2 h, the surface of the device at the moment of power-off is as shown in FIG. 7.

### Comparative Example 4

The difference between the present Comparative Example 4 and Example 4 merely lies in that the alignment directions of the upper alignment layer and the lower alignment layer are anti-parallel alignment.

The performance test thereof is carried out and the results are shown in Table 11.

TABLE 11
Test results for the performance parameters

| | |
|---|---|
| Tᵣ₀ | 13.2 |
| Tᵣ₂₅₅ | 53.4 |
| CR | 4 |
| VHR (initial, 25° C.) | 83.52 |
| VHR (initial, 60° C.) | 56 |
| VHR (Ra, 25° C.) | 40.7 |
| VHR (Ra, 60° C.) | 19.22 |

Applying power on the liquid crystal dimming device in Comparative Example 4 for 2 h, the surface of the device at the moment of power-off is as shown in FIG. 8.

It can be seen from the comparison between Comparative Example 4 and Example 4 that filling the liquid crystal composition with a higher clearing point, an appropriate optical anisotropy, an appropriate absolute value of dielectric anisotropy and a better low temperature storage stability, as well as the chiral agent and the dye into the liquid crystal dimming device of the present invention makes the liquid crystal dimming device of the present invention have an appropriate transmittance (Tᵣ₀, Tᵣ₂₅₅), an appropriate contrast rate, a higher VHR (initial), a higher VHR (Ra) and a wider operation temperature range. It can be seen from the comparison between the FIG. 8 and FIG. 7 that the dimming device of the present invention has a better display effect at the moment of power-off after applying power on it for 2 h, and can effectively avoid the problems of display mura and image sticking.

### Example 5

The present Example provides a liquid crystal dimming device, sequentially comprising, from bottom to top, a lower substrate, a lower conductive layer, a lower alignment layer, a guest-host liquid crystal composition layer, an upper alignment layer, an upper conductive layer, and an upper substrate; wherein alignment directions of the upper alignment layer and the lower alignment layer are parallel alignment.

The liquid crystal composition 3 is prepared according to each compound and weight percentage listed in Table 12, the dye providing 3 wt. % of the liquid crystal composition is added in the liquid crystal composition 3, the chiral agent S811 providing 1.3 wt. % of the liquid crystal composition is added in the liquid crystal composition 3, the performance test of the liquid crystal dimming device is carried out by filling the same into the guest-host liquid crystal composition layer of the present Example and the test results thereof are shown in Table 13.

TABLE 12
Formulation of liquid crystal composition

| | | | |
|---|---|---|---|
| Code of | Weight | Code of | Performance |
| component | percent | structure | Parameters |

| | | | | |
|---|---|---|---|---|
| 3CWO4 | 12 | N-2 | Cp | 125 |
| 5CWO2 | 7 | N-2 | Δn | 0.088 |
| 3CWO2 | 11.5 | N-2 | Δε | −4.3 |
| 3CCWO3 | 7 | N-5 | T_{c} | −30 |
| 4CCWO2 | 7 | N-5 | t_{-30° C.} | ≥7 |
| 5CCWO2 | 7 | N-5 | | |
| 3CCWO2 | 7 | N-5 | | |
| 3CC1OC5 | 3.5 | M-24 | | |
| VCCP1 | 2 | M-12 | | |
| 3CCO3 | 5 | M-1 | | |
| 3CGPC3 | 3 | M-28 | | |
| 3CPO2 | 6 | M-2 | | |
| 3CCEC5 | 3.5 | M-21 | | |
| 4CCEC3 | 3.5 | M-21 | | |
| 4CCECC3 | 3 | M-31 | | |
| 3CCEPC3 | 4 | M-30 | | |
| 3CCEPC4 | 4 | M-30 | | |
| 3CCEPC5 | 4 | M-30 | | |
| Total | 100 | | | |

TABLE 13
Test results for the performance parameters

| | |
|---|---|
| Tᵣ₀ | 21.4 |
| Tᵣ₂₅₅ | 64.2 |
| CR | 3 |
| VHR (initial, 25° C.) | 89.85 |
| VHR (initial, 60° C.) | 68.08 |
| VHR (Ra, 25° C.) | 72.88 |
| VHR (Ra, 60° C.) | 33.07 |

Applying power on the liquid crystal dimming device in Example 5 for 2 h, the surface of the device at the moment of power-off is as shown in FIG. 9.

### Comparative Example 5

The difference between the present Comparative Example 5 and Example 5 merely lies in that the alignment directions of the upper alignment layer and the lower alignment layer are anti-parallel alignment.

The performance test thereof is carried out and the results are shown in Table 14.

TABLE 14
Test results for the performance parameters

| | |
|---|---|
| Tᵣ₀ | 21.3 |
| Tᵣ₂₅₅ | 63.9 |
| CR | 3 |
| VHR (initial, 25° C.) | 88.12 |
| VHR (initial, 60° C.) | 65.98 |
| VHR (Ra, 25° C.) | 50.4 |
| VHR (Ra, 60° C.) | 29.22 |

Applying power on the liquid crystal dimming device in Comparative Example 5 for 2 h, the surface of the device at the moment of power-off is as shown in FIG. 10.

It can be seen from the comparison between Comparative Example 5 and Example 5 that filling the liquid crystal composition with a higher clearing point, an appropriate optical anisotropy, an appropriate absolute value of dielectric anisotropy and a better low temperature storage stability, as well as the chiral agent and the dye into the liquid crystal dimming device of the present invention makes the liquid crystal dimming device of the present invention have an appropriate transmittance (Tᵣ₀, Tᵣ₂₅₅), an appropriate contrast rate, a higher VHR (initial), a higher VHR (Ra) and a wider operation temperature range. It can be seen from the comparison between the FIG. 10 and FIG. 9 that the dimming device of the present invention has a better display effect at the moment of power-off after applying power on it for 2 h, and can effectively avoid the problems of display mura and image sticking.

### Example 6

The present Example provides a liquid crystal dimming device, sequentially comprising, from bottom to top, a lower substrate, a lower conductive layer, a lower alignment layer, a guest-host liquid crystal composition layer, an upper alignment layer, an upper conductive layer, and an upper substrate; wherein alignment directions of the upper alignment layer and the lower alignment layer are parallel alignment.

The liquid crystal composition 3 is prepared according to each compound and weight percentage listed in Table 12, the dye providing 3.8 wt. % of the liquid crystal composition is added in the liquid crystal composition 3, the chiral agent S1011 providing 1.25 wt. % of the liquid crystal composition is added in the liquid crystal composition 3, the performance test of the liquid crystal dimming device is carried out by filling the same into the guest-host liquid crystal composition layer of the present Example and the test results thereof are shown in Table 15.

TABLE 15
Test results for the performance parameters

| | |
|---|---|
| Tᵣ₀ | 16.9 |
| Tᵣ₂₅₅ | 56.5 |
| CR | 3.3 |
| VHR (initial, 25° C.) | 84.5 |
| VHR (initial, 60° C.) | 55.4 |
| VHR (Ra, 25° C.) | 62.94 |
| VHR (Ra, 60° C.) | 23.36 |

Applying power on the liquid crystal dimming device in Example 6 for 2 h, the surface of the device at the moment of power-off is as shown in FIG. 11.

### Comparative Example 6

The difference between the present Comparative Example 6 and Example 6 merely lies in that the alignment directions of the upper alignment layer and the lower alignment layer are anti-parallel alignment.

The performance test thereof is carried out and the results are shown in Table 16.

TABLE 16
Test results for the performance parameters

| | |
|---|---|
| Tᵣ₀ | 16.6 |
| Tᵣ₂₅₅ | 56.4 |
| CR | 3.4 |
| VHR (initial, 25° C.) | 84.72 |
| VHR (initial, 60° C.) | 58.59 |
| VHR (Ra, 25° C.) | 42.51 |
| VHR (Ra, 60° C.) | 22.61 |

Applying power on the liquid crystal dimming device in Comparative Example 6 for 2 h, the surface of the device at the moment of power-off is as shown in FIG. 12.

It can be seen from the comparison between Comparative Example 6 and Example 6 that filling the liquid crystal composition with a higher clearing point, an appropriate optical anisotropy, an appropriate absolute value of dielectric anisotropy and a better low temperature storage stability, as well as the chiral agent and the dye into the liquid crystal dimming device of the present invention makes the liquid crystal dimming device of the present invention have an appropriate transmittance (Tᵣ₀, Tᵣ₂₅₅), an appropriate contrast rate, a higher VHR (initial), a higher VHR (Ra) and a wider operation temperature range. It can be seen from the comparison between the FIG. 12 and FIG. 11 that the dimming device of the present invention has a better display effect at the moment of power-off after applying power on it for 2 h, and can effectively avoid the problems of display mura and image sticking.

### Example 7

The present Example provides a liquid crystal dimming device, sequentially comprising, from bottom to top, a lower substrate, a lower conductive layer, a lower alignment layer, a guest-host liquid crystal composition layer, an upper alignment layer, an upper conductive layer, and an upper substrate; wherein alignment directions of the upper alignment layer and the lower alignment layer are parallel alignment.

The liquid crystal composition 3 is prepared according to each compound and weight percentage listed in Table 12, the dye providing 3.8 wt. % of the liquid crystal composition is added in the liquid crystal composition 3, the chiral agent S2011 providing 0.66 wt. % of the liquid crystal composition is added in the liquid crystal composition 3, the performance test of the liquid crystal dimming device is carried out by filling the same into the guest-host liquid crystal composition layer of the present Example and the test results thereof are shown in Table 17.

TABLE 17
Test results for the performance parameters

| | |
|---|---|
| Tᵣ₀ | 18.5 |
| Tᵣ₂₅₅ | 59.4 |
| CR | 3.2 |
| VHR (initial, 25° C.) | 84.14 |
| VHR (initial, 60° C.) | 57.1 |
| VHR (Ra, 25° C.) | 65.04 |
| VHR (Ra, 60° C.) | 25.58 |

Applying power on the liquid crystal dimming device in Example 7 for 2 h, the surface of the device at the moment of power-off is as shown in FIG. 13.

### Comparative Example 7

The difference between the present Comparative Example 6 and Example 6 merely lies in that the alignment directions of the upper alignment layer and the lower alignment layer are anti-parallel alignment.

The performance test thereof is carried out and the results are shown in Table 18.

TABLE 18
Test results for the performance parameters

| | |
|---|---|
| Tᵣ₀ | 18 |
| Tᵣ₂₅₅ | 59.1 |
| CR | 3.3 |
| VHR (initial, 25° C.) | 83.03 |
| VHR (initial, 60° C.) | 59.97 |
| VHR (Ra, 25° C.) | 41.81 |
| VHR (Ra, 60° C.) | 19.74 |

Applying power on the liquid crystal dimming device in Comparative Example 7 for 2 h, the surface of the device at the moment of power-off is as shown in FIG. 14.

It can be seen from the comparison between Comparative Example 7 and Example 7 that filling the liquid crystal composition with a higher clearing point, an appropriate optical anisotropy, an appropriate absolute value of dielectric anisotropy and a better low temperature storage stability, as well as the chiral agent and the dye into the liquid crystal dimming device of the present invention makes the liquid crystal dimming device of the present invention have an appropriate transmittance (Tᵣ₀, Tᵣ₂₅₅), an appropriate contrast rate, a higher VHR (initial), a higher VHR (Ra) and a wider operation temperature range. It can be seen from the comparison between the FIG. 14 and FIG. 13 that the dimming device of the present invention has a better display effect at the moment of power-off after applying power on it for 2 h, and can effectively avoid the problems of display mura and image sticking.

### Example 8

The present Example provides a liquid crystal dimming device, sequentially comprising, from bottom to top, a lower substrate, a lower conductive layer, a lower alignment layer, a guest-host liquid crystal composition layer, an upper alignment layer, an upper conductive layer, and an upper substrate; wherein alignment directions of the upper alignment layer and the lower alignment layer are parallel alignment.

The liquid crystal composition 4 is prepared according to each compound and weight percentage listed in Table 19, the dye providing 3.8 wt. % of the liquid crystal composition is added in the liquid crystal composition 4, the chiral agent S811 providing 1.14 wt. % of the liquid crystal composition is added in the liquid crystal composition 4, the performance test of the liquid crystal dimming device is carried out by filling the same into the guest-host liquid crystal composition layer of the present Example and the test results thereof are shown in Table 20.

TABLE 19
Formulation of liquid crystal composition

| | | | |
|---|---|---|---|
| Code of | Weight | Code of | Performance |
| component | percent | structure | Parameters |

| | | | | |
|---|---|---|---|---|
| 3CWO2 | 15 | N-2 | Cp | 96 |
| 5CWO2 | 10 | N-2 | Δn | 0.102 |
| 3CWO4 | 15 | N-2 | Δε | −6.5 |
| 2CPWO2 | 4 | N-11 | T_{c} | −30 |
| 3CPWO3 | 4 | N-11 | t_{-30° C.} | ≥7 |
| 3CPWO4 | 4 | N-11 | | |
| 3CPWO2 | 3 | N-11 | | |
| 3CCWO2 | 9 | N-5 | | |
| 3CCWO3 | 9 | N-5 | | |
| 4CCWO3 | 9 | N-5 | | |
| 5CCWO2 | 9 | N-5 | | |
| 3CCEP5 | 5 | M-22 | | |
| 3CCEC3 | 4 | M-21 | | |
| Total | 100 | | | |

TABLE 20
Test results for the performance parameters

| | |
|---|---|
| Tᵣ₀ | 13.1 |
| Tᵣ₂₅₅ | 57.3 |
| CR | 4.4 |
| VHR (initial, 25° C.) | 89.61 |
| VHR (initial, 60° C.) | 67.33 |
| VHR (Ra, 25° C.) | 67.24 |
| VHR (Ra, 60° C.) | 14.28 |

### Comparative Example 8

The difference between the present Comparative Example 8 and Example 8 merely lies in that the alignment directions of the upper alignment layer and the lower alignment layer are anti-parallel alignment. The performance test thereof is carried out and the results are shown in Table 21.

TABLE 21
Test results for the performance parameters

| | |
|---|---|
| Tᵣ₀ | 13.4 |
| Tᵣ₂₅₅ | 57.2 |
| CR | 4.3 |
| VHR (initial, 25° C.) | 88.29 |
| VHR (initial, 60° C.) | 59.24 |
| VHR (Ra, 25° C.) | 42.14 |
| VHR (Ra, 60° C.) | 12.45 |

It can be seen from the comparison between Comparative Example 8 and Example 8 that filling the liquid crystal composition with a higher clearing point, an appropriate optical anisotropy, an appropriate absolute value of dielectric anisotropy and a better low temperature storage stability, as well as the chiral agent and the dye into the liquid crystal dimming device of the present invention makes the liquid crystal dimming device of the present invention have an appropriate transmittance (Tᵣ₀, Tᵣ₂₅₅), an appropriate contrast rate, a higher VHR (initial), a higher VHR (Ra) and a wider operation temperature range, and it can effectively avoid the problems of display mura and image sticking.

### Example 9

The present Example provides a liquid crystal dimming device, sequentially comprising, from bottom to top, a lower substrate, a lower conductive layer, a lower alignment layer, a guest-host liquid crystal composition layer, an upper alignment layer, an upper conductive layer, and an upper substrate; wherein alignment directions of the upper alignment layer and the lower alignment layer are parallel alignment.

The liquid crystal composition 4 is prepared according to each compound and weight percentage listed in Table 22, the dye providing 4 wt. % of the liquid crystal composition is added in the liquid crystal composition 4, the chiral agent S811 providing 1.1 wt. % of the liquid crystal composition is added in the liquid crystal composition 4, the performance test of the liquid crystal dimming device is carried out by filling the same into the guest-host liquid crystal composition layer of the present Example and the test results thereof are shown in Table 23.

TABLE 22
Formulation of liquid crystal composition

| | | | |
|---|---|---|---|
| Code of | Weight | Code of | Performance |
| component | percent | structure | Parameters |

| | | | | |
|---|---|---|---|---|
| 3CWO2 | 12 | N-2 | Cp | 124 |
| 3CWO4 | 12 | N-2 | Δn | 0.103 |
| 5CWO2 | 12 | N-2 | Δε | −5.8 |
| 3CCWO2 | 9 | N-5 | T_{c} | −30 |
| 3CCWO3 | 9 | N-5 | t_{-30° C.} | ≥7 |
| 4CCWO2 | 9 | N-5 | | |
| 5CCWO2 | 9 | N-5 | | |
| 2CPWO2 | 5 | N-11 | | |
| 3CPWO3 | 5 | N-11 | | |
| 3CCEPC3 | 5 | M-30 | | |
| 3CCEPC4 | 5 | M-30 | | |
| 3CPCC2 | 5 | M-32 | | |
| 3CGCC2 | 3 | M-33 | | |
| Total | 100 | | | |

TABLE 23
Test results for the performance parameters

| | |
|---|---|
| Tᵣ₀ | 14.1 |
| Tᵣ₂₅₅ | 57.8 |
| CR | 4.1 |
| VHR (initial, 25° C.) | 89.43 |
| VHR (initial, 60° C.) | 67.34 |
| VHR (Ra, 25° C.) | 72.35 |
| VHR (Ra, 60° C.) | 33.5 |

### Comparative Example 9

The difference between the present Comparative Example 9 and Example 9 merely lies in that the alignment directions of the upper alignment layer and the lower alignment layer are anti-parallel alignment.

The performance test thereof is carried out and the results are shown in Table 24.

TABLE 24
Test results for the performance parameters

| | |
|---|---|
| Tᵣ₀ | 13.9 |
| Tᵣ₂₅₅ | 57.4 |
| CR | 4.1 |
| VHR (initial, 25° C.) | 88.66 |
| VHR (initial, 60° C.) | 67.23 |
| VHR (Ra, 25° C.) | 50.54 |
| VHR (Ra, 60° C.) | 28.54 |

It can be seen from the comparison between Comparative Example 9 and Example 9 that filling the liquid crystal composition with a higher clearing point, an appropriate optical anisotropy, an appropriate absolute value of dielectric anisotropy and a better low temperature storage stability, as well as the chiral agent and the dye into the liquid crystal dimming device of the present invention makes the liquid crystal dimming device of the present invention have an appropriate transmittance (Tᵣ₀, Tᵣ₂₅₅), an appropriate contrast rate, a higher VHR (initial), a higher VHR (Ra) and a wider operation temperature range.

### Example 10

The present Example provides a liquid crystal dimming device, sequentially comprising, from bottom to top, a lower substrate, a lower conductive layer, a lower alignment layer, a guest-host liquid crystal composition layer, an upper alignment layer, an upper conductive layer, and an upper substrate; wherein alignment directions of the upper alignment layer and the lower alignment layer are parallel alignment.

The liquid crystal composition 4 is prepared according to each compound and weight percentage listed in Table 7, the dye providing 3.6 wt. % of the liquid crystal composition is added in the liquid crystal composition 4, the chiral agent S1011 providing 0.72 wt. % of the liquid crystal composition is added in the liquid crystal composition 4, the performance test of the liquid crystal dimming device is carried out by filling the same into the guest-host liquid crystal composition layer of the present Example and the test results thereof are shown in Table 25.

TABLE 25
Test results for the performance parameters

| | |
|---|---|
| Tᵣ₀ | 13.8 |
| Tᵣ₂₅₅ | 53.9 |
| CR | 3.9 |
| VHR (initial, 25° C.) | 84.25 |
| VHR (initial, 60° C.) | 57.08 |
| VHR (Ra, 25° C.) | 63.14 |
| VHR (Ra, 60° C.) | 23.14 |

### Comparative Example 10

The difference between the present Comparative Example 10 and Example 10 merely lies in that the alignment directions of the upper alignment layer and the lower alignment layer are anti-parallel alignment.

The performance test thereof is carried out and the results are shown in Table 26.

TABLE 26
Test results for the performance parameters

| | |
|---|---|
| Tᵣ₀ | 13.6 |
| Tᵣ₂₅₅ | 54.1 |
| CR | 4 |
| VHR (initial, 25° C.) | 83.68 |
| VHR (initial, 60° C.) | 52.36 |
| VHR (Ra, 25° C.) | 40.54 |
| VHR (Ra, 60° C.) | 18.65 |

It can be seen from the comparison between Comparative Example 10 and Example 10 that filling the liquid crystal composition with a higher clearing point, an appropriate optical anisotropy, an appropriate absolute value of dielectric anisotropy and a better low temperature storage stability, as well as the chiral agent and the dye into the liquid crystal dimming device of the present invention makes the liquid crystal dimming device of the present invention have an appropriate transmittance (Tᵣ₀, Tᵣ₂₅₅), an appropriate contrast rate, a higher VHR (initial), a higher VHR (Ra) and a wider operation temperature range.

In conclusion, the liquid crystal dimming device of the present invention has an appropriate transmittance (Tᵣ₀ is 12.6-21.4, Tᵣ₂₅₅ is 53.4-64.2), an appropriate contrast rate (3-4.5), a higher VHR (initial) (VHR (initial, 25° C.) is above 84, VHR (initial, 60° C.) is above 55), a higher VHR (Ra) (VHR (Ra, 25° C.) is above 62, VHR (Ra, 60° C.) is above 14, even above 23) and a wider operation temperature range (the phase transformation point in low temperature storage ≥−30° C.). The dimming device of the present invention has a better display effect at the moment of power-off after applying power on it for 2 h, and can effectively avoid the problems of display mura and image sticking.

The applicant declares that the liquid crystal dimming device of the present invention is illustrated by the above Examples, but the present invention is not limited to the above Examples, that is, it does not mean that the implement of the present application must rely on the above Examples. It shall be clear to the person skilled in the art that any improvements of the present invention, equivalent replacements of the raw materials used in the present invention, the additions of any auxiliary components, the selection of specific methods or the like all fall into the protection scope and the disclosure scope of the present invention.

### INDUSTRIAL APPLICABILITY

The liquid crystal dimming device involved in the present invention can be applied to the construction and transportation fields.

1. A liquid crystal dimming device comprising, from bottom to top, a lower substrate, a lower conductive layer, a lower alignment layer, a guest-host liquid crystal composition layer, an upper alignment layer, an upper conductive layer, and an upper substrate;
wherein alignment directions of the upper alignment layer and the lower alignment layer are parallel alignment;
wherein the guest-host liquid crystal composition layer comprises at least one dichroic dye, at least one chiral agent and at least one liquid crystal composition;
wherein, the liquid crystal composition comprises at least one compound of general formula N: 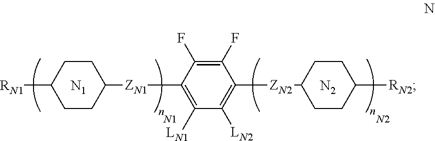
wherein,
R_{N1} and R_{N2} each independently represents C₁₋₁₂ linear or branched alkyl, 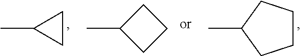
one or more than two nonadjacent —CH₂— in the C₁₋₁₂ linear or branched alkyl can each be independently replaced by —CH═CH—, —C≡C—, —O—, —CO—, —CO—O— or —O—CO—;
ring 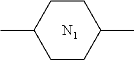
and ring 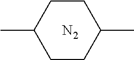
each independently represents 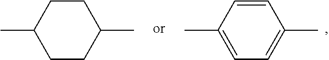
wherein one or more —CH₂— in 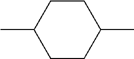
can be replaced by —O—, one or more single bond in the rings can be replaced by double bond, wherein one or more —H on 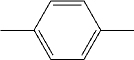
can each be independently substituted by —F, —Cl or —CN, and one or more —CH═ in the rings can be replaced by —N═;
Z_{N1} and Z_{N2} each independently represents single bond, —CO—O—, —O—CO—, —CH₂O—, —OCH₂—, —CH═CH—, —C≡C—, —CH₂CH₂—, —CF₂CF₂—, —(CH₂)₄—, —CF₂O— or —OCF₂—;
L_{N1} and L_{N2} each independently represents —H, halogen, C₁₋₃ alkyl, or C₁₋₃ alkoxy; and
n_{N1} represents 0, 1, 2 or 3 n_{N2} represents 0 or 1, and 0≤n_{N1}+n_{N2}≤3, when n_{N1}=2 or 3, ring 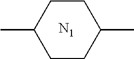
can be the same or different, and Z_{N1} can be the same or different.

2. The liquid crystal dimming device according to claim 1, wherein the compound of general formula N is selected from a group consisting of the following compounds:

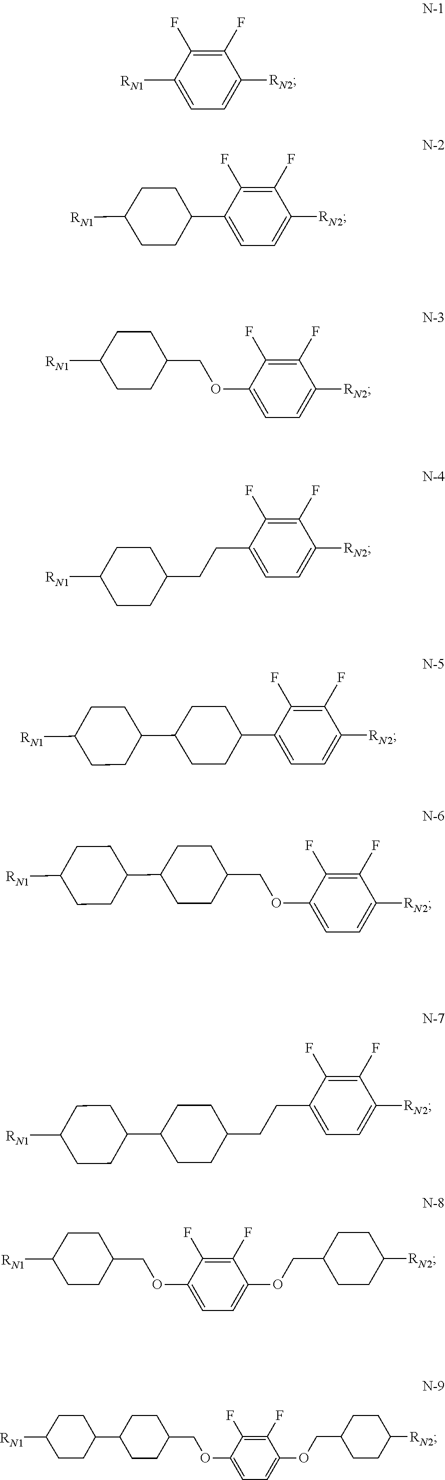

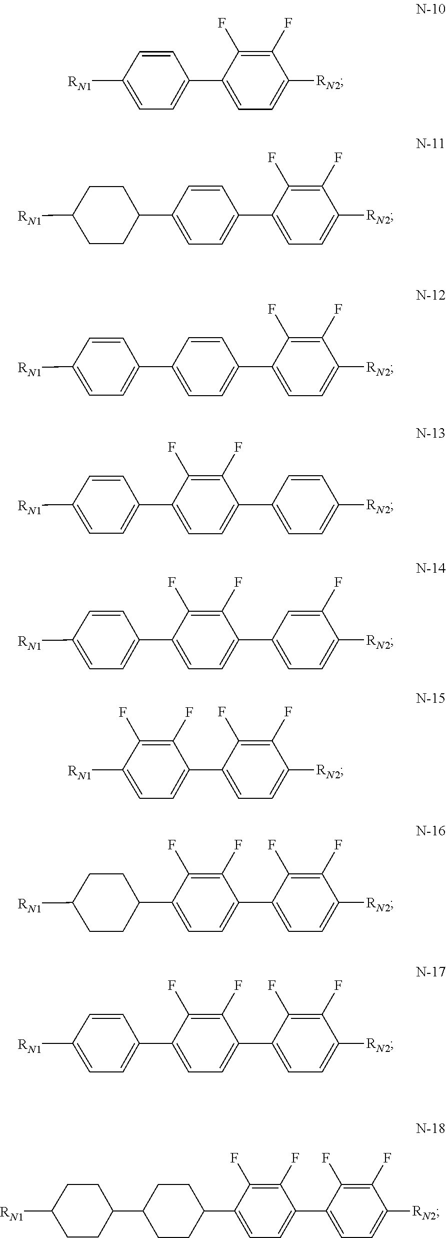

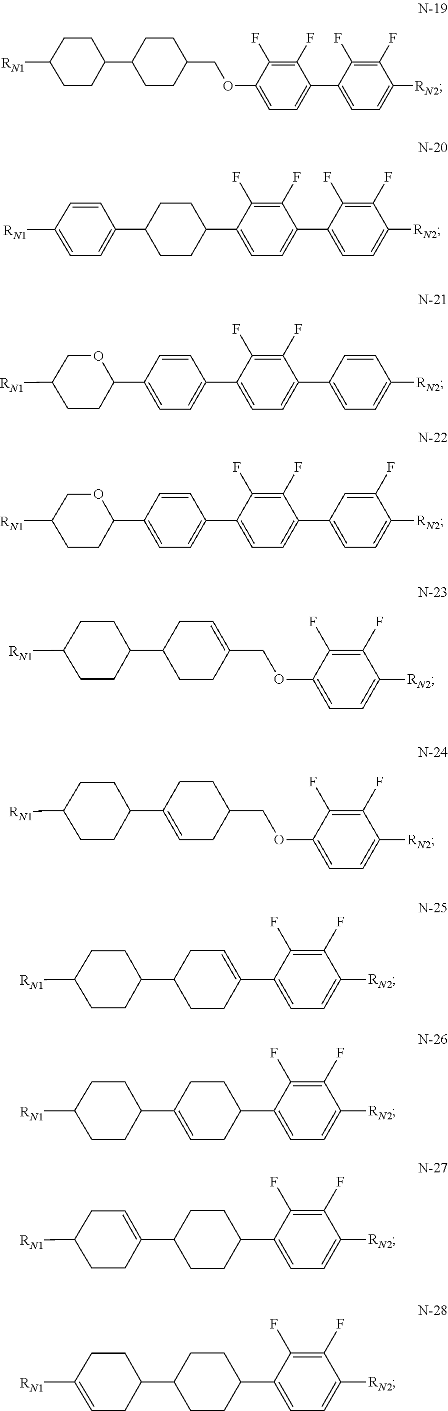

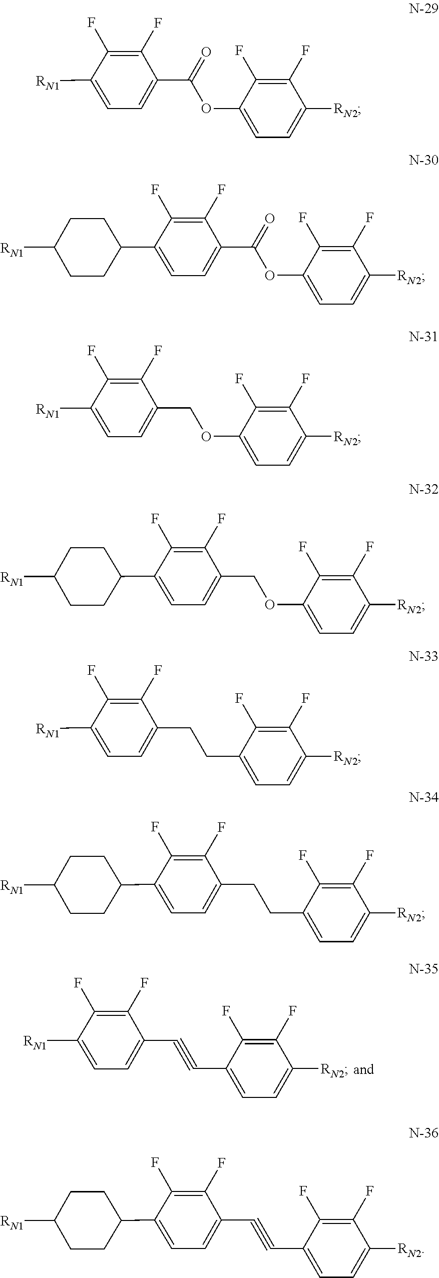

3. The liquid crystal dimming device according to claim 1, wherein the dielectric anisotropy of the liquid crystal component <0.

4. The liquid crystal dimming device according to claim 1, wherein the dichroic dye molecule is one or more dyes selected from the group consisting of dyes of azo type, anthraquinone type, phthalocyanine, cyanine type, indigoid, arylmethane, nitro and nitroso.

5. The liquid crystal dimming device according to claim 4, wherein the dichroic dye molecule is selected from the group consisting of the following compounds:

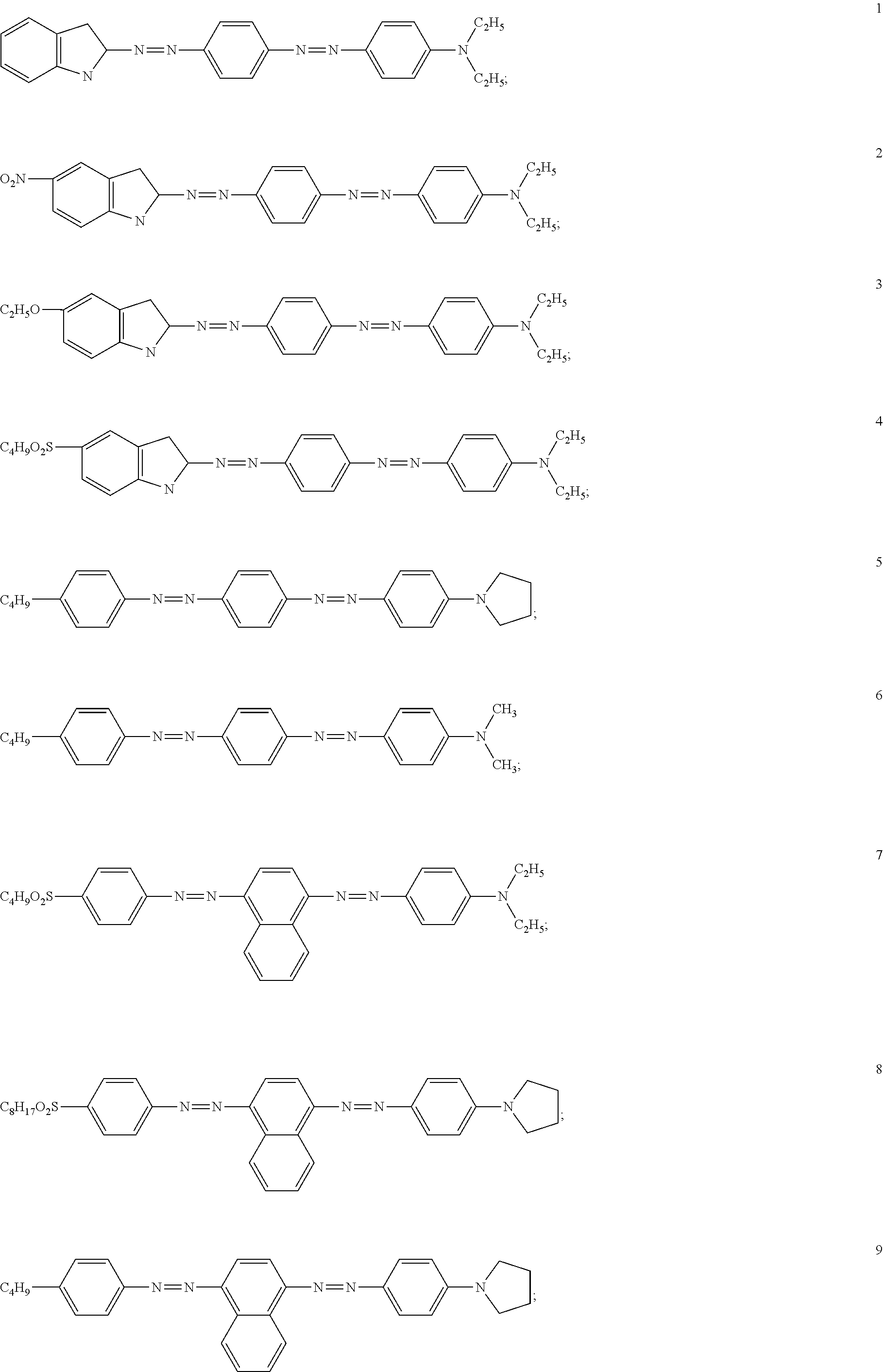

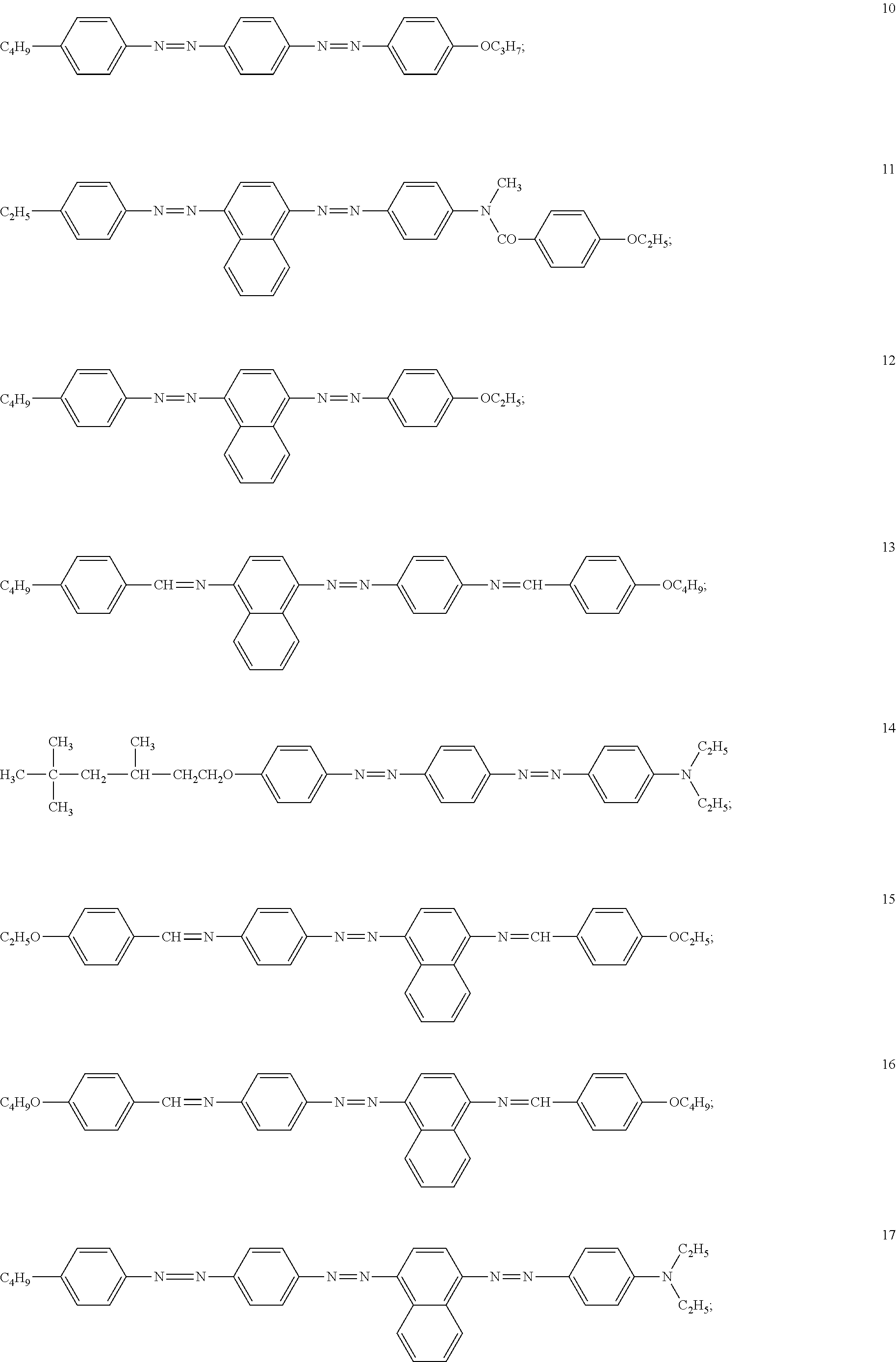

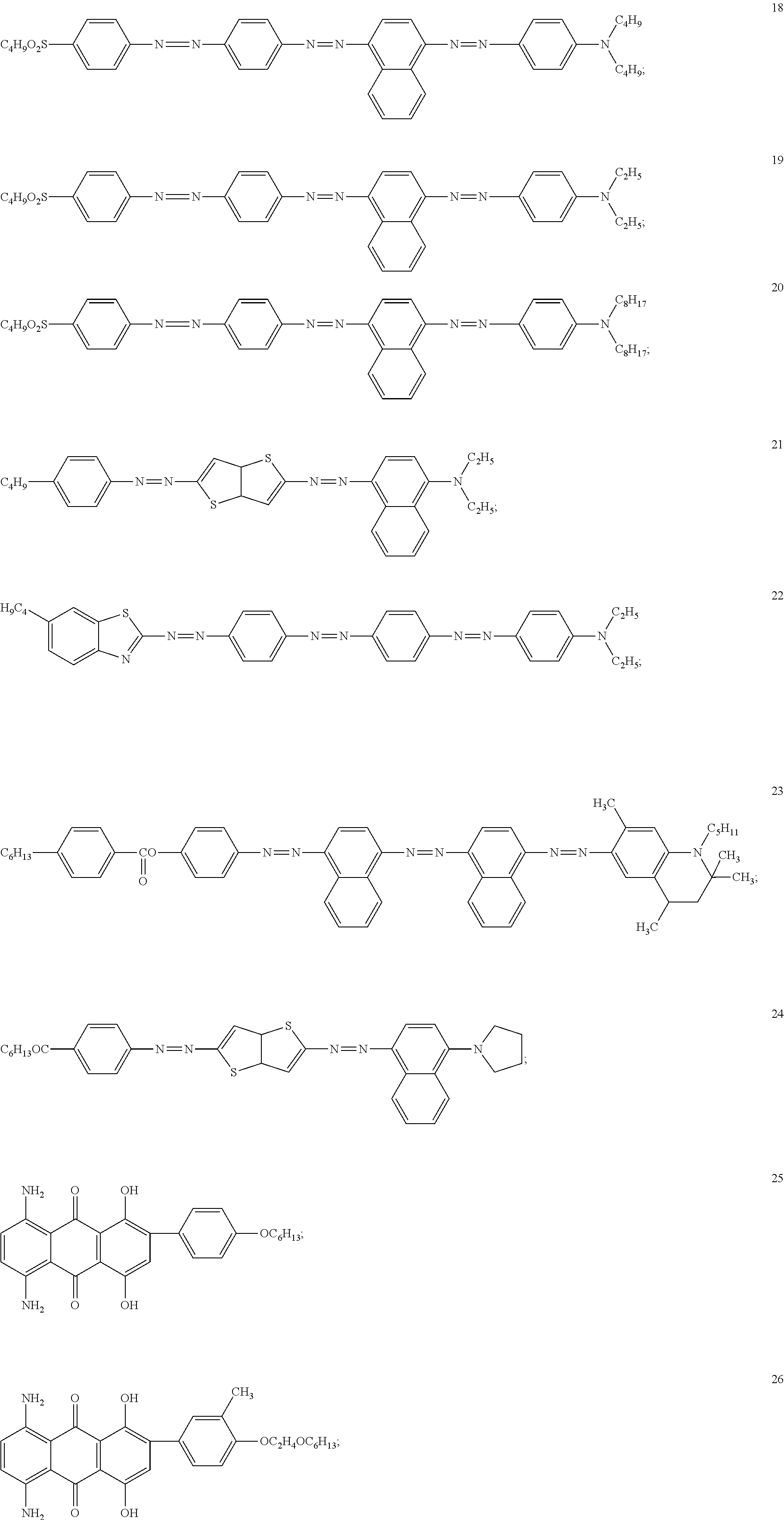

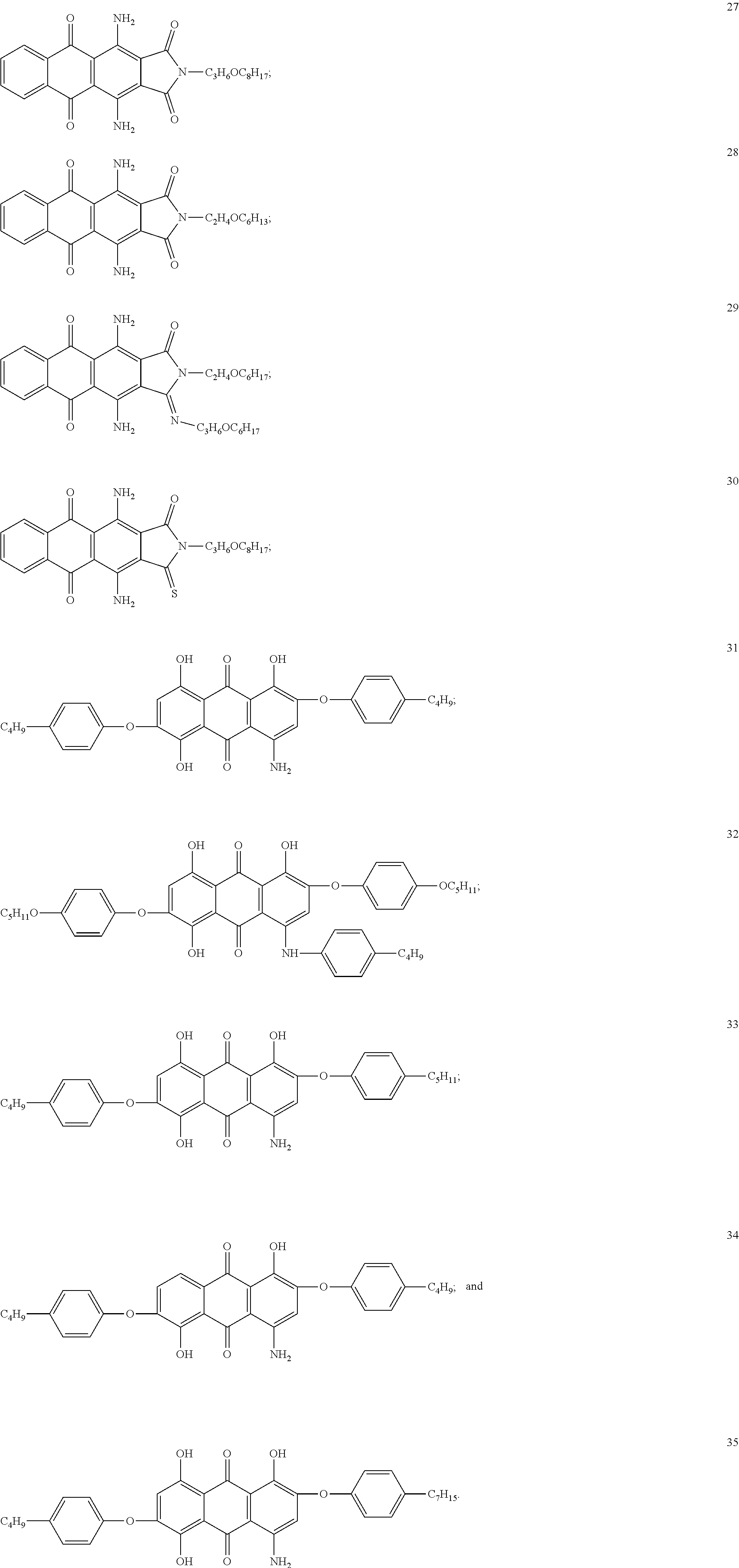

6. The liquid crystal dimming device according to claim 1, wherein the chiral agent is an S-type chiral compound or an R-type chiral compound.

7. The liquid crystal dimming device according to claim 6, wherein the S-type chiral compound is selected from a group consisting of the chiral agents of S1011, S2011, S5011, S811, S6N, and the R-type chiral compound is selected from a group consisting of the chiral agents of R1011, R2011, R5011, R811, R6N.

8. The liquid crystal dimming device according to claim 1, wherein the liquid crystal composition further comprises at least one compound of general formula M: 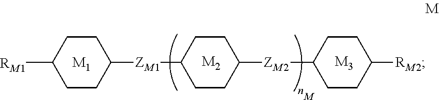
wherein,
R_{M1} and R_{M2} each independently represents C₁₋₁₂ linear or branched alkyl, 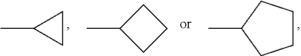
one or more than two nonadjacent —CH₂— in the C₁₋₁₂ linear or branched alkyl can each be independently replaced by —CH═CH—, —C≡C—, —O—, —CO—, —CO—O— or —O—CO—;
ring 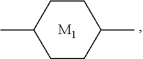
ring 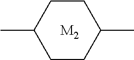
and ring 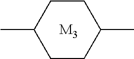
each independently represents 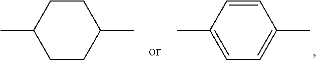
wherein one or more —CH₂— in 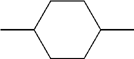
can be replaced by —O—, and one or more single bond in the rings can be replaced by double bond, at most one —H on 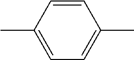
can be substituted by halogen;
Z_{M1} and Z_{M2} each independently represents single bond, —CO—O—, —O—CO—, —CH₂O—, —OCH₂—, —C≡C—, —CH═CH—, —CH₂CH₂— or —(CH₂)₄—; and
n_{M} represents 0, 1 or 2, wherein when n_{M}=2, ring 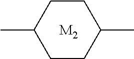
can be the same or different, Z_{M2} can be same or different.

9. The liquid crystal dimming device according to claim 8, wherein the compound of general formula M is selected from a group consisting of the following compounds:

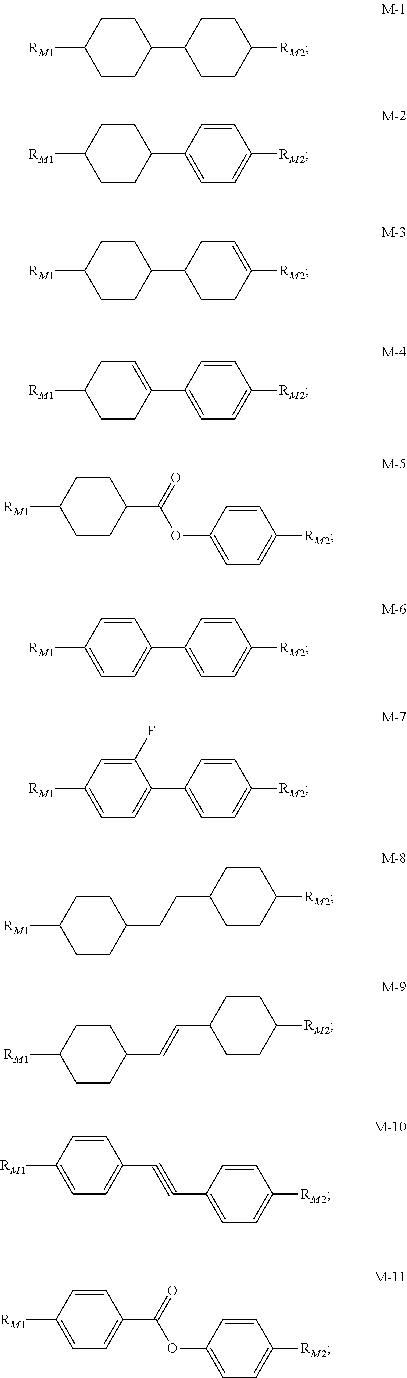

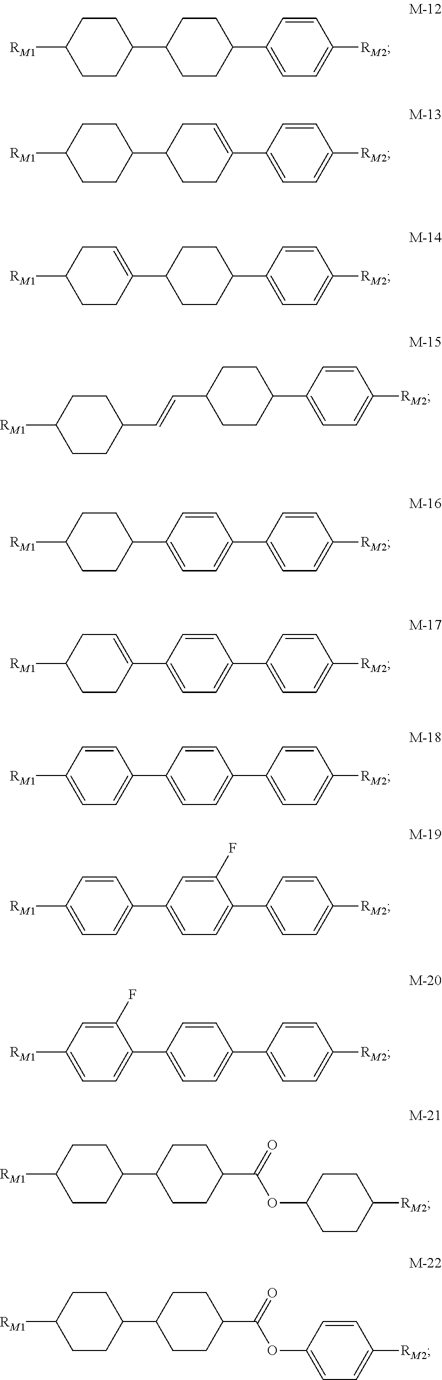

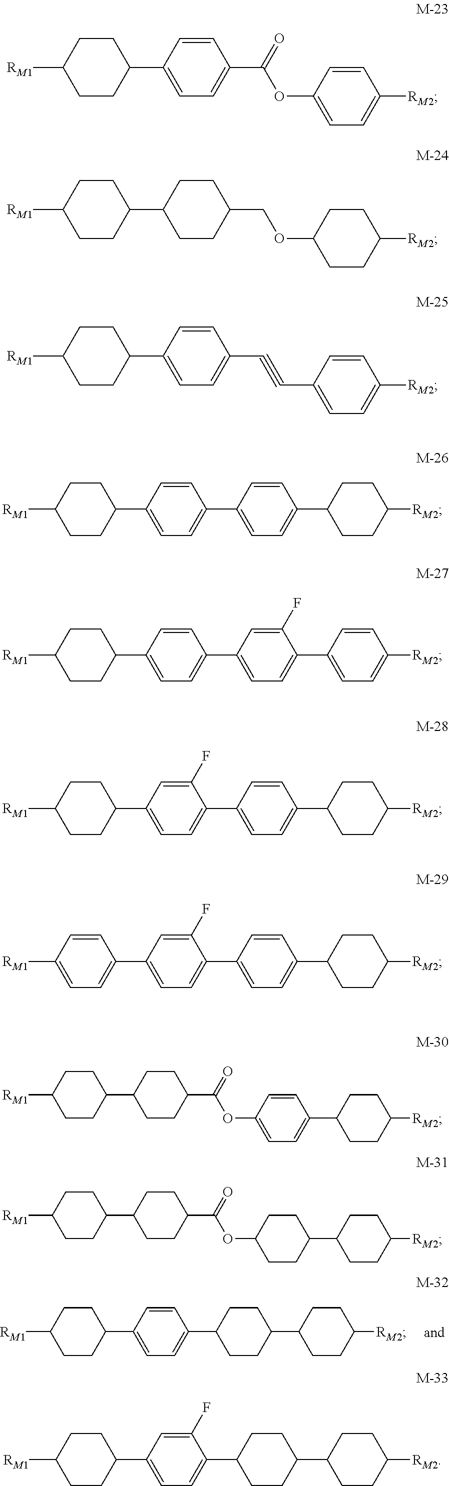

10. The liquid crystal dimming device according to claim 8, wherein the compound of general formula N provides 0.1-98 wt. % of the liquid crystal composition, and the compound of general formula M provides 0.1-60 wt. % of the liquid crystal composition.

11. The liquid crystal dimming device according to claim 4, wherein the dichroic dye molecule is selected from the group consisting of dyes of azo type and anthraquinone type.

12. The liquid crystal dimming device according to claim 4, wherein the dichroic dye provides 0.01-10 wt. % of the total weight of the liquid crystal composition.

13. The liquid crystal dimming device according to claim 5, wherein the dichroic dye molecule is selected from a combination of one or at least two of the dye of the dye number of 5 to the dye of the dye number of 35.

14. The liquid crystal dimming device according to claim 13, wherein the dichroic dye molecule is selected from a combination of one or at least two of the dye of the dye number of 5 to the dye of the dye number of 22.

15. The liquid crystal dimming device according to claim 6, wherein the HTP value of the chiral compound is ≥5.

16. The liquid crystal dimming device according to claim 6, wherein the chiral compound provides 0.01-10 wt. % of the total weight of the liquid crystal composition.

17. The liquid crystal dimming device according to claim 7, wherein the chiral compound is selected from a group consisting of S1011, S2011, S811.

18. The liquid crystal dimming device according to claim 2, wherein the compound of general formula N is selected from compounds of a group consisting of the compound of general formula N-2, the compound of general formula N-5, the compound of general formula N-11.

19. The liquid crystal dimming device according to claim 9, wherein the compound of general formula M is selected from compounds of a group consisting of the compound of general formula M-1, the compound of general formula M-2, the compound of general formula M-12, the compound of general formula M-16, the compound of general formula M-26, the compound of general formula M-27, the compound of general formula M-28, the compound of general formula M-29, the compound of general formula M-30, the compound of general formula M-31, the compound of general formula M-32, and the compound of general formula M-33.

20. The liquid crystal dimming device according to claim 9, wherein the compound of general formula M comprises at least one compound selected from a group consisting of the compound of general formula M-26, the compound of general formula M-27, the compound of general formula M-28, the compound of general formula M-29, the compound of general formula M-30, the compound of general formula M-31, the compound of general formula M-32, and the compound of general formula M-33.
